(19) United States
(12) Patent Application Publication
(10) Pub. No.: US 2007/0168266 A1
(43) Pub. Date: Jul. 19, 2007

(54) Systems, methods and computer readable code for visualizing and managing digital cash

(76) Inventor: Patrick Questembert, New York, NY (US)

Correspondence Address: DR. MARK FRIEDMAN LTD.;C/o Bill Polkinghorn, 9003 Florin Way, Upper Marlboro, MD, 20772, US

(21) Appl. No.: 11/333,379

(22) Filed: Jan. 18, 2006

(51) Int. Cl. G06Q 40/00; G07F 19/00

(52) U.S. Cl. 705/35; 235/379

(57) ABSTRACT

Systems, methods and computer readable code for handling (for example, visualizing and/or managing) digital cash are provided. According to some embodiments, digital cash bundles are each represented as graphical icons associated a visual indication of at least one digital cash attribute of the respective digital cash bundle. Exemplary digital cash attributes include but are not limited to an earliest valid redeeming time, a multi-redeeming parameter, an acceptance condition parameter, a password protection status, and a currency parameter. Methods systems and computer-readable code for generating, redeeming and/or dispensing digital cash are disclosed. Methods of doing business involving digital cash are provided. Methods and systems for facilitating the installation of software on a user machine in accordance with operations involving digital cash are disclosed. Methods for simulating drag-and-drop notification icons from the taskbar of a Microsoft Windows system are provided.

### FIELD OF THE INVENTION

The present invention relates to digital cash, and in particular to systems, methods and computer readable code for visualizing and/or managing digital cash, and to methods of doing business with digital cash.

### BACKGROUND OF THE INVENTION

The explosive growth in content and services available on the Internet, which started in the late 1990's has continued largely unabated into the 21^{st} century. A growing number of business transactions, which were once conducted in person, are now performed on-line. Furthermore, a growing number of goods, which were once physical items needing to be shipped to the customer, are being replaced with electronic alternatives. For example, video content, once delivered on video tapes and DVDs, may now be downloaded in electronic format. In addition, the Internet is continuing to replace traditional mediums not only in commercial transactions but also in person-to-person interactions.

These trends have combined to create a tremendous need for convenient and secure electronic methods of payment. To date, credit and debit cards have extended the dominance they enjoy in the offline commerce world to the Internet and are the by far the most popular method of payment used on the Internet. However, credit and debit cards present very significant drawbacks in the eyes of both consumers and businesses. In surveys, consumers list the following concerns: credit card security, disclosure of personal details, distrust of web retailers, complex order process and time consuming order process. Web vendors have to pay a high percentage of their revenues to credit cards companies, typically 2% or above. These drawbacks significantly reduce the volume and reach of Internet commerce.

Micropayments, electronic payments in the range $0-$5, are particularly problematic. For such payments, the credit card fees structure render many potentially lucrative high volume/low cost business models entirely unprofitable. In addition, consumer concerns using credit cards online, such as credit cards security and the time consuming nature of entering credit card information, are significant more acute for low and frequent payments.

Internet vendors are trying to alleviate some of the drawbacks of credit and debit cards by attempting to convince consumers to become subscribers, and pay in “lumps” instead of paying for individual items. However, these attempts have generally been unsuccessful. The explosion and globalization of the Internet has created a situation where web vendors compete fiercely for consumer market share, and to do so, often offer a wide range of services at no charge or highly discounted. Consumers are aware of this, and so are reluctant to commit to subscription models, preferring to pay-as-you-go for goods and services.

In recent years, digital cash has been made available to users as a form of payment. Typically, a user must open a digital cash “account” with a financial institution or technology provider in order to use digital cash. The user's digital cash resides within this digital cash account. After opening the digital cash account, the user can deposit funds into this digital cash account (i.e. to increase the balance in his or her account) using a traditional payment method (for example, credit or debit card payment, wire transfer, providing paper currency or check, etc). Conversely, the user may convert digital cash from his or her digital cash “account” into traditional money (i.e. exchange the digital cash, or the right to the digital cash, for traditional money) by providing an electronic data sequence representative of the digital cash. Once the digital cash is exchanged for “real money” the digital cash can no longer be used. In order to effect a purchase with digital cash (i.e. to “use” the digital cash), the user typically authorizes that a certain amount of digital cash be debited from his or her digital cash account in favor of the account of a seller or vendor.

To date, digital cash products have enjoyed only relatively modest success, while traditional methods of payment (i.e. paper currency, wire transfers, credit card payment, etc) retain their dominant position. There are a number of possible explanations for this. One possible explanation is that many users are hesitant to invest the effort, however minimal, in opening a digital cash account, as this requires forming a relationship with a new financial institution or broadening an existing relation with a financial institution.

Another possible explanation for the failure of digital cash implementations to capture the hearts and minds of consumers stems from the counter-intuitive way in which past and current digital cash implementations have presented digital cash to consumers. Hard currency has been available in the real world for centuries and mankind is fascinated by it. Beyond the value of a bill or coin, cash is appealing to us because it is more concrete than a number we may see on a bank statement. It is something we can touch, give and receive instantly, immediately recognized as cash by anyone, anywhere. In contrast, past and current digital cash implementations are one step removed from tangible to the user, who cannot “touch” or “see” digital cash, which remains an abstraction represented by an electronic credit balance displayed on a web site.

It is unfortunate that consumer acceptance of digital cash technology remains limited to date, despite the promise that digital cash holds as a financial tool. There is an ongoing need for methods, systems, and computer-readable code which facilitate the use of digital cash. Furthermore, there is an ongoing need for business methods which allow for the use of digital cash in different contexts, in order to harness the benefits associated with digital cash.

### SUMMARY OF THE INVENTION

Some or all of the aforementioned needs are satisfied by several aspects of the present invention.

It is now disclosed for the first time a system for visualizing digital cash on a computer. The presently disclosed system includes (a) a digital cash status engine for determining at least one cash attribute of a digital cash bundle, and (b) a digital cash management interface operative to represent the digital cash bundle as a graphical icon associated with a visual indication of at least one the determined digital cash attribute.

According to some embodiments, the cash visual interface is operative to display an additional visual indication associated with at least one the cash status attribute upon detecting a user engagement with the graphical icon.

According to some embodiments, at least one visual indication is provided as text.

According to some embodiments, the digital cash management interface includes drag-and-drop functionality, and drag-and-drop manipulation of the graphical icons is operative to effect cash bundle manipulation operations.

According to some embodiments, subjecting a graphical icon to a drag-and-drop operation is operative to effect a corresponding drag-and-drop operation to a digital cash file associated with the subjected graphical icon.

According to some embodiments, the presently-disclosed system further includes (c) a digital cash bundle combining engine for generating a cash bundle from a plurality of existing digital cash bundles.

According to some embodiments, upon detecting by the digital cash management interface of an engagement of a first graphical icon representing a first digital cash bundle with a second graphical icon representing a second digital cash bundle, the digital cash combining engine is operative to generate a combined cash bundle from the first and second cash bundles.

According to some embodiments, the combining is a silent combining.

According to some embodiments, upon the detecting of the engagement, the digital cash management interface presents a cash combining interface (for example, a dialogue), and the generation of the combined cash bundle by the digital cash bundle combining engine is performed in accordance with parameters received through the cash combining interface.

According to some embodiments, at least one digital cash attribute is a parameter indicative of an earliest valid redeeming time of the digital cash bundle.

According to some embodiments, at least one the digital cash attributes is a multi-redeeming parameter of the digital cash bundle.

According to some embodiments, at least one digital cash attributes is an acceptance condition parameter attached to the digital cash bundle.

According to some embodiments, at least one digital cash attributes is a password protection status of the digital cash parameter.

According to some embodiments, at least one digital cash attributes is a currency parameter of the digital cash bundle.

According to some embodiments, at least one the digital cash attributes is selected from the group consisting of a value of the digital cash bundle, a parameter indicative of a source of the digital cash bundle, a parameter indicative of a creation time of the digital cash bundle, a parameter indicative of an expiration time of the digital cash bundle, a destination parameter, a parameter indicative of the ability of the present user to redeem the digital cash bundle, a consistency status of the digital cash bundle, a cancellation status parameter of the digital cash bundle, a notification of redeeming status of the digital cash bundle, a modifiability status of the digital cash bundle, an online redeeming status of the digital cash bundle, an informative message status of the digital cash bundle.

According to some embodiments, the digital cash management interface is further operative to effect at least one modification of at least one the digital cash attribute of the digital cash bundle.

According to some embodiments, a digital cash redeeming engine operative to handling redeeming of a digital cash bundle upon, and upon detecting by the digital cash management interface of a user engagement to the graphical icon, the redeeming engine effects a redeeming operation for an associated digital cash bundle.

According to some embodiments, the digital cash bundle is a repeat bundle, and the redeeming engine is only operative to redeem the repeat bundle if a sum of one and number of previous redeeming does not exceed a maximum number of redeeming associated with the repeat bundle.

According to some embodiments, if a given digital cash bundle is a deferred cash bundle, the digital cash redeeming engine is only operative to redeem the deferred cash bundle if an earliest redeeming time has arrived or passed.

According to some embodiments, the presently disclosed system further includes (c) a notification engine adapted to send a notification message upon the redeeming.

According to some embodiments, the notification message includes at least one of an identity of a redeemer (e.g. machine and/or user), the amount redeemed and a time of redeeming.

According to some embodiments, notification message is sent to a source of the redeemed cash bundle.

According to some embodiments, the presently disclosed system further includes (c) a condition acceptance engine for determining if an acceptance condition for redeeming the digital cash bundle is met, wherein if the condition acceptance engine determines that a given digital cash bundle is associated with an acceptance condition, the redeeming engine is operative to redeem the cash bundle associated with the acceptance condition only upon determination by the condition acceptance engine that the acceptance condition is met.

According to some embodiments, the presently disclosed system further includes (c) an acceptance condition presentation interface for presenting the acceptance condition.

According to some embodiments, the presently disclosed system further includes: (c) a password engine for determining a validity status of a submitted password,

wherein if digital cash status engine determines that a given digital cash bundle is password-protected, the redeeming engine is operative to redeem the protected cash bundle only upon determination by the password engine of a valid password.

According to some embodiments, the presently disclosed system further includes: (d) a password interface associated with the password engine, the password interface being operative to communicate a received user password to the password engine,

wherein the password interface is activatable upon detection by the cash management interface of a user engagement with a graphical icon.

According to some embodiments, the presently disclosed system further includes (c) a cash bundle generation engine operative to generate a digital cash bundle,

wherein upon generation of the digital cash bundle, the cash management interface is operative to create and/or display a graphical icon representing the generated digital cash bundle.

According to some embodiments, the presently disclosed system further includes:

(d) a cash bundle generation interface, wherein the cash bundle generation engine operates in accordance with directives received through the cash bundle generation interface, the cash bundle generation interface being activatable in accordance with a detected drag-and-drop operation.

According to some embodiments, the cash bundle generation engine is operative to generate a digital cash bundle in accordance with predetermined values provided in the digital cash template.

According to some embodiments, the generation of the digital cash bundle is performed upon detection of a dragging and a dropping of a template graphical icon associated with the provided digital cash template.

According to some embodiments, the management interface is operative to display a graphically modified cash graphical icon which is modified in accordance with the at least one cash status attribute.

According to some embodiments, the graphically modified cash graphical icon includes a primary icon combined with at least one secondary icon, and the visualization interface is operative to select the at least one secondary icon is selected in accordance with at least one the digital cash attribute.

According to some embodiments, associated visual indication is determined in accordance with at least one environmental and/or dynamic factor of the digital cash bundle.

According to some embodiments, environmental factor is a current time.

According to some embodiments, the environmental factor is selected from the group consisting of an identity of the logged in user and a location of the digital cash bundle.

According to some embodiments, the environmental factor is a financial institution environmental factor.

According to some embodiments, the digital cash management interface is operative to produce a menu upon detecting a user engagement with a graphical icon, the menu containing at least one item operative to effect a cash bundle manipulation operation to a digital cash bundle associated with the engaged icon.

According to some embodiments, the presently disclosed system further includes (c) a digital cash bundle splitting engine for generating from the digital cash bundle a plurality of distinct derivative digital cash bundles.

According to some embodiments, the presently disclosed system further includes a cash splitting engine that is activatable upon engaging the graphical icon within the cash visual interface.

The digital cash bundle and the graphical icon are associated with a digital cash file (for example, the graphical icon represents the digital file)

According to some embodiments, the presently disclosed system further includes (c) a search engine for searching locating digital cash bundles in accordance with a plurality of values provided for respective digital cash attributes.

According to some embodiments, the cash visualization interface is operative to interact with at least one separate desktop application to embed the graphical icon (for example, as a graphical object) within the separate desktop application.

According to some embodiments, the embedding is carried out by a user drag-and-drop operation.

According to some embodiments, upon detecting a user designation of a desktop application as a drag-and-drop target for the graphical icon, and in accordance with a detection that the designated desktop application accepts drag-and-drop input text, the cash management interface is operative to transmit a textual representation of the associated digital cash bundle to the designated desktop application.

It is now disclosed for the first time a method of visualizing digital cash on a computer. The presently disclosed method includes (a) determining at least one cash attribute of a digital cash bundle, and (b) representing the digital cash bundle as a graphical icon associated with a visual indication of at least one determined digital cash attribute.

It is now disclosed for the first time a method of a computer readable medium comprising program instructions, wherein when executed the program instructions are operable to (a) determine at least one cash attribute of a digital cash bundle, and (b) represent the digital cash bundle as a graphical icon associated with a visual indication of at least one the determined digital cash attribute.

It is now disclosed for the first time a system including (a) means for determining at least one cash attribute of a digital cash bundle, and (b) means for representing the digital cash bundle as a graphical icon associated with a visual indication of at least one determined digital cash attribute.

It is now disclosed for the first time a system for organizing a plurality of digital cash bundles. The presently disclosed system includes (a) a multi-bundle display interface for displaying an ordered list of visual representations of digital cash bundles, and (b) a sorting control for sorting the ordered list in accordance with at least one a digital cash attribute.

It is now disclosed for the first time a method of simulating a drag-and-drop operation of a Microsoft Windows notification icon from the taskbar into a region outside of the taskbar the method. The presently disclosed method includes (a) detecting a user engagement with the notification icon in a manner indicative of initiating a drag-and-drop operation; (b) upon detecting, creating a temporary proxy (and/or surrogate) window whose initial location is proximate to the notification icon, (c) transferring the focus to the created proxy window and establishing the created proxy window as the drag source, and (d) allowing the user to complete the drag-and-drop operation with the proxy window.

According to some embodiments, an icon derived from the notification icon is embedded in the proxy window in order to further the impression that it is the notification icon that is being dragged.

It is now disclosed for the first time a computer readable medium comprising program instructions, wherein when executed the program instructions are operable to:

(a) detect a user engagement with the notification icon in a manner indicative of initiating a drag-and-drop operation, (b) upon detecting, create a temporary proxy (and/or surrogate) window whose initial location is proximate to the notification icon, (c) transfer the focus to the created proxy window and establishing the created proxy window as the drag source, and (d) allow the user to complete the drag-and-drop operation with the proxy window.

It is now disclosed for the first time a digital cash generation system for creating customized digital cash. The presently disclosed system includes (a) a digital cash generator for generating digital cash, and (b) a data extractor for deriving an identifier of a payee target from a software application distinct from the digital cash generator, wherein the digital cash generator is operative to generate the digital cash in accordance with the derived identity of the payee.

According to some embodiments, the digital cash generator is further adapted to embed the generated digital cash into the software application.

According to some embodiments, the digital cash generator is operative to generate digital cash bundles, and to embed the generated digital cash bundles into an object (for example, a file or workspace) of the software application.

According to some embodiments, digital cash generator is adapted to embed additional data associated with the target payee

It is now disclosed for the first time a method of creating customized digital cash with a digital cash generator. The presently disclosed method includes (a) deriving an identifier of a payee target from a software application distinct from the digital cash generator (i.e. the code for generating digital cash], and b) generating customized digital cash in accordance with the derived identity of the payee.

It is now disclosed for the first time a computer readable medium comprising program instructions, wherein when executed the program instructions are operable to (a) derive an identifier of a payee target from a software application distinct from a digital cash generator and (b) generate customized digital cash in accordance with the derived identity of the payee.

It is now disclosed for the first time a digital cash generation system for creating customized digital cash. The presently disclosed system includes (a) a digital cash generator for generating digital cash customized in accordance with a digital cash account identifier, and (b) a customized data manager for associating the digital cash account identifiers with identifiers under a software application distinct from the digital cash generator, wherein upon receiving a request to generate digital cash for a payee having an identifier under the software application, the digital cash generator is operative to customize generated digital cash using a digital cash account identifier previously associated with the identifier under the software application.

According to some embodiments, the generated digital cash is a digital cash bundle.

According to some embodiments, the digital cash generator is operative to customize generated digital cash using a digital cash account identifier provided by a user in a previous request.

According to some embodiments, generated and customized digital cash is a digital cash bundle.

It is now disclosed for the first time a method for creating customized digital cash using a cash generator. The presently disclosed method includes (a) receiving a request to generate digital cash for a payee having an identifier under a software application distinct from the digital cash generator, and (b) generating digital cash customized in accordance with a digital cash account identifier associated with the identifier under the software application.

It is now disclosed for the first time a computer readable medium comprising program instructions, wherein when executed the program instructions are operable to (a) receive a request to generate digital cash for a payee having an identifier under a software application distinct from the digital cash generator, and (b) generate digital cash customized in accordance with a digital cash account identifier associated with the identifier under the software application.

It is now disclosed for the first time a method of facilitating the installation of software on a user machine. The presently disclosed method includes (a) associating a digital cash bundle file with code or with a reference to code operative to install an application on the user machine in accordance with a detecting of a user engagement of the digital cash bundle file; and (b) storing the digital cash bundle in volatile or non-volatile memory.

According to some embodiments, the code is operative to prevent repeated installation of the application.

According to some embodiments, the code is operative to modify the digital cash bundle to prevent the repeated installation.

According to some embodiments, the code is operative to configure a file type association data structure of the operating system such that future engagements by the user of digital cash bundles associated with the installation code or the reference are operative to bypass the installation code.

It is now disclosed for the first time a computer readable medium comprising program instructions, wherein when executed the program instructions are operable to (a) detect a user engagement of a digital cash bundle file; (b) upon detecting, invoke code operative to install an application on the user machine in accordance with a detecting of a user engagement of the digital cash bundle file.

It is now disclosed for the first time a system for redeeming digital cash on a computer. The presently disclosed system includes a digital cash status engine for determining at least one cash access attribute of digital cash payment, and (b) a digital cash access granting engine for redeeming only upon detecting a user acceptance of an embedded acceptance condition associated with the digital cash payment.

According to some embodiments, the presently disclosed system further includes (c) a notification engine operative to send a notification upon user acceptance of the acceptance condition.

According to some embodiments, the notification engine is operative to send or make available a piece of legally admissible evidence of the user acceptance.

According to some embodiments, the legally admissible evidence includes a digitally signed communication (for example, associated with a digital certificate).

It is now disclosed for the first time a method for redeeming digital cash on a computer. The presently disclosed method includes (a) determining at least one cash access attribute of digital cash payment, and (b) redeeming the digital cash payment only upon detecting a user acceptance of an embedded acceptance condition associated with the digital cash payment.

It is now disclosed for the first time a computer readable medium comprising program instructions, wherein when executed the program instructions are operable to (a) determine at least one cash access attribute of digital cash payment, and (b) redeem the digital cash payment only upon detecting a user acceptance of an embedded acceptance condition associated with the digital cash payment.

It is now disclosed for the first time a method of redeeming digital cash including the step of (a) handling a redeeming request for a digital cash payment that is associated with an embedded acceptance condition, and (b) authorizing redeeming of the digital cash payment only upon determining that the acceptance condition has been fulfilled.

It is now disclosed for the first time a method including the steps of (a) providing a digital cash bundle file on a first user machine, and (b) manipulating (for example, dragging, dropping, right clicking, viewing in a directory, etc) the digital cash electronic file using operating system desktop file manipulation resources (for example, interfaces for accessing the file system which are exposed to the user, including via at least one of the desktop and the command prompt) of the first user machine.

According to some embodiments, the provided digital cash electronic file is created by an application residing at least in part on the first user machine.

According to some embodiments, the presently disclosed system further includes (c) transferring the digital cash electronic file to a second user machine, the second user machine being distinct from the first user machine.

It is now disclosed for the first time a method of doing business, the method comprising: (a) providing a digital cash file having an embedded specified earliest redeeming time; and (b) storing the digital cash bundle file in volatile or non-volatile memory.

According to some embodiments, the presently disclosed method further includes c) upon handling a redeeming request, redeeming the digital cash file only the redeeming time constraint is satisfied.

It is now disclosed for the first time a method of doing business. The presently disclosed method includes (a) providing a digital cash file having an embedded specified earliest redeeming time, and (b) upon handling a redeeming request, redeeming the digital cash file only if the redeeming time constraint is satisfied.

According to some embodiments, a digital cash account is debited at a time selected from the group consisting of a time of successful redeeming, the specified redeeming time, and a time of issuing.

According to some embodiments, a digital cash file is designated with a status selected from the group consisting of cancelable and non-cancellable.

It is now disclosed for the first time a computer readable medium comprising program instructions, wherein when executed the program instructions are operable to: (a) handle a digital cash file having an embedded specified earliest redeeming time, and (b) upon receiving a redeeming request, redeem the digital cash file only if the redeeming time constraint is satisfied.

It is now disclosed for the first time a system for redeeming digital cash a) a redeeming engine for redeeming a digital cash bundle only if a redeeming time constraint associated with a pre-specified earliest redeeming time is satisfied.

It is now disclosed for the first time a method of doing business, the method comprising: (a) specifying a redeeming parameter describing a number of times a digital cash payment may be redeemed, and (b) associating the redeeming parameter with the digital cash payment.

According to some embodiments, a user-specific number of times a digital cash payment may be redeemed for any given user is also specified, and the user-specific number of times is associated with the digital cash payment.

It is now disclosed for the first time a method of redeeming digital cash including the steps of (a) handling a redeeming request for a repeat digital cash payment that is redeemable a number of times equal to a first number, and b) authorizing redeeming of repeat digital cash payment only if a number of previous successful redeemings is less than one less than the first number

In some embodiments, a mechanism is provided for preventing a given user from redeeming a bundle two or more times.

According to some embodiments, the redeeming request is associated with an identity of a potential redeemer, the digital cash payment is redeemable for the potential redeemer a number of times equal to a second number, and the digital cash payment is authorized for the redeeming only if a number of previous successful redeemings for the potential redeemer is less than one less than the second number.

It is now disclosed for the first time a method of doing business including the steps of (a) offering an item or service for sale over the Internet; and (b) receiving over the Internet one or more digital cash bundle files as payment for the item or service.

According to some embodiments, the step of offering includes embedding within a web page a visual element with associated code, the visual element representing the item or service offered for sale and the associated code is operative to accept the digital cash bundle file as payment for the item or service upon user engagement with the web element.

According to some embodiments, the embedded associated code is operative to accept the digital cash bundle file upon detecting a user drag-and-drop operation of the digital cash bundle file onto a region associated with the visual web element.

According to some embodiments, the associated code is operative to accept a plurality of digital cash bundle files, and to indicate when an accrued amount of digital cash from the plurality is equal to or exceeds a payment due for the item or service.

According to some embodiments, if excess digital cash is received for the item or service, the associated code is operative to provide one or more digital cash files whose value is determined by a received excess payment.

It is now disclosed for the first time a method dispensing digital cash bundles. The presently disclosed method includes the steps of (a) embedding within a web page a visual indication of a presence of digital cash, and (b) embedding within the web page at least one web element operative to supply a digital cash bundle file (for example, to supply to a host machine of a browser viewing the web page) upon detecting a user engagement of a location associated with the visual indication of the presence of digital cash.

According to some embodiments, web element is selected from the group consisting a digital cash bundle file (e.g. a remote cash bundle file), computer-readable code for providing a digital cash bundle file (onto the host machine), and a reference to the computer-readable code.

According to some embodiments, the presently disclosed method further includes (c) making the web pages available to users.

It is now disclosed for the first time a computer readable medium comprising program instructions, wherein when executed the program instructions are operable to: (a) present in a web browser a visual indication indicative of a presence of digital cash, and (b) supply a digital cash bundle file to a host machine of the web browser upon detecting a user engagement of a location associated with the visual indication of the presence digital cash.

It is now disclosed for the first time a method of doing business. The presently disclosed method includes the steps of (a) presenting in a web browser a visual indication indicative of a presence of digital cash, and (b) supplying a digital cash bundle file to a host machine of the web browser upon detecting a user engagement of a location associated with the visual indication of the presence the digital cash.

It is now disclosed for the first time a method of encouraging web traffic. The presently disclosed method includes the steps of (a) making a web page available a plurality of times, and (b) for at least one of the plurality of times, making the web page available with an embedded digital cash bundle.

According to some embodiments, the web page is made available with the digital cash bundle only a fraction of the time, and a determination about whether or not to embed the digital cash bundle is made in accordance at least in part with an identity of a user.

It is now disclosed for the first time method of doing business including the steps of (a) specifying or receiving an identity of an redeeming entity, and b) issuing a digital cash bundle file redeemable only by the specified or received redeeming entity.

It is now disclosed for the first time a method of doing business including the steps of (a) providing digital cash as a digital cash bundle file accessible to an operating system desktop, and (b) storing the digital cash bundle file in volatile or non-volatile memory.

According to some embodiments, the presently disclosed method further includes (c) writing the digital cash bundle file to a removable non-volatile medium.

According to some embodiments, at least one of a validity of the digital cash electronic file and an accessibility of the digital cash electronic file transcends a state of the user machine.

It is now disclosed for the first time a method of doing business including the steps of (a) providing restricted digital cash redeemable only by a pre-defined entity, and (b) making the restricted digital cash available to one or more individuals, each individual being distinct from a redeeming party.

According to some embodiments, the restricted digital cash voucher is provided as a digital cash file accessible to an operating system desktop.

According to some embodiments, the presently disclosed method further includes (c) effecting a transaction where an entity authorized to redeem the distributed restricted digital cash receives the distributed restricted digital cash in exchange for goods or services.

It is now disclosed for the first time a method of doing business including the steps of (a) providing digital cash having an embedded informative message, the digital cash redeemable concomitant with a viewing of the embedded informative message; and b) storing the digital cash bundle file in volatile or non-volatile memory.

According to some embodiments, the embedded informative message includes an advertising message.

According to some embodiments, the digital cash is redeemable only after viewing of at least a portion of the embedded informative message.

According to some embodiments, at least a portion of the embedded informative message is presented after cash redeeming.

According to some embodiments, the embedded informative message includes at least one of a graphical message and a multi-media message.

According to some embodiments, the digital cash is represented as a graphical icon, and the embedded informative message is operative to be presented upon a user engagement to the graphical icon.

It is now disclosed for the first time a method of doing business including the steps of (a) providing a password-protected digital cash payment; and b) authorizing access to the digital cash payment only after a providing of a valid password.

According to some embodiments, the digital cash payment is provided as a digital cash file.

According to some embodiments, the digital cash payment is represented as a graphical icon, and the password is requested upon a user engagement to the graphical icon.

It is now disclosed for the first time a computer readable medium comprising program instructions, wherein when executed the program instructions are operable to: (a) read data associated with a password-protected digital cash payment; and b) authorize access to the digital cash payment only after a providing of a valid password.

It is now disclosed for the first time a method of doing business including the steps of (a) providing digital cash having an embedded redeeming acceptance condition; and b) storing the digital cash bundle file in volatile or non-volatile memory

It is now disclosed for the first time a method of doing business including the steps of (a) generating digital cash having an embedded redeeming acceptance condition, and b) storing the digital cash bundle file in volatile or non-volatile memory

According to some embodiments, the redeeming acceptance condition of the generated digital cash includes formal legal text, and the generating of the digital cash includes generating the formal legal text on the basis of one or more predetermined templates.

According to some embodiments, the digital cash includes embedded instructions to send a notification upon user acceptance of the acceptance condition.

According to some embodiments, the digital cash includes embedded instructions to send or make available a piece of legally admissible evidence of the user acceptance.

According to some embodiments, the legally admissible evidence includes a digitally signed communication (for example, associated with a digital certificate)

According to some embodiments, the digital cash payment is distributed as a digital cash bundle file.

According to some embodiments, the presented acceptance condition is presented within a multi-media document.

Some embodiments of the present invention provide methods, systems and/or computer-readable code for running software upon redeeming digital cash.

It is now disclosed for the first time a method of doing business including the steps of (a): providing a digital cash payment associated with instructions which are operative upon redeeming to execute of software code distinct from the redeeming code; and (b) storing the digital cash payment in volatile or non-volatile memory.

According to some embodiments, the instructions are instructions embedded within the digital cash payment.

According to some embodiments, the instructions are external to the digital cash payment.

According to some embodiments, the instructions are operative to execute installation code operative to install an application on a user machine.

According to some embodiments, digital cash payment is distributed as a digital cash bundle file.

It is now disclosed for the first time a method of facilitating a transaction wherein a buyer purchases an item from a vendor using digital cash payment. The presently disclosed method includes (a) receiving an indication that the item has been sent from the vendor for delivery to the buyer, (b) receiving (for example, from a buyer) a key for redeeming the digital cash payment (in some embodiments, the key allows the vendor but not the shipping agent to redeem the cash), and (c) in accordance with a successful validation of the key, authorizing the providing of the item to the buyer.

According to some embodiments, the presently disclosed method further includes (c) in accordance with the successful validation of the key, authorizing the sending of the key to at least one of the vendor.

According to some embodiments, the presently disclosed method further includes (c) in accordance with the successful validation of the key, effecting (i.e. directly effecting and/or indirectly effecting) and/or authorizing a crediting of an account of the vendor with an amount derived from a value of the digital cash payment.

According to some embodiments, the digital cash payment is a digital cash bundle file (i.e. the key is operative to redeem a digital cash bundle file).

It is now disclosed for the first time a method for handling a plurality of application items of a software application. The presently disclosed method includes (a) registering with the software application, (b) for each application item, determining if the respective application item is associated with digital cash, and (c) handling each of the plurality of application items in accordance with the results of the determining (for example, handling in an environment provided by the software application.).

According to some embodiments, the handling includes visualization, the handling in accordance with the results includes presenting a given application item in a modified manner if the given application item is associated with digital cash.

According to some embodiments, the objects are mail messages.

It is now disclosed for the first time a system for handling a plurality of application items of a software application. The presently disclosed system includes a) registration code for registering with the software application; and b) an application item handler for handling application items of the software application, the application handler adapted to handle the application items in accordance with determinations of whether or not given application items are associated with digital cash. (for example, handling in an environment provided by the software application.).

According to some embodiments, the presently disclosed system is provided at least in part as a plug-in for the software application.

It is now disclosed for the first time a computer readable medium comprising program instructions for handling a plurality of application items of a software application, wherein when executed the program instructions are operable to (a) register with the software application, (b) for each application item, determine if the respective application item is associated with digital cash, and (c) handle each of the plurality of application items in accordance with the results of the determining, (for example, handling in an environment provided by the software application.).

According to some embodiments, the instructions are provided at least in part as part of a plug-in for the software application.

These and further embodiments will be apparent from the detailed description and examples that follow.

### BRIEF DESCRIPTION OF THE DRAWINGS

FIG. 1A-B illustrate some embodiments of a computer including a processor.

FIGS. 2A-C provides an image of exemplary graphical icons representing digital cash bundles.

FIG. 3 provides a block diagram of system components for handling digital cash in accordance with some embodiments of the present invention.

FIG. 4 provides an image of files visualized using specific icons selected according to file type (prior art).

FIG. 5 shows an image of an exemplary digital cash bundle represented as an XML file as viewed through an XML viewer.

FIG. 6 shows the temporal evolution of the status of two digital cash bundles in accordance with some embodiments of the present invention.

FIG. 7 illustrates how moving the mouse over one of the digital cash bundle in a folder results in the textual information for that digital cash bundle being shown by the graphical operating system in a floating text box, in accordance with some embodiments of the present invention.

FIG. 8 depicts exemplary removable media or devices containing removable media onto which digital cash bundles may be copied in accordance with some embodiments of the present invention.

FIG. 9 shows exemplary display of the files in a folder including digital cash bundle files.

FIG. 10 provides a block diagram of system components for handling digital cash in accordance with some embodiments of the present invention.

FIG. 11 describes an exemplary process of creating a cash bundle by dragging-and-dropping a taskbar icon into a file folder in accordance with exemplary embodiments of the present invention.

FIGS. 12A-D illustrate how one user may send a cash bundle to another user using MSN Messenger in accordance with exemplary embodiments of the present invention.

FIGS. 13A-B illustrate how one user may send a cash bundle to another user using SkyPE in accordance with exemplary embodiments of the present invention.

FIGS. 14A-B illustrate how a user may attach an existing cash bundle to a mail message in accordance with exemplary embodiments of the present invention.

FIGS. 15A-B illustrate how a user may create and attach a cash bundle to a Microsoft Word document in accordance with exemplary embodiments of the present invention.

FIGS. 16A-B illustrate exemplary use scenarios involving dragging-and-dropping a digital cash bundle into applications accepting only text in accordance with exemplary embodiments of the present invention.

FIG. 17 depicts how a user may cancel a cash bundle through the use of a menu command in accordance with exemplary embodiments of the present invention.

FIGS. 18A-B depict how a user may edit a cash bundle through the use of a menu command in accordance with exemplary embodiments of the present invention.

FIGS. 19A-B depicts how a user may split a cash bundle into two cash bundles in accordance with exemplary embodiments of the present invention.

FIG. 20 depicts how a user can combine two cash bundles into one bundle in accordance with exemplary embodiments of the present invention.

FIG. 21 depicts how the usage of a cash bundle template may save a user time entering the details of a cash bundle he is creating in accordance with exemplary embodiments of the present invention.

FIG. 22A shows how a user can create a password-protected cash bundle in accordance with exemplary embodiments of the present invention

FIG. 22B shows an exemplary sequence of events when redeeming a password-protected cash bundle in accordance with exemplary embodiments of the present invention.

FIG. 23 illustrates exemplary usage of a repeat cash bundle sent to multiple users in accordance with exemplary embodiments of the present invention.

FIG. 24A shows how a user can create a cash bundle with an acceptance request in accordance with exemplary embodiments of the present invention.

FIG. 24B shows an exemplary sequence of events when redeeming a cash bundle with acceptance request in accordance with exemplary embodiments of the present invention.

FIG. 25 shows an exemplary sequence of events when accepting a digital cash payment with acceptance request effected without the use of a cash bundle in accordance with exemplary embodiments of the present invention.

FIG. 26 shows exemplary cash bundles with attached personal or advertising message display requests in accordance with exemplary embodiments of the present invention.

FIGS. 27A-C show an exemplary sequence of events when a buyer pays for an item with a bundle protected by a password which a shipping agent is requiring at the time of delivery, using three different ways of accepting and processing the password, in accordance with exemplary embodiments of the present invention.

FIGS. 28A-C show exemplary effects of a user accepting an auto-install cash bundle for the first time in accordance with exemplary embodiments of the present invention.

FIG. 29 illustrates several exemplary formats for auto-install cash bundles in accordance with exemplary embodiments of the present invention.

FIGS. 30A-B illustrate purchasing an item on a web site using one cash bundle in accordance with exemplary embodiments of the present invention.

FIGS. 31A-D illustrate purchasing an item on a web site using multiple cash bundles in accordance with exemplary embodiments of the present invention.

FIGS. 32A-B illustrate purchasing an item on a web site using one cash bundle, with digital cash bundle change returned in accordance with exemplary embodiments of the present invention.

FIGS. 33A-B illustrates an exemplary display of mail messages with embedded digital cash and the sorting of these messages based on attributes of the embedded digital cash in accordance with exemplary embodiments of the present invention.

### DETAILED DESCRIPTION OF THE INVENTION

The present invention will now be described in terms of specific, example embodiments. It is to be understood that the invention is not limited to the example embodiments disclosed. It should also be understood that not every feature of the systems, methods and computer-readable code for handling digital cash described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

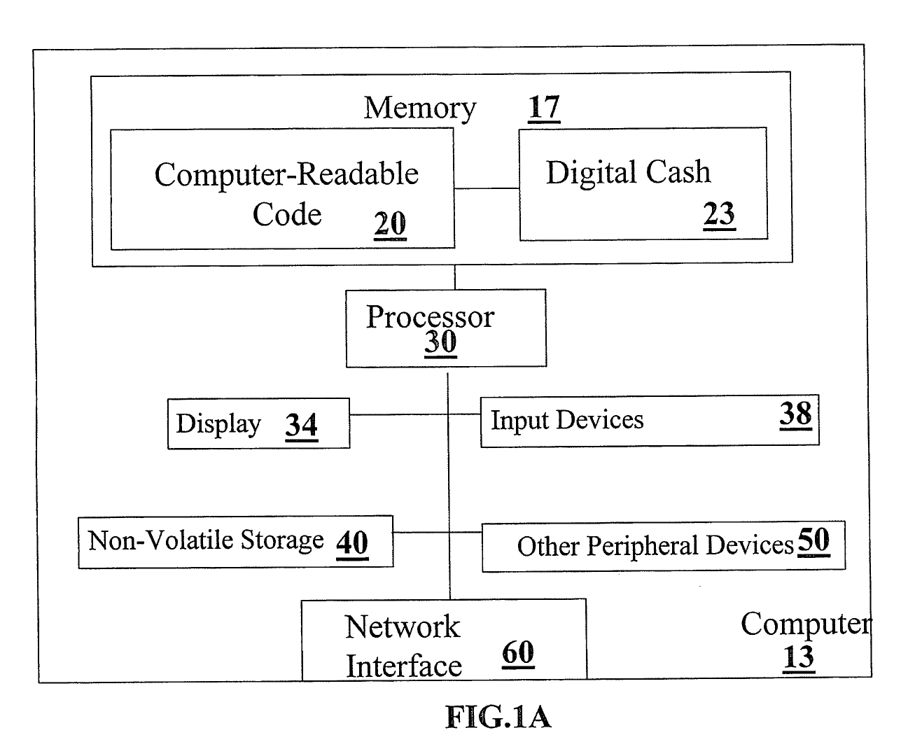

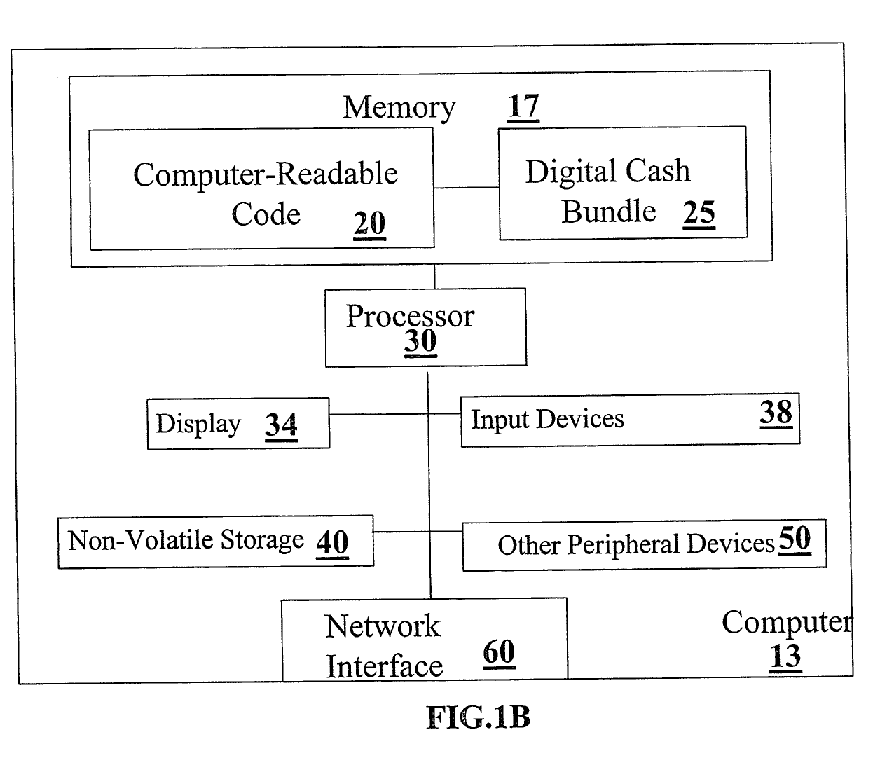

FIGS. 1A-1B illustrate one embodiment of a computer 13 (referred to as a “Host” device) including a processor 30. Processor 30 is shown coupled to a memory 17, a display 34, a non-volatile storage 40 (e.g. a hard disk drive and/or flash memory device), one or more input devices (e.g. a stylus, keyboard, keypad, mouse, or any combination thereof, other peripheral devices 50 (e.g. printer, etc) and a network interface 60 such as a network interface card. Exemplary “computer” 13 lost devices include but are not limited to microcomputers, cell phones, personal digital assistants, and the like.

Processor 30 may be configured to execute instructions and to process data according to a particular instruction set architecture (ISA). In one embodiment, processor 30 may be configured to implement an x86 compatible ISA, although in other embodiments it is contemplated that any desired ISA may be employed, such as the SPARC V9 ISA, PowerPC compatible ISAs, or MIPS compatible ISAs, for example. (SPARC is a registered trademark of Sun Microsystems, Inc.; PowerPC is a registered trademark of International Business Machines Corporation; MIPS is a registered trademark of MIPS Computer Systems, Inc.).

In various embodiments, memory 17 may comprise any suitable type of system memory as described above, such as FB-DIMM, DDR/DDR2 SDRAM, or RDRAM®, for example. Memory 17 may include multiple discrete banks of memory. Also, in some embodiments memory 17 may include multiple different types of memory.

In some embodiments, computer 13 may include more than one instance of the devices shown, such as more than one processor 30, for example. In various embodiments, computer 110 may be configured as desktop computer, a laptop computer, a personal digital assistant, a cellular telephone, a rack-mountable server system, a standalone system, or in any other suitable form factor. In different embodiments, computer 13 may be configured as a client system or as a server system.

In some embodiments, processor 30 may be configured to run operating system software (referred to as the “host operating system”) such as Microsoft Windows (including but not limited to Windows 2000, Windows XP, Windows CE, Microsoft Windows Mobile, PocketPC, or future versions of Windows including but not limited to the version presently referred to as “Vista”), BeOS, Symbian OS, Palm OS, RIM BlackBerry OS, Linux (e.g. RedHat Linux, Suse Linux or any other version of Linux), MacOS (e.g. OS X or any other version of MacOS), IBM AIX or Sun Microsystems Solaris. Operating system software may in turn provide an environment in which processor 30 may execute additional software modules in the form of applications, programs, or processes designed to perform specific functions.

In some embodiments, the host operating system software includes or is associated with a graphical computing environment (e.g. a “desktop” environment such as that provided by Windows or OS X or PocketPC, or one of the desktop environments associated with Linux such as Gnome or KDE, where the term “desktop” refers to an electronic analogy of items on a desktop and is not intended to be limiting to desktop computers). Typically, the graphical computing environment associated with a given operating system provides functionality for manipulating (e.g. dragging-and-dropping) one or more icons.

In a graphical computing environment, “drag” refers to moving an icon or other image on a display screen. To drag an object (e.g. an icon) across a display screen, one usually selects the object with a mouse button (“grab” it) and then moves the mouse while keeping the mouse button pressed down.

“Drag-and-Drop” is a mechanism provided by graphical user interfaces (e.g. graphical desktop environments) and applications to allow the user to drag objects to specific locations on the screen to perform actions on them. For example, in the Macintosh environment, one may drag a document and drop it on the trashcan icon to delete it. Another common use of drag and drop is moving or copying one file from one folder to another. When implemented well, “drag and drop” may be faster and more intuitive than selecting menu options or typing commands.

Although the concept of dragging and dropping has been explained in terms of a computer mouse, this is not intended as limiting, and different host devices may provide different input peripherals whose input is operative to drag and/or drop an object.

It is noted that these graphical icons (e.g. icons that may be dragged-and-dropped) may be associated with many types of objects, though typically the graphical desktop environment is operative to represent various file system objects (e.g. files, directories, etc) as manipulable graphical icons. The graphical icon is provided is a graphical picture (e.g. a small graphical picture) used to represent objects.

Graphical icons usually reside within or are accessible from a “desktop”, or workspace provided to a user. Typically, the desktop provides access to a plurality of “windows” and/or graphical icons and/or “folders” (i.e. containers for one or more documents or files or graphical icons, which may also be used to organize information). Furthermore, in some embodiments, the operating system and/or the graphical computing environment provides APIs or other appropriate interfaces for invoking or modifying graphical desktop functionality. These APIs and other interfaces may be useful tools for developers when developing software applications which reside within the graphical computer environment.

For the remainder of this disclosure, embodiments of the invention will be explained in terms of the Windows operating system (in particular Windows XP), though it is appreciated that any operating system (e.g. MacOs, Linux, etc) and any graphical computing environment is within the scope of the present invention.

Referring once again to FIGS. 1A-1B, it is noted that the memory is operative to store both data as well computer-readable code 20. It is appreciated that the computer readable code may be provided in any format and in any language, including but not limited to binary code (e.g. machine code or byte code) and human readable code (e.g. code associated with compilable languages such as C or C++or C# or Java, scripts, macros, etc). In some embodiments, the computer readable code includes directives (even “primitive” directives) operative to invoke services, or modify default behavior of services, provided in a graphical environment, such as a graphical environment associated with an operating system.

One example of “data” that may be stored in the memory is “digital cash.” As used herein, “digital cash” is electronic data (e.g. a string of bits, a string of characters, etc.) that may be presented to a “digital cash clearinghouse” (e.g. a financial institution or an representative of a financial institution such as a machine or server) in exchange for a sum of real “traditional” money (e.g. having a non-negotiable value) or an object or commodity whose value is equal to the sum of real money.

A digital cash payment is digital cash that is sent from a first user (possibly an anonymous user) to another user (possibly an anonymous user). This “another” user may at some point redeem this digital cash payment in order to increase the balance of his or her cash account (e,g. digital cash account or real cash account), or may redeem this digital cash for real digital cash. Alternatively or additionally, this “another” user may transfer the digital cash payment to a third user, who may then redeem the digital cash. Though not a requirement, in many examples digital cash payments are transferred from one user to another user in exchange for goods or services.

It is noted that digital cash payments may reside outside of any particular account. Digital cash bundles are one example of digital cash payments, and provide a mechanism for digital cash to bide its time in volatile or non-volatile memory outside of any particular digital cash account. Furthermore, it is noted that later in this disclosure, the concept of “repeat digital cash bundles” or payments are disclosed, and it is noted that these repeat digital cash bundles or payment are also considered “digital cash payments.”

In some embodiments, digital cash is provided within a digital cash bundle (usually associated with or implemented as one or more files having one or more optional specific properties), and the host device is operative to store digital cash bundles within the memory 17. As used herein, a “digital cash bundle” is a given amount or “lump” of digital cash embedded within or associated with a container (e.g. a manipulable container) such as a file or a graphical icon. Typically, digital cash bundles may reside outside of a digital cash account, just as paper money resides outside of a bank account. Not wishing to be bound by theory, it is noted that use of digital cash bundles provides a way for digital cash to “bide its time” in volatile and/or non-volatile memory without being stored in a digital cash account.

Like paper money, digital cash bundles are associated with a “face value” specifying how much money the bundle is worth. Unlike real cash which is available only in denominations determined by the Federal Bank, digital cash bundles may, in some embodiments, bear any desired denomination the user desires.

It is noted that typically, the digital cash bundle is associated with a unique sequence of electronic bits or characters, which provide a unique identifier for a give digital cash bundle, and function like the serial numbers on paper money bills.

### Visualization of Digital Cash Bundles and the Digital Cash Management Application

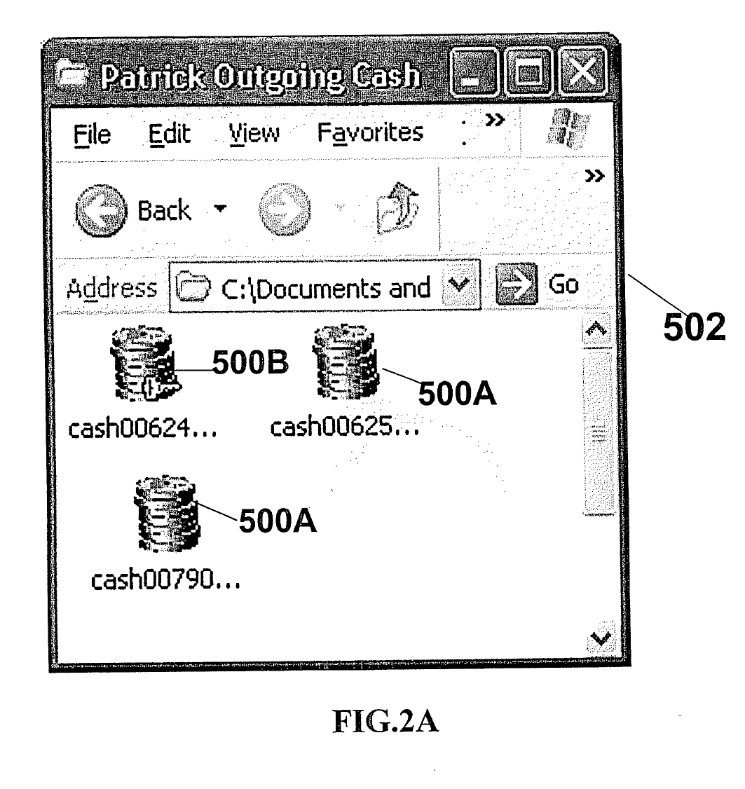

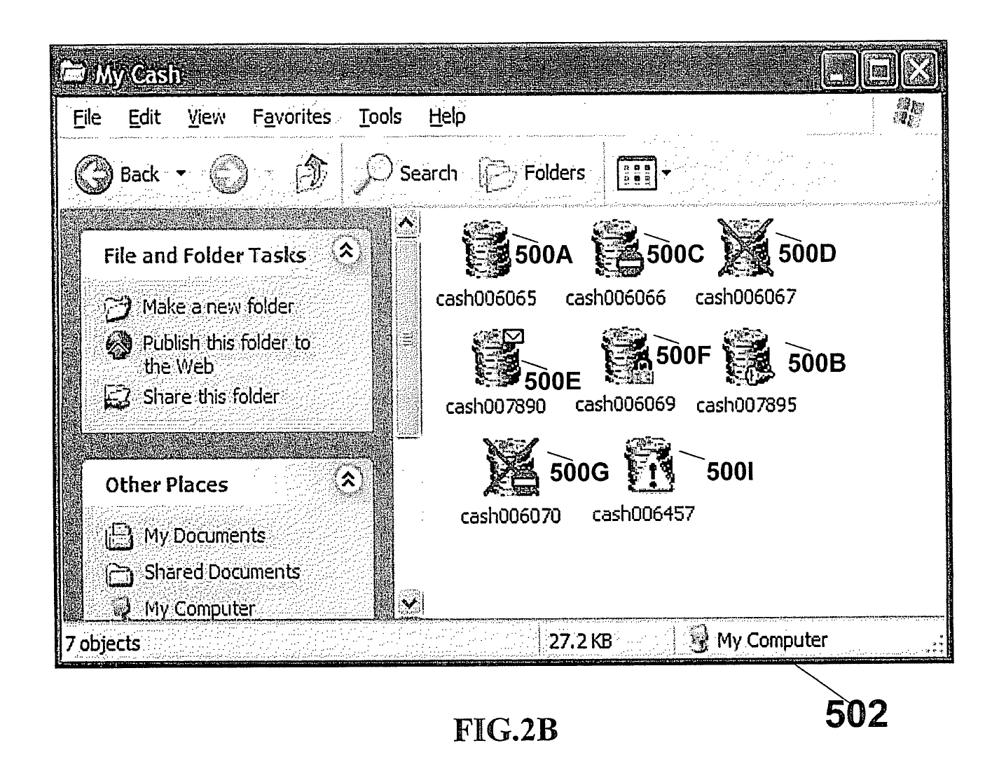

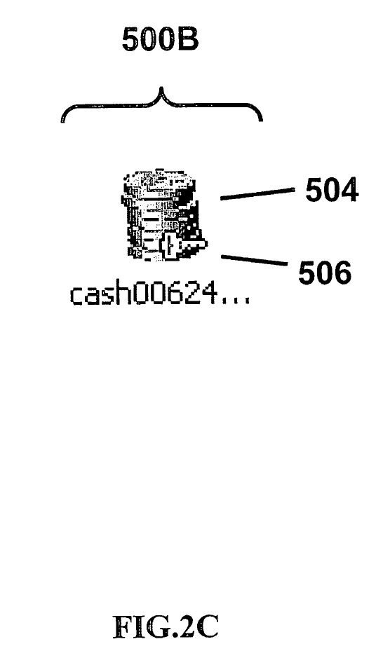

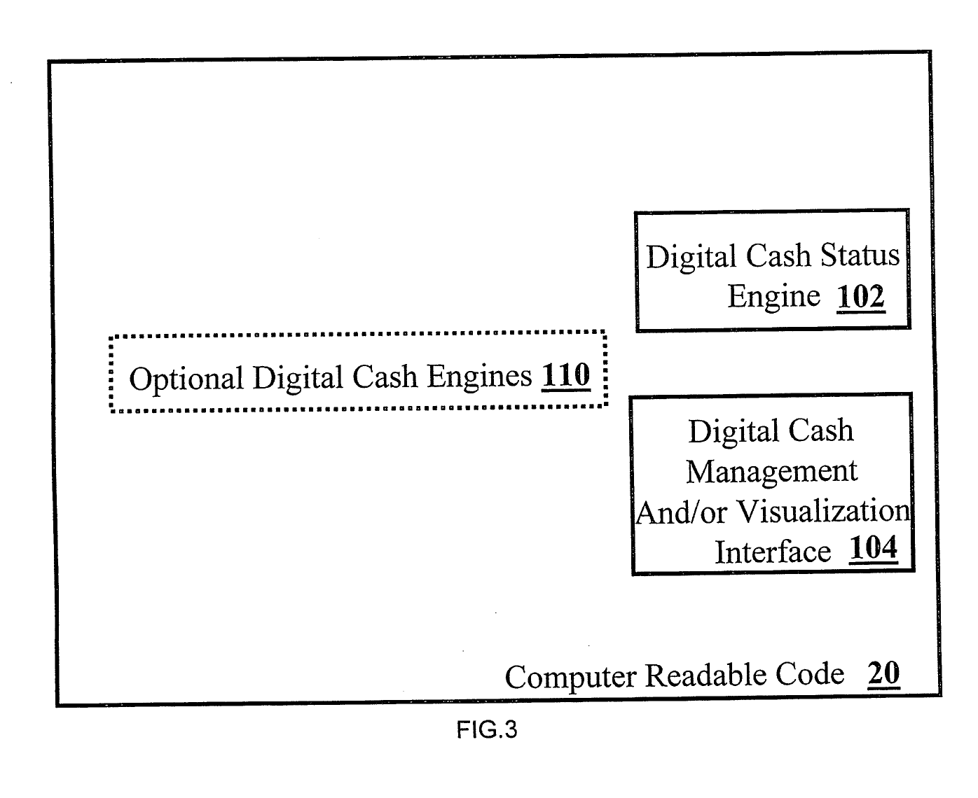

Certain embodiments of the present invention provide systems, methods and computer-readable code for representing digital cash bundles as graphical icons, as illustrated in FIG. 2A-2B. FIGS. 2A-2B provide images of exemplary digital cash bundles represented as graphical icons 500 embedded within a in a frame 502 (i.e. a folder). Although the graphical icon provided in FIGS. 2A-2B is an image of a small pile of coins, it is appreciated that any graphical icon image (for example, an image of a bank note or any other image) is within the scope of the present invention.

FIG. 2 provides a diagram of an exemplary system for visualizing digital cash according to some embodiments of the present invention which is provided as computer readable code 20. As illustrated in FIG. 2, this system includes at least one of a digital cash status engine 102 for determining at least one cash attribute of a digital cash bundle and a digital cash management and/or visualization interface 104 for representing the digital cash bundle as a graphical icon. Furthermore, the exemplary system includes one or more digital cash engine 110. The role of each of these components will be discussed below.

According to some implementations, some or all of the functionality of the system of FIG. 2 is provided by a digital cash management application (not shown) which resides in memory 17 of one or more host computers 13. In one particular example, the digital cash management application is a Windows application, for example, a Windows application which may be installed on a machine 13 running a Windows operating system.

As used herein, a “digital cash management application” is a collection of one or more modules (i.e. software module, hardware module, or module implemented as a combination of software and hardware) that together implement at least some aspects of visualization and/or management of digital cash on a machine. It is noted that just as with other software applications that may exist in different versions, wherein each version has a different combination of modules (e.g. software modules), the “digital cash management application,” according to different embodiments, may be provided in different versions. Different versions may include one or more of the modules described herein, or any combination thereof. Exemplary modules include but are not limited to digital cash management and/or visualization interface 104, the digital cash status engine 102, and any one or more of the optional digital cash engines 110.

According to some embodiments, the digital cash management application is implemented as a Windows software application associated with a defined file type. This allows for the utilization of operating system resources whereby certain files are associated with certain graphical icons that are stored in specific repositories recognized by the operating system. In exemplary embodiments, the digital cash bundles themselves are implemented as files, e.g. files that are explicitly recognizable by the operating system's file system.

According to these exemplary embodiments, these digital cash bundle files have two characteristics:
1. A type (e.g. analogous to the .doc file type associated with the MS-Word software application, analogous to the “.xls” type associated with the MS-Excel software application, etc.), indicating to the Host operating system that this file represents a digital cash bundle which is associated with the digital cash management application; and
2. The file name and contents are determined by the digital cash management application, and provide whichever details are required to fully specify the attributes of the cash bundle, including but not limited to value, the identity of who issued the cash bundle and restrictions on who may receive or redeem the cash bundle.

An additional discussion of visualization features provided by the digital cash management and/or visualization interface 104 is presented in the section later in this disclosure entitled “Visualization Features of the digital cash management and/or visualization interface.”

Operating System Resources for Associating File Types, Software Applications and Graphical Icons

In some embodiments, the Host operating system is configurable such that certain file types are associated with certain graphical icons, for example, on the user-accessible graphical desktop. For example, under Microsoft Windows, the mechanism to define file types is by way of their file extension, which is the part of the file name after the last occurrence of the “.” character.

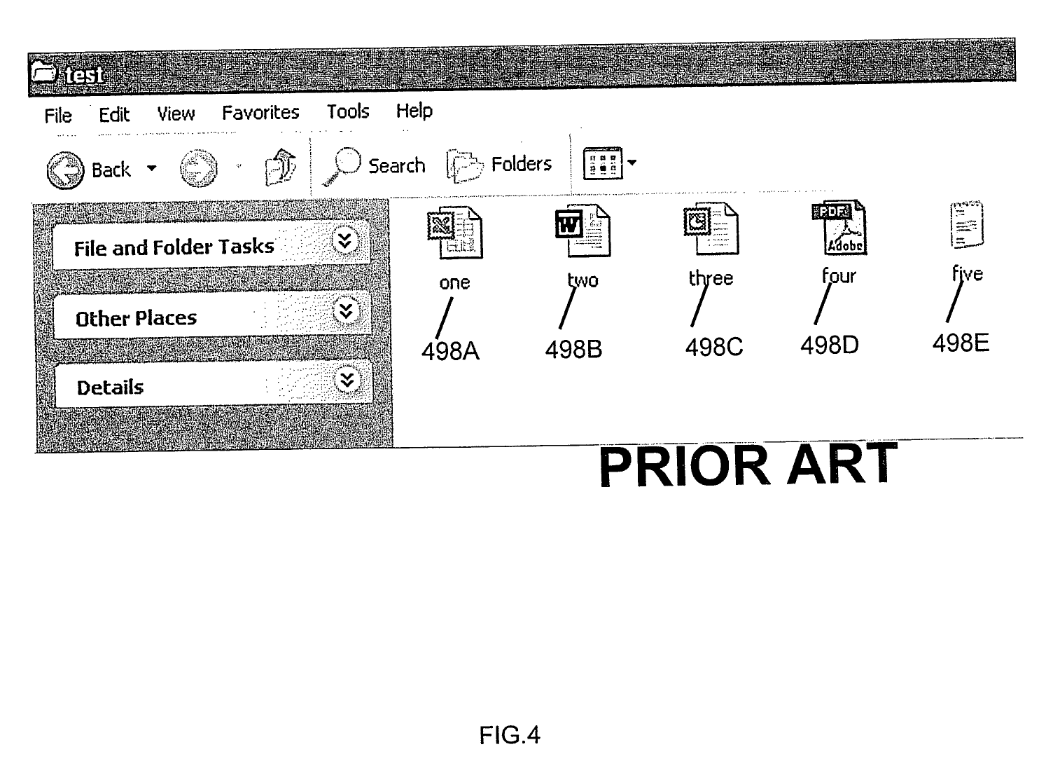

This Host operating system property where specific file types are associated with specific graphical icons is illustrated in FIG. 4, where five files, each of a different type (for example, each having a different file extension) reside within a folder called “test,” where each file is associated with a different respective graphical icon. This association is carried out using operating system icon-file type association resources. In particular, specific file types are each associated with respective software applications registered with the Host operating system, and the Host operating system is operative to associate file types of a specific software application with a respective graphical icon. According to the example of FIG. 4 (i.e. the example illustrating known properties of certain operating systems), the file “one.xls” is associated with the MS-Excel software application which in turn is associated with icon 498A, the file “two.doc” is associated with the MS-Word software application which in turn is associated with icon 498B, the file “three.ppt” is associated with the MS-Power Point software application which in turn is associated with icon 498C, the file “four.pdf” is associated with the Adobe Acrobat software application which in turn is associated with icon 498D, and the file “five.txt” is associated with the Notepad software application which in turn is associated with icon 498E.

It is noted that under Microsoft Windows, certain files types are associated by default with certain applications—for example, files with a .txt extension are assumed to contain text files by default, and are associated by default with the Notepad application This mechanism can be customized and/or extended, and the mechanism for defining a new file type is known as “extending the Windows Shell”. An application which extends the shell is called a “Shell Extension”. One of the mechanisms which can be implemented by a Shell Extension is called a “File Association”. This mechanism tells the Windows Shell how to handle specific files, such as text files or digital cash bundle files. The Windows Shell knows which file-associations exist and how to handle them by looking in the Registry repository. This repository contains a hierarchy of named-keys, which can have sub-keys or values. Under the top level hierarchy called “HKEY_CLASSES_ROOT”, the sub-keys starting with a “.” determine file extensions and which software application handles them (for example: the key named “.txt” represents files which end with a “txt” extension).

As will be explained below, it is noted that the aforementioned mechanism for associating certain file types with certain software applications registered with the Host operating system is useful also for associating these file types with graphical icons (as illustrated in FIG. 4. Mechanism(s) provided by the operating system for associating specific file types with specific graphical icons are collectively referred to as “operating system icon-file type association resources.” It is noted that many operating systems, such as Windows, allow these association resources to be customized so that specific file types associated with a registered software application are associated with icons that are also associated with the registered software application.

Therefore, according to some embodiments, at least a part of the digital cash management and/or visualization tool 104 may be implemented using these file association resources of the Host operating system. Thus, according to different embodiments, the digital cash management and/or visualization interface 104 may include various directives and/or image files for configuring the operating system, which may reside at least in part in the operating system registry or any other repository where operating system configuration directives and/or graphical icons are stored.

It is noted that although examples are provided where the digital cash bundle is implemented as a file, this is not a limitation of the present invention, and other implementations of digital cash bundles, for example, as a string of bits not structured as a file, are within the scope of the present invention. Furthermore, although examples are provided wherein operating resources for associating file types with icons and/or registered software applications are provided in order to display digital cash bundles as graphical icons, this is not a limitation of the present invention, and implementations where the Host 13 operating system does not provide this functionality, or implementations that do not invoke these operating system association resources (for example, implementations that provide code for displaying the icons from “scratch” as, for example, a Java applet or application or as a stand alone application) are also within the scope of the present invention.

Use of Operating System Resources for Associating File Types, Software Applications and Graphical Icons for Visualizing Digital Cash Bundles

According to one illustrative example, the digital cash management application is associated a given file extension, for example the ‘.vc$’ file extension. Thus, according to this example, digital cash bundle files have the .vc$ file extension.

Under Microsoft Windows, to handle this type of files, a key called “.vc$” is created under HKEY_CLASSES_ROOT. Under this root, some more keys are defined. One of those values is the default value and it states the Programmatic ID (ProgID) of the shell-extension program, packaged for example as a Dynamic Link Library (DLL) installed by the digital cash management application. This ProgID is the name of another key under “HKEY_CLASSES_ROOT, which is usually a string representing the name of the program that is handling the file association, and its version. For example, if the digital cash management application uses the ProgID called “Verdicash.1”, the default value of “HKEY_CLASSES_ROOT\.vc$” is “Verdicash.1” and the key which describes how such files will be is “HKEY_CLASSES_ROOT\Verdicash.1”. According to this example, this key's sub-keys and values contain detailed instructions to the Windows Shell on how to treat files of this type. In our example, the key's sub-keys and values tells the shell how to handle .vc$ files. For example, the keys below could be set by the digital cash management application:
The default value: a literal name for this type of files, for example “Verdicash Money”. This will be shown in some places in Windows (for example when checking the properties of such file).
The default value under “DefaultIcon” sub-key specifies the full path of the default icon to be associated with this type of files.
   To implement Some of the Additional features described later in the present disclosure, the digital cash management application may export certain functionalities by implementing Component Object Module (COM) interfaces. In order to do that, the digital cash management application may create a Globally Unique Identifier (GUID). This GUID may be created, for example, by using the Microsoft utility “GENGUID.EXE”. In order to associate the digital cash management application with this GUID in the Windows Registry repository, the Microsoft utility “REGSVR32.EXE” may be used. According to this example, once this is done, whenever there is a need to refer to a specific GUID, for example, for implementing an “Icon Handler” (which will be described later), that GUID will be used to refer can be made to the digital cash management application
   An Exemplary Digital Cash Bundle File Format

Although there is no limitation on the particular format of digital cash bundle files, exemplary implementations will be discussed. Thus, according to some embodiments, the digital cash bundle files are human readable files and/or files provided in pre-defined formats that can be parsed and understood by humans and/or other software applications to achieve interoperability.

According to one exemplary possible implementation, this is achieved by using industry-standard public-key encryption to encrypt and sign the relevant portions of digital cash bundles, while using the EXtensible Markup Language (XML) to store that information.

The below is a possible XML representation of one exemplary digital cash bundle, issued by VerdiCash, Inc:

<?xml version =“1.0” encoding=“UTF-8”?>
<DigitalCashBundle>

<Origin>VerdiCash, Inc.</Origin>
<Application>http://www.verdicash.com/Install.htm</Application>
<ClearingHouse>Bank Of Metropolis</ClearingHouse>
<HASH>FAB8A64C88FCBBC53D2226D87128AA8E</HASH>
<Basic>

<ID>821771624</ID>
<CreationDate>12/10/2005 10:33</CreationDate>
<Creator>John.Doe@hotmail.com</Creator>

</Basic>
<PaymentInfo>

<Amount>10.00</Amount>
<Currency>USD</Currency>
<ExpirationDate>01/10/2006 10:33</ExpirationDate>
<TargetWallet>Mary@msn.com</TargetWallet>
<TargetWallet>HelenOfTroy@yahoo.com</TargetWallet>

</PaymentInfo>
<AcceptanceRequest>This payment represents full
compensation, direct

and indirect, for damages caused by myself to a Ford Taurus Lic.#
T689W8 parked on Regent Street on November 23, 2005

</AcceptanceRequest>

</DigitalCashBundle>

Throughout this disclosure, the XML file above will be referred to as the “exemplary XML file.”

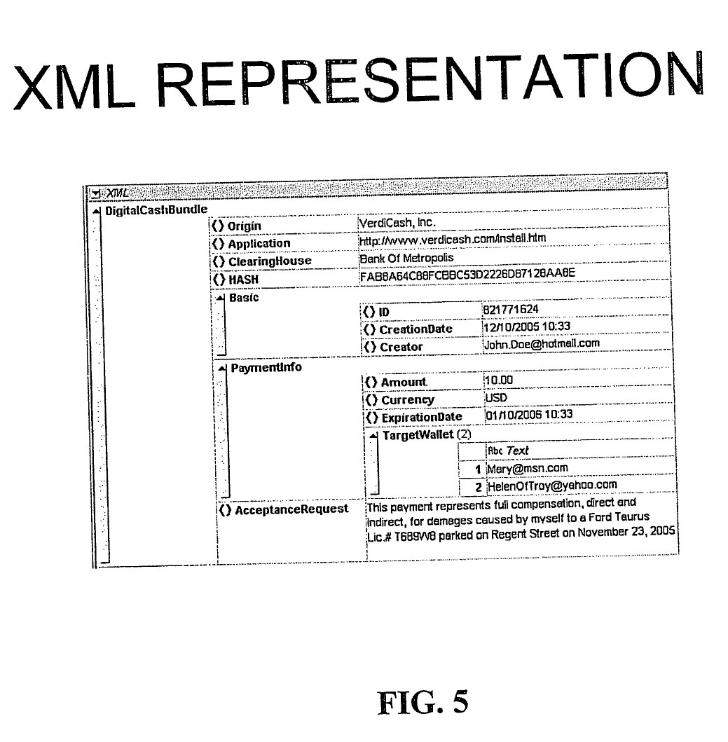

FIG. 5 shows the same digital cash bundle viewed with an XML viewer.

It is noted that typically, digital cash bundles are associated with a unique sequence of electronic bits or characters, which provide a unique identifier for a given digital cash bundle, and function like the serial numbers on paper money bills. Like other forms of digital cash, digital cash bundles may also be presented to a Clearing House in exchange for real money.

One example of this unique sequence of electronic bits or characters is the Hash field as provided in the aforementioned exemplary XML file (i.e. the field whose value is “FAB8A64C88FCBBC53D2226D87128AA8E”). Typically, this field is generated and/or used by a Digital Cash Clearinghouse.

As used herein, a “Digital Cash Clearinghouse” represents an entity (i.e. one or more financial institutions employing one or more computer devices such as Internet servers) which may issue digital cash, redeem a digital cash payment or bundle into a digital cash account (referred to as an “electronic wallet”), validate digital cash, and/or “convert” digital cash to real cash or vice versa. It is noted that the “converting” of digital cash to real cash or vise versa, i.e. performing a transfer (e.g. an authorized transfer) of digital cash into a “traditional account” or “real money” account (including but not limited to bank accounts, credit card accounts, and other money accounts), or performing a transfer of cash or funds from the traditional account into a digital cash account, may entail issuing digital cash as well.

In the preceding paragraph, the “Digital Cash Clearinghouse” was described as a single entity, though it is appreciated that the services of the “Digital Cash Clearinghouse” may, in fact, be provided by different entities (i.e. different financial institutions or different computational devices).

Returning to the example of the hash field of the exemplary XML file, it is noted that this Hash field is composed using defined industry standard encryption and signature algorithm, and the information in the XML file suffice to locate the required encryption keys to decode the hash. Note that in most implementations, the Hash field may repeat attributes specified in other fields. For example, the value of the cash bundle may be a field on its own, as well as part of the Hash. This is because the Hash is signed by the Clearinghouse which prevents tampering.

With reference to the exemplary XML file, it is noted that not every digital cash attributed described in the XML file (or a file in another format) is required. In some embodiments, specific implementations of the digital cash management application may ignore unsupported fields.

Additional Optional Features Associated with the Digital Cash Management and/or Visualization Interface 104

It is noted that certain details associated with a specific implementation for visualizing digital cash have been discussed above, in the sections entitled “Description of Exemplary Features of One Implementation of the Digital Cash Management Application” and “An Exemplary Digital Cash Bundle File Format.” Thus, in some embodiments of the present invention, digital cash icons are presented without any particular visual features to distinguish between different types of digital cash bundles (see FIG. 2A, icons labeled 500A).

Alternatively or additionally, different digital cash bundles are presented differently in accordance with digital cash attributes of each respective digital cash bundle (i.e. graphically modified icons are presented, for example, by the digital cash management and/or visualization interface 104). Some exemplary “digital cash attributes” provided within the exemplary XML file are “CreationDate”, “Creator”, “TargetWallet.” These attributes, and other attributes, are discussed below.

Thus, in some embodiments, the digital cash management and/or visualization interface 104 is associated with a digital cash status engine 102 for determining at least one attribute of the digital cash (i.e. digital cash bundle or digital cash bundle file or digital cash payment). Typically, the determining of at least one attribute is carried out by the digital cash status engine 102 by analyzing or understanding electronic data associated with the digital cash that resides in memory 17 and/or non-volatile memory 40. In one example, this determining includes parsing an XML file or other structured file and determining the values of various attributes.

In some embodiments, different types of digital cash bundles may be visualized by using a set of different icons that share a “common look.”, In one example, this may be carried out by presenting all cash using a central or primary icon, for example a small pile of coins, but with additional graphical elements overlaid on the common icon, to indicate to the user in a visual manner important differences between cash bundles in terms of attributes or status.

For example, as illustrated FIGS. 2A-2B, an exemplary implementation could visualize the following attributes and status of digital cash bundles:
Digital cash bundles corrupted in some way may be presented with an exclamation mark on top or in a corner of the digital cash icon (for example, bundle 500I)
Digital cash bundles (for example, bundles 500D or 500G) that have expired or have been cancelled by the issuer may be presented a large X across the digital cash icon.
Digital cash bundles (for example, bundles 500C or 500G) intended (assigned) for a specific beneficiary (target electronic wallet) may be presented with a “no-entry” sign when displayed on machines associated with a wallet other than the one specified as beneficiary
Digital cash bundles (for example, bundle 500F) intended (assigned) for the wallet of the user herself (assigned to the wallet running on the local machine), may be presented with a lock icon on top or in a corner of the digital cash icon.
Digital cash bundles (for example bundle 500B) protected by a password may be presented with a small lock or key on top or in a corner of the digital cash icon
Some implementations may allow the creator of a digital cash bundle (for example, bundle 500E) to receive a notification when a user accepts (redeems) that digital cash bundle, along with information about the wallet identification of that user. Thus, the presence of this small envelope in a corner of the digital cash bundle may alert the user of this fact.

In the examples of FIGS. 2C, the graphically modified cash icon 500B includes a primary icon 504 (typically, the icon of the “common theme”) combined with a secondary icon 506 (typically, the icon which can appear or not appear, or can change, in accordance with the digital cash attribute). In some embodiments, the secondary 506 icon is superimposed on the primary icon 504.

The concept of accepting or redeeming digital cash payments or bundles will be discussed at a later stage of this disclosure.

The non-limiting list above provides illustrative examples of possible useful attributes of digital cash bundles which may be visually associated with a given digital cash bundle represented as a graphical icon. In some embodiments, the actual set of attributes to be displayed is determined by the digital cash management application residing on a given machine. It is appreciated that the actual icons and icon schemes presented here are provided for illustrative purposes only, and that different embodiments of the present invention may use other icons and/or icon schemes.

It is noted that in some embodiments, a given cash bundle may be associated with more than one visual indications of a given digital cash attribute or given cash attributes. Thus, for the bundle 500G, more than one graphical element (i.e. the do not enter and the X) is added to a single icon.

It is noted that in some embodiments, one or more digital cash attributes are determined in accordance with a least one environmental and/or dynamic factor (i.e. a factor which is not intrinsic to the cash bundle). Non-limiting examples of environmental factor include temporal factors and/or locations in which the cash bundles, or factors relating to events occurring in the outside world. In some embodiments, these factors may be “dynamic” factors which change in accordance with time and/or cash bundle location and/or events that transpire outside of the digital cash bundle.

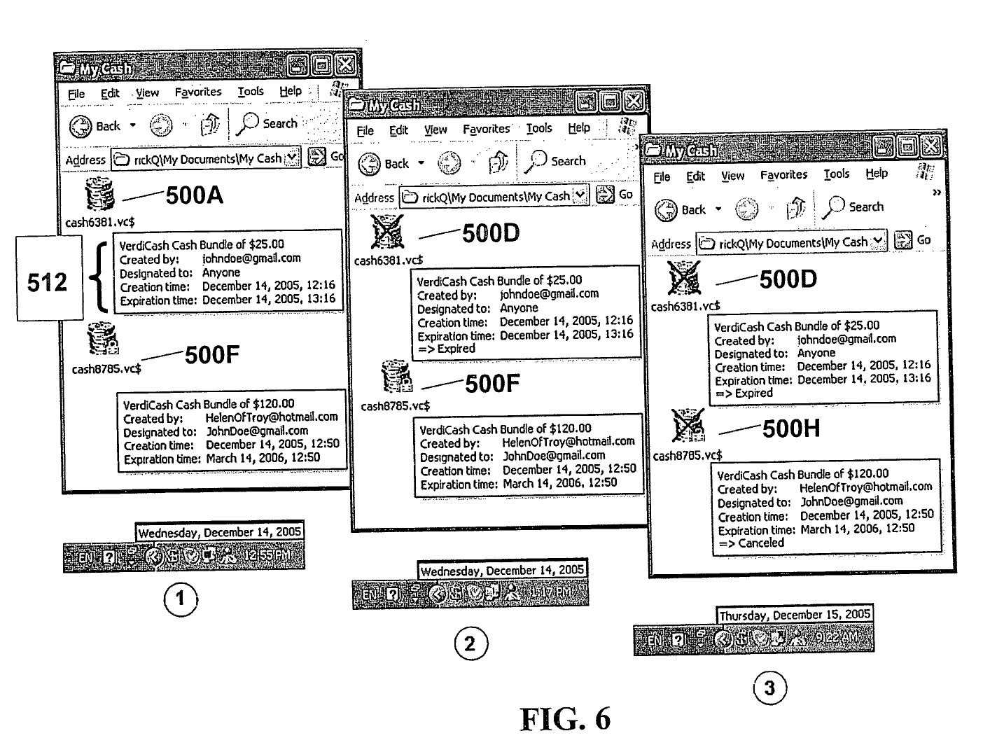

FIG. 6 shows the temporal evolution of the status of two digital cash bundles and how the determined “current time” influences how these bundles are displayed:
Step 1: the time is Dec. 14, 2005 12:55 pm and user Patrick has two digital cash bundles, the top one 500A created by JohnDoe@gmail.com and expiring at 1:16 pm, the bottom one 500F created by HelenOfTroy@hotmail.com and expiring on March 14.
Step 2: it is 1:17 pm and the top bundle has now expired (displayed using icon 500D), as can be seen visually. Patrick regrets having forgotten to redeem the bundle before expiration.
Step 3: the next moning, Patrick can see that the Clearinghouse has notified his electronic wallet that HelenOfTroy@hotmail.com has canceled the bottom digital cash bundle (displayed using icon 500H), as can be visually recognized (i.e. this bundle is crossed out). Patrick regrets having trusted Helen and makes a note to accept from Helen only bundles with the non-cancelable attribute set.

According to some embodiments, a graphical user interface (for example, a digital cash management and/or visualization interface 104) is operative to decide at run-time which icon should be displayed, and is not limited to a fixed icon determined when the digital cash bundle file is created. In some embodiments, this is the case because the digital cash attributes are dynamic and/or environmentally determined, and thus the digital cash status engine 102 may determine these one or more attributes as a function of time, and pass this digital cash attribute data to the interface 104.

An exemplary implementation wherein secondary icons are associated with primary icons as part of a graphical icon assembly will now be described. Microsoft Windows is an example of a platform that supports such multiplicity of icons. Thus, on Microsoft Windows, the digital cash management application may implement several Component Object Module-interfaces, exposed by Windows in the Dynamic Link Library “SHELL32.dll”:
IPersistFile: by implementing the “Load” method, the digital cash management application is notified every time the Windows Shell starts handling a file. It can then, for example, save this name for later use or store it in a database of loaded file-names.
IExtractIcon: by implementing the “GetIconLocation” and “Extract” methods, the digital cash management application can select exactly which icon will be displayed, according to the contents of the digital cash bundle, for example a simple pile of coins, or adding a small lock picture overlaid, a “no-entry” sign overlay etc.
   To instruct the Windows Shell to use the above implementations, the digital cash management application may export a Global Unique Identifier (GUID) identifying the digital cash management application implementation of these interfaces and add a reference to it under the ProgID key in the registry, in a sub-key called “ShellEx\IconHandler.”

Although the implementation wherein operating system resources are invoked for associating or “fusing” a plurality of icons in a graphical icon assembly has been described, it is appreciated that there are many other implementations apparent to the skilled artisan which do not rely on these operating system resources but are within the scope of the present invention.

It is noted that in FIG. 6 textual information describing one or more digital cash bundle attributes is provided in a text box 512. Thus, according to some embodiments, visual indications of one or more digital cash attributes are provided as text.

In some examples, this text is not automatically displayed in association with the graphical icon, but is only displayed when the user moves the mouse pointer over the icon. It is noted that passing a mouse pointer over icon is one example of “user engagement” within a graphical icon. Thus, in some embodiments, a visual indication of a digital cash attribute (or an additional visual indication of a digital cash attribute) is displayed upon detecting a “user engagement” with the graphical icon.

Exemplary detectable user engagements with the graphical icon include but are not limited to passing of a locator associated with a user input device (e.g. a mouse pointer) within a proximity of the graphical icon, a clicking or double clicking of the icon, and a right click on the icon.

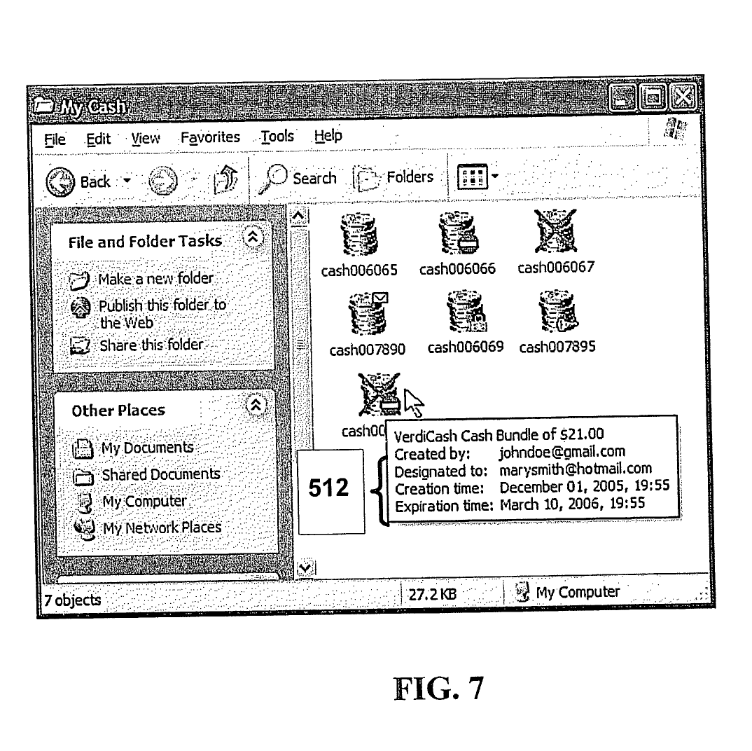

FIG. 7 illustrates how moving the mouse over one of the digital cash bundle in a folder results in the textual information 512 for that digital cash bundle being shown by the graphical operating system in a floating text box. Under Microsoft Windows, the textual information is called a “tooltip”. It is noted that the textual information 512 provided in FIG. 7 is one example of an “additional visual indication” indicative of one or more digital cash attributes.

To provide the tooltip, he digital cash management application needs to implement a number of Component Object Module (COM) interfaces, exposed by Windows in the Dynamic Link Library “SHELL32.DLL” and specific methods within these interfaces:
IPersistFile: as mentioned before, the “Load” method of the “IPersistFile” interface may be implemented.
IQueryInfo: by implementing the method “GetInfoTip” of the “IQueryInfo” interface, the digital cash management application can decide which text to show as the file's “tooltip” information, according to the contents of the digital cash bundle and/or digital cash attributes, including but not limited to the monetary value of the cash bundle, creation time, expiration time, the identity of the creator of this bundle, the identity of the wallet(s) allowed to redeem this bundle, and more.
   To instruct the Windows Shell to use the above implementations of the interfaces, the digital cash management application may add a reference to the Globally Unique Identifier (GUID) of the digital cash management application under the File-association key in the registry, in a sub-key called “ShellEx\{00021500-0000-0000-C000-000000000046}”.

### Digital Cash Bundles on Removable Media

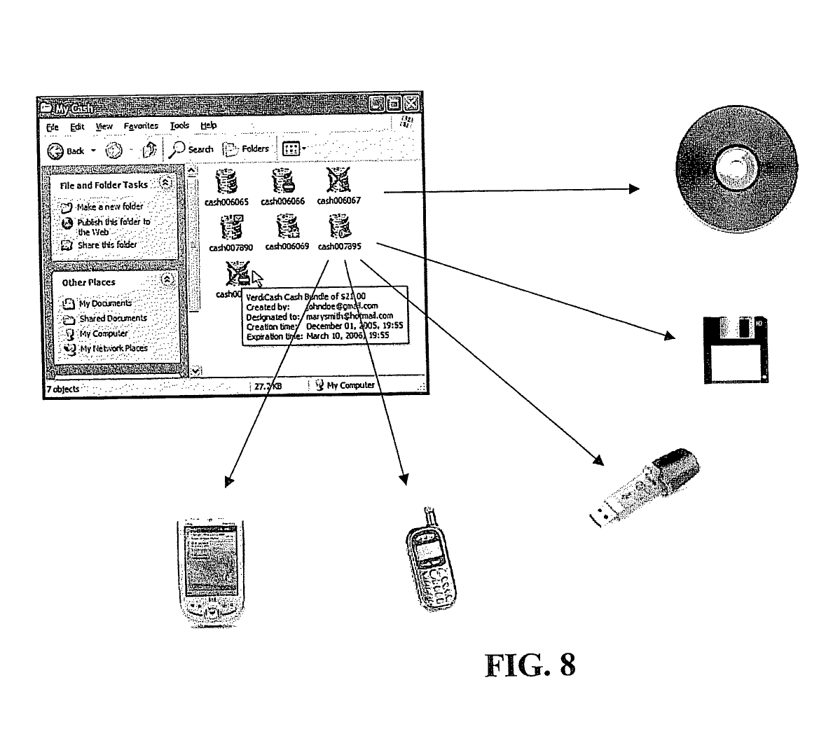

There is no explicit requirement to implement digital cash bundles or digital cash payments as files, and digital cash bundles and/or payments may be provided in any manner as electronic data which resides in volatile and/or non-volatile memory. In some embodiments, this electronic data (for example, digital cash bundle files) may be stored in portable removable media (for example, writable CD or DVD, a flash device such as a USB flash device, or a floppy disk) in order to carry digital cash, as illustrated in FIG. 8. In a later section entitled “Exemplary Business Methods for Dispensing Digital Cash” certain Business Methods for Dispensing digital cash will be described.

### Interface for Viewing and/or Sorting Digital Cash Bundles

It is recognized that there are situations where a plurality of digital cash bundles may reside in a given computational environment (for example, on one or more host machines), and a user may wish to sort these digital cash bundles (and/or sort graphical icons representing digital cash bundles, or any other object representing digital cash bundles) for one of many purposes. According to one example, the user may want to sort the digital cash bundle according to the face value of the digital cash bundle, expiration date, or earliest valid redeeming date, according to the identity of the issuer of the digital cash, or according to any relevant digital cash attributes. According to one non-limiting example, the digital cash bundles all reside in a given container (for example, a folder or directory of a file system), and the user wishes to view a sorted list of the digital cash bundles within that container.

Thus, some embodiments of the present invention provide a mechanism operative to sort the digital cash bundles (or a plurality of objects, where each object is representative of a respective digital cash bundle) which can be operated, for example, through an interface. According to one non-limiting example, the digital cash bundles are implemented as files, and operating system resources for organizing or handling files according to file characteristics (for example, associated with graphical interface file management and/or manipulation resources) are utilized. In particular embodiments, these Host operating system resources include resources for sorting (and/or for displaying a sorted list) of files in order to provide the user with an interface for sorting digital cash bundles (and/or objects representing digital cash bundles).

Nevertheless, this should not be construed as a limitation, and in alternative embodiments, a mechanism for sorting digital cash bundles that are not implemented as files is provided, or an alternative mechanism for sorting digital cash bundles files is provided. Implementations of the digital cash bundle sorting engine and/or interface that do not rely on Host operating system resources for sorting files according to file characteristics (for example, implementations coded in from “scratch” in C++ or another programming language).

According to one example where digital cash bundles are implemented as files, the Host operating system is an operating system from the Microsoft Windows family. Thus, it is recognized that the “Windows Explorer” feature of the Host operating system can display files in a folder not only as icons in various variations (using viewing modes called small or large icons, Thumbnails, Tiles, Icons or List), all of which utilize the mechanisms previously described that allow the digital cash management application to control which icon to show for each digital cash bundle.

Thus, according to this described example, the digital cash management application is associated with directives for configuring the Windows Explorer “Details” folder viewing interface. In the view(s) provided by this interface, several standard columns appear (such as name, type, modification date, etc.). The digital cash management application may thus configure the Windows Explore interface to add additional columns which provide details relevant to cash bundles, for example: value, expiration, special attributes, and more.

According to one exemplary implementation, the digital cash management application may implement a Component Object Module (COM) interface “IColumnProvider” which is exposed by Windows's “SHELL32.DLL” Dynamic Link Library. By implementing the methods “Initialize”, “GetColumnInfo” and “GetItemData”, the digital cash management application may add new columns to the Windows Shell “Details” view. For the Windows Shell to support this implementation, the digital cash management application should add a reference to the Globally Unique Identifier (GUID) of the digital cash management application in the registry. As this above operation refers to entire folders and not just specific files, a sub key should be added under the key “HKEY_CLASSES_ROOT\Folder\ShellEx\ColumHandlers”. The sub-key name may be the digital cash management application GUID.

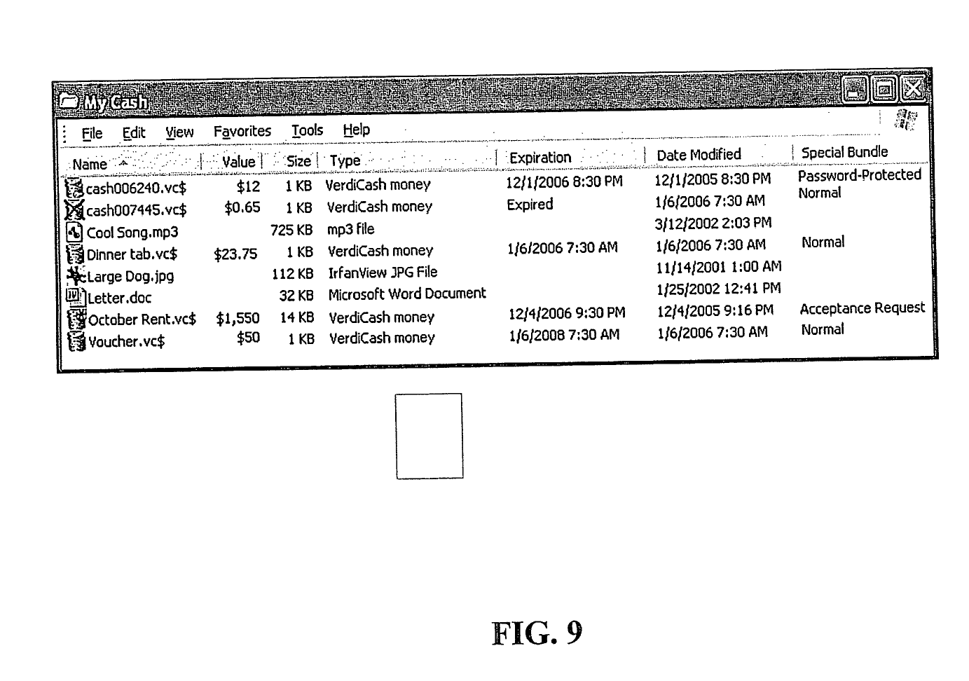

FIG. 9 illustrates how a folder containing digital cash bundles may display additional details in the “Details” folder view in accordance with exemplary embodiments. Note the presence of columns specific to digital cash bundles (i.e. digital cash bundle attributes). Thus, the bundle “cash006240.vc$” is a password-protected digital cash bundle, while the cash bundle “October Rent.vc$” is associated with an acceptance request. Although in FIG. 9 the digital cash bundle attributes Value, Expiration and “Special Bundle” (the type of special handling required by a given bundle) are presented, other embodiments with other combinations of attributes are contemplated.

It is noted that the Example of FIG. 9 relates to the specific case wherein digital cash bundles are implemented as files. Thus, in this example, files that are not digital cash bundles also reside within the same directory or folder as the digital cash bundle files (the files “Cool Song.mp3“, “Large Dog.jpg”, and “Letter.doc”). These columns contain information only relevant for digital cash bundles, and thus no value of these attributes is provided for the JPG (image), DOC (Word document) and MP3 (music file) do not show values in these cash-specific columns.

### Manipulating Digital Cash Bundles Files

As noted earlier, in some embodiments, digital cash bundles may be implemented as files, though this is not an explicit requirement. Thus, it is noted that by implementing digital bundles as files, certain functionality provided by exemplary Host operating systems (or a graphical computational environment associated with a Host operating system) for manipulating and/or accessing and/or visualizing properties of files may be employed to manipulate and/or visualize digital cash bundles. Nevertheless, it is appreciated that various features described in the context of digital cash bundle files residing on a Host with a given type of operating system may be provided for implementations where digital cash bundles are not implemented as files and/or in environments where the Host operating system lacks one or more of the described operating system features.

When the digital cash bundles are implemented as files, and the Host operating system is a so-called object-oriented file systems, each file may explicitly expose a rich set of properties Thus, a number of features for manipulating digital cash bundles may be implemented by invoking Host operating system resources for manipulating (i.e. searching, sorting, etc) files in accordance with these rich set of properties.

It is noted that when the Host operating system provides an object-oriented file system, file properties may be used as search criteria in queries across entire disk arrays, without needing to invoke the applications that created each type of files that are part of the search. For example, a user could search for all files containing a specified word, be it in a Word document or an email message, in a single search. It is expected that future versions of Windows will support object-oriented file systems. Thus, according to some embodiments, the invention is implemented on a host having an object-oriented file-system, and one or more properties of digital cash bundles through attributes of digital cash bundle files as supported by the Host object-oriented file-system.

Doing so will allow users to find, for example, all cash bundle that are still valid, are assigned to anyone, and are due to expire in the next 24 hours.

Digital Cash Electronic Wallet Application

Details of how digital cash bundles are displayed and manipulated in a variety of formats and contexts have been disclosed in accordance with some embodiments. A discussion of exemplary systems, methods and computer-readable code for creating digital cash bundles is now presented. It is noted that digital cash bundles may be generated according to a number of techniques, and the exemplary techniques described herein in no way are intended as limiting.

Thus, it is noted that hard cash in the real world may be dispensed by an Automatic Teller Machine (ATM) or by a machine or human in a bank branch office. In the digital world, according to some embodiments, this role may be assumed for digital cash by the digital cash electronic wallet application, for example a digital cash electronic wallet application running on the Host computing device.

As used herein, “a digital cash electronic wallet application” is a particular type of a digital cash management application, namely a digital cash management application that also includes functionality for directly or indirectly managing one or more digital cash accounts.

Typically, this digital cash electronic wallet application is a client application which exchanges data with one or more electronic wallet servers (e.g. over the Internet), which maintain one or more digital cash accounts (also referred to as “electronic wallets”). The digital electronic wallet application may generate directives to deposit digital cash to or withdraw digital cash from these valid accounts which are managed by the electronic wallet server.

Thus, in some embodiments, digital cash bundles are formed upon withdrawing of digital cash from a digital cash account. Not wishing to be bound by any particular theory or analogy, it is noted that this may be thought of as analogous to the act of withdrawing hard cash at an ATM. Once again, not wishing to be bound by any theoretical statement, it is noted that when digital cash resides in a digital cash account, this account serves as a container for the digital cash, and digital cash bundles allow digital cash to reside outside of a digital cash account in the same way that hard cash provides a container for real money.

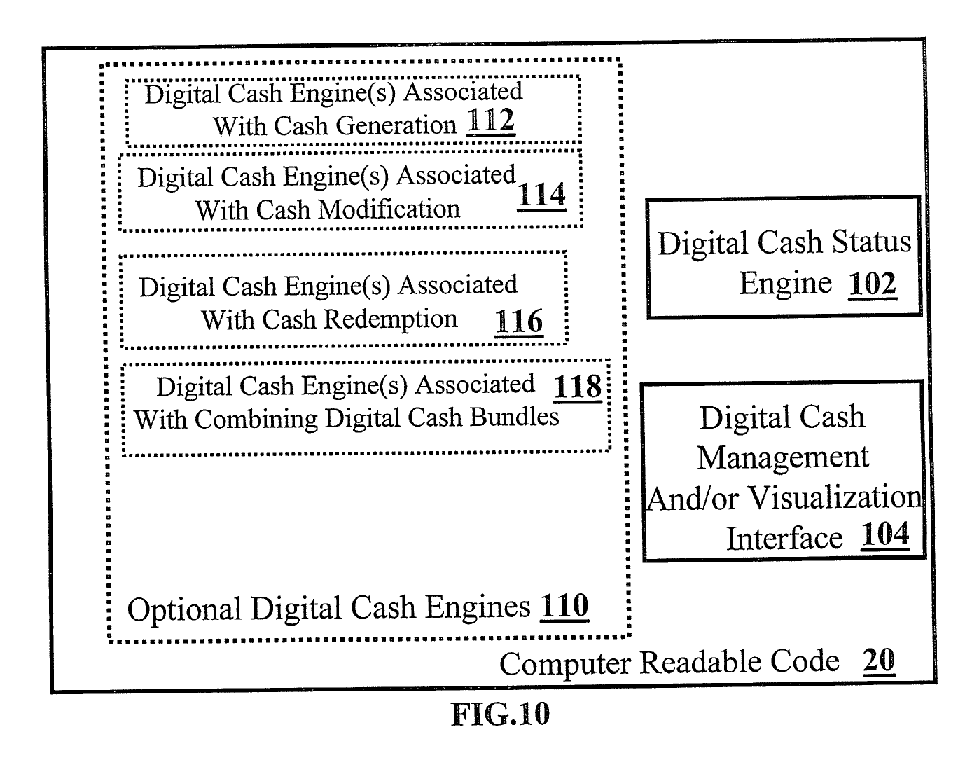

In some embodiments, the functionality for directly or indirectly managing one or more digital cash accounts is provided by one or more optional digital cash engines 110 provided as computer readable code 20. Thus, it is noted that FIG. 10 provides non-limiting examples of optional digital cash engines 110. Exemplary optional digital cash engines 110 include but are not limited to Digital Cash Engine(s) Associated With Cash Generation 112 (for example, generation of digital cash payments or digital cash bundles by withdrawing funds from a real or digital cash account), Digital Cash Engine(s) Associated With Cash Modification 114 (for example, modification of a digital cash bundle, e.g. by changing an expiration date or a target wallet), and Digital Cash Engine(s) Associated With Cash Redeeming 116 (for example, redeeming of a digital cash bundle by depositing this bundle into a digital cash account),

Redeeming of a digital cash bundle or digital cash payment (i.e. using a Digital Cash Engine(s) Associated With Cash Redeeming 116) generally entails crediting a digital cash (or real cash) account in exchange for the digital cash bundle or payment (i.e. eliminating the digital cash payment or bundle, or the validity of the digital cash payment, for example, by changing the status of the digital cash payment to ‘redeemed’ or ‘not redeemable’). Not wishing to be bound by theory, this is analogous to depositing hard cash into a bank account. When the customer deposits this hard cash into the account by handing the money to a teller or a machine, the customer forfeits the hard cash in exchange for crediting her account.

Thus, as used herein “redeeming” of a digital cash payment or digital cash bundle refers to the act of a user crediting digital cash account (or digital cash “electronic wallet”) by a value derived from the value of a digital cash bundle or digital cash payment (for example, the face value of the digital cash bundle or payment, or the face value minus a certain fee).

According to one example, when a digital cash bundle or a digital cash payment is “redeemed into an electronic wallet,” the electronic wallet application sends data to the centralized server which associates the redeemed bundle or payment with a digital cash account maintained by the server, and increments the account balance.

In some embodiments, one or more of the aforementioned engines are associated with one or more interfaces for receiving directives to configure behavior of the respective engine. It is noted that in exemplary embodiments discussed herein, the digital cash engines 110 as well as their associated interfaces will be described in the context of the digital cash management application, and in particular, the digital cash electronic wallet application, though it is appreciated that this exemplary implementation is not a limitation of the present invention.

Digital Cash Generation Engine 112 and Digital Cash Generation Interface

Although the functions of all of the aforementioned digital cash engine types and associated interfaces will be explained later in this disclosure, in this section the Digital Cash Engine(s) Associated With Cash Generation 112 as well as associated interfaces for generating digital cash and/or digital cash payments and/or digital cash bundles will be discussed.

In general, it is noted that there are many ways for a software application residing in a graphical computational environment (e.g. an environment associated with the Host operating system) to expose its functionality (e.g. functionality for enabling the user to start the application and/or mechanisms for the user to interact with the application while it is running) to users One exemplary mechanism whereby an application provides this functionality employs the “taskbar,” and in particular, “notification” graphical icons of the taskbar. In the Windows environment, this taskbar typically resides in the lower-right hand side of the screen, and contains a plurality of application “notification” graphical icons, where user engagement with a given notification application icon is operative to invoke the respective application.

Thus, according to some embodiments, the digital cash electronic wallet application as well as the associated Digital Cash Management And/or Visualization Interface 104 may be associated with one or more notification icons of the taskbar which are operative to invoke functionality of the interface 104 or application.

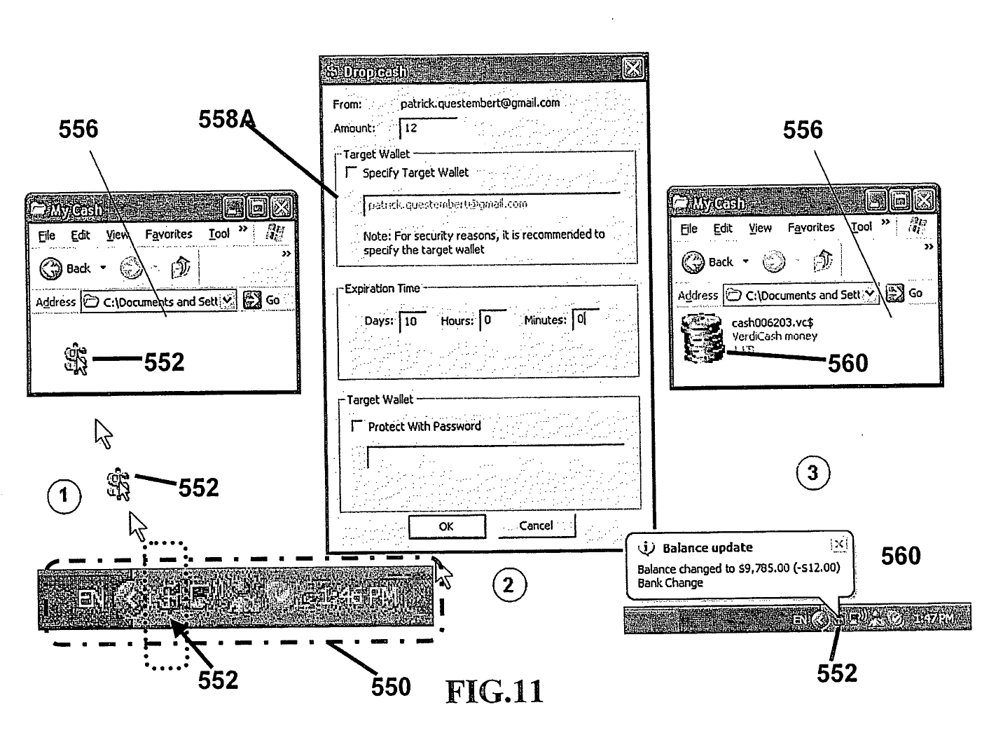

As illustrated in FIG. 11, in one particular example, a user engagement with a defined “digital cash notification icon,” and more specifically a dragging-and-dropping of the digital cash notification from the task bar to a region outside of the task bar (i.e. the “desktop” and/or one or more folders) is operative to activate a cash generation interface.

FIG. 11 shows the temporal evolution of an exemplary generation of a digital cash bundle. In particular, there are three steps described in FIG. 11 (steps 1, step 2, and step 3). First (step 1) the user engages a notification icon 552 of the digital cash management application which resides within the taskbar 550. The user drags this notification icon top a drop target (for example, a folder 556).

The dragging-and-dropping of the notification icon 552 to the drop target 556 is operative to activate a cash bundle generation interface 558, which provides a plurality of fields for receiving parameters for setting at least one digital cash attribute of the newly generated digital cash bundle. According to the example of FIG. 11, the fields of the digital cash bundle generation interface 558A include fields specifying an amount of digital cash (i.e. a face value), a target wallet, and a password to associate with the digital cash wallet. In the example of FIG. 11, the digital cash bundle is formed to have a value of $12 and to expire in 10 days. Upon providing appropriate parameters to the cash bundle generation interface 558A, the digital cash bundle is formed, in a location related to the drop target 556. Thus, according to the example of FIG. 11, where the digital cash bundle is implemented as a file, the generated digital cash bundle file 556 resides, by default, in the targeted folder.

According to the example of FIG. 11, the digital cash bundle is formed by withdrawing digital cash from a digital cash account managed directly or indirectly by the digital cash electronic wallet application. Thus, in the example of FIG. 11, the digital cash electronic wallet application presents accord balance information 560 to the user.

A Discussion of Dragging-and-Dropping on the Windows Platform

Under Microsoft Windows, several methods are possible to perform drag-and-drop. According to some embodiments of the invention, a method called “OLE drag-and-drop” is employed, as this method gives the application (i.e. the digital cash management application) the ability drag-and-drop complex data types. This is unlike, for example, “shell drag and drop”, which supports a very limited set of objects that can be dragged The “OLE drag-and-drop” method is described below.

An object can be dragged only from a window which is a “drag source”. In order for a window to be a drag source, the window may monitor Windows messages and look for a message called “WM_LBUTTONDOWN”. When this message is sent to the window, it means that the user has clicked on the window and the drag-and-drop can start. These are the steps that the digital cash management application has to perform:
1. Call the function “OleInitialize” which is implemented in the Windows Dynamic Link Library “OLE32.DLL”.
2. Implement two Component Object Module (COM) interfaces, implemented by the OLE infrastructure:
   a. IDropSource: by implementing the “GiveFeedback” and “QueryContinueDrag” methods, the electronic-wallet can control the behavior of the dragging: provide visual presentation of the drag and decide if and when it should end.
   b. IDataObject: by implementing the “GetData”, “QueryGetData” and “EnumFonnatEtc” methods, the digital cash management application can control the type and content of the data being dragged.
3. Call the Windows OLE API function “DoDragDrop”.
   Some other methods of these and other interfaces can be implemented to improve the drag-and-drop functionality.

While the object is being dragged, Windows or the user can decide at which point is will be dropped. This decision is determined by the “QueryContinueDrag” method of the above described IDropSource. If, at any point, this method decides that the dragging is over and drop should occur (for example, because the user has left the mouse button over a legitimate drop target, such as MSN Messenger), it should notify the object implementing “IDataObject”, for instance, by raising a flag. The next time that the “GetData” method of IDataObject will be called by Windows, the digital cash management application may, for example, show a dialog asking the user which amount to drop. Then, this method can decide if the drag is successful, and an object containing the requested data (digital cash bundle) is created in the drop target If the method decides to cancel the drag-and-drop, nothing is dropped on the drop target.

### Simulation of Dragging-and-Dropping on the Windows Platform of Notification Icons from the Taskbar

As discussed in the section entitled “Digital Cash Generation Engine 112 and Digital Cash Generation Interface,” in some embodiments, dragging-and-dropping of a notification icon from the taskbar to a drop target outside of the taskbar is operative to invoke functionality associated with the digital cash management application.

It is noted that Windows does not provide any mechanism for dragging-and-dropping notification icons from the taskbar. The present inventor is now disclosing a novel method for simulating a dragging-and-dropping of a notification icon from the taskbar to engage a software application registered with the Windows operating system. Although this method will be described in the context of the digital cash management application, it is appreciated that this presently disclosed techniques for dragging-and-dropping notification icons from the task bar is equally applicable to any Windows application, and is not limited to the digital cash-related software applications such as the digital cash management application.

In general, the presently disclosed method of simulating a drag-and-drop operation (as in FIG. 11) of a Microsoft Windows notification icon from the taskbar into a region outside of the taskbar includes the steps of:

a) detecting a user engagement with the notification icon in a manner indicative of initiating a drag-and-drop operation (for example, the user clicking on a notification icon 552 within the taskbar 550, and moving away from the location of the notification icon 552 with the mouse button remaining depressed);

b) upon the detecting, creating a temporary proxy window whose initial location is proximate to the notification icon 552 (i.e. the notification icon 552 at its initial location within the task bar);

c) transferring the focus to the created proxy window and establishing the created proxy window as the drag source, and

d) allowing the user to complete the drag-and-drop operation with the proxy window (i.e. allowing the user to release the mouse button when the proxy window reached the drop target).

It is noted that in some embodiments, an icon derived from the notification icon (for example, a copy of the notification icon) is embedded in the dragged proxy window (for example, an icon that is an identical copy of the notification icon 552) in order to further the impression that it is the notification icon that is being dragged.

In exemplary embodiments, the proxy window needs to receive events involving notification icon, and may thus use the Windows Shell API function “Shell_NotifyIcon”. It is noted that the Windows application (for example, the digital cash management application) can receive messages equivalent to “The mouse cursor is now hovering on the notification icon” and “The user has just clicked with the mouse on the notification icon”. When the Windows application (for example, the digital cash management application) receives this last message, the Windows application can simulate a drag-and-drop operation in the following way:
1. Create a transparent “proxy” window with a given size (for example, a minimal size, for example, 1×1), at the position of the mouse cursor. This proxy window will be used as a drag source, as will be described later, for example, by using the Windows API functions like “CreateWindow”, “MoveWindow” and “GetCursorPos”. It may also be the top window. This may be done by using Windows API functions like “SetActiveWindow”, “SetForegroundWindow”, “BringWindowToTop” and “ShowWindow”.
2. Simulate the sequence of events that would have occurred had a normal drag-and-drop operation been performed by inserting into the Windows message queue a mouse event which states that the user is not clicking the mouse anymore, followed by another mouse events which states that the user has clicked the left mouse button again. This can be done for example, by using the Windows API function “mouse_event” or “SendInput”, which are implemented in the WIN32 API in the Dynamic Link Library USER32.DLL.
   Since the newly created transparent window is the topmost window and is a drag source, it receives the mouse click messages (WM_LBUTTONDOWN) and by calling the Windows API function “DoDragDrop”, the simulated drag-and-drop is started and behaves as described previously for the drag-and-drop implementation of the electronic wallet under Windows.

### Drop Targets Associated with Separated with Desktops Applications

In the above examples, windows associated with folders of the file system were designated as drop targets, and the digital cash management application was configured so that the newly formed digital cash bundle file resided in the folder. In some embodiment, the “folder” is associated with a removable media, and thus, when formed, the digital cash bundle is saved to removable media.

Alternatively or additionally, the user may designate a window or area of the screen associated with a separate desktop application (for example, a frame of this application). When the digital cash bundle is generated, this bundle is then associated with the separate desktop application (i.e. an application that is not the digital cash management application).

### Microsoft MSN Messenger

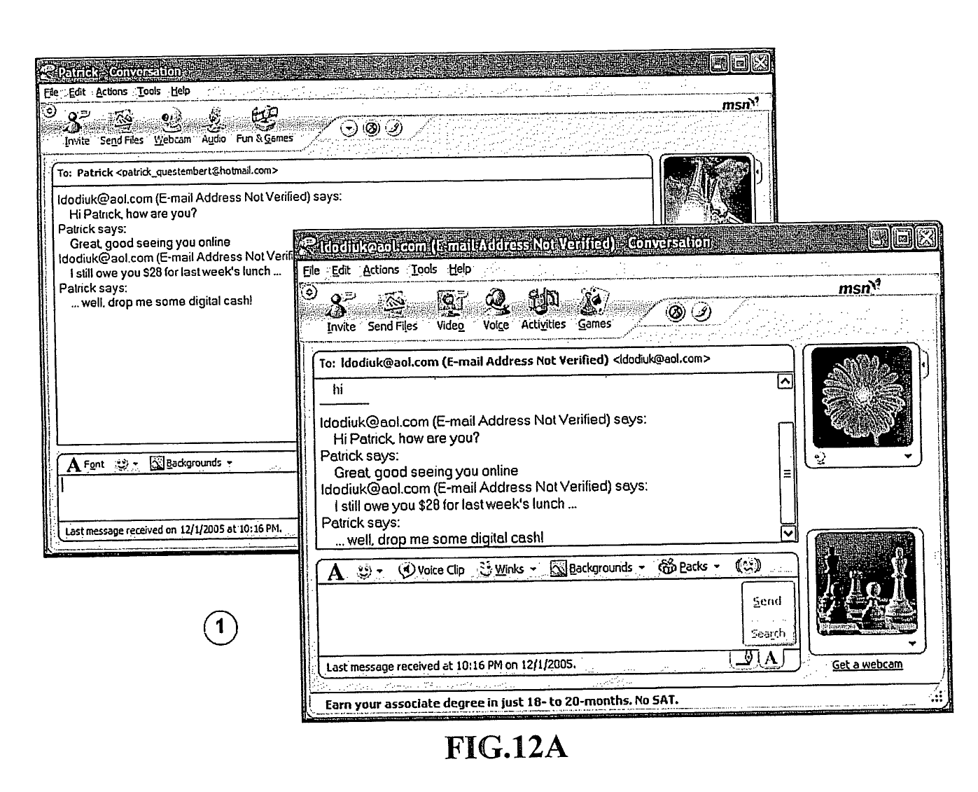

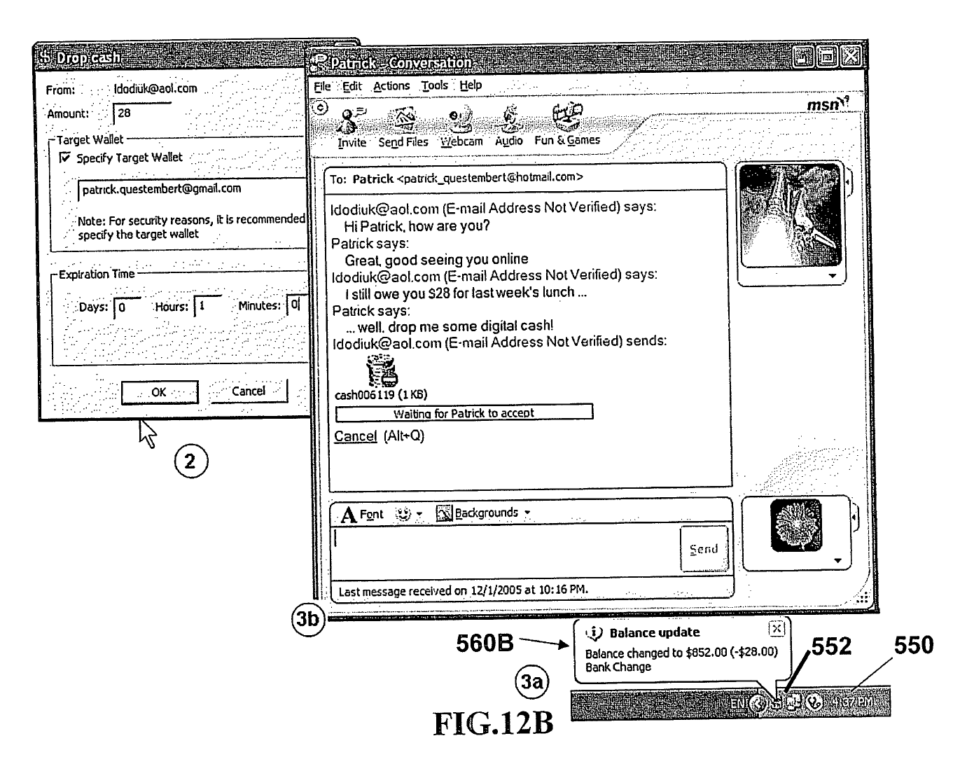

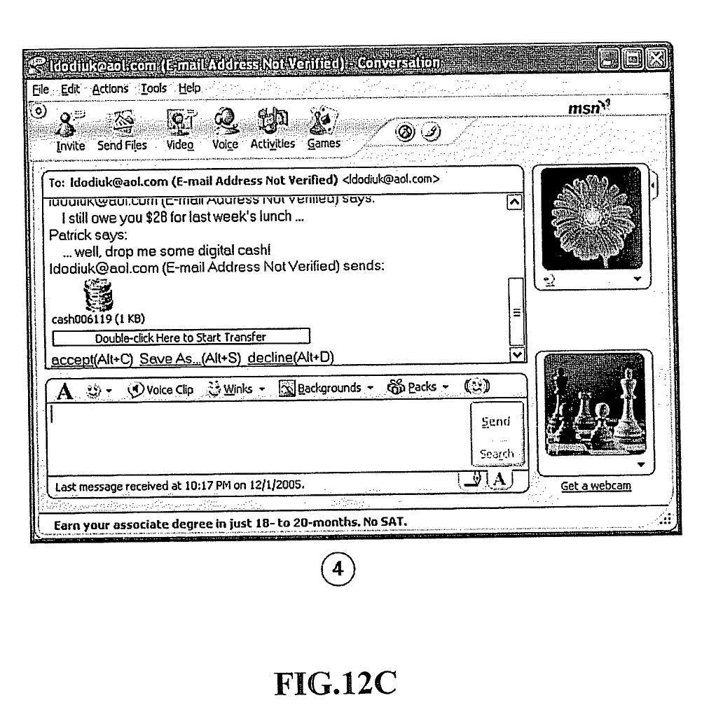

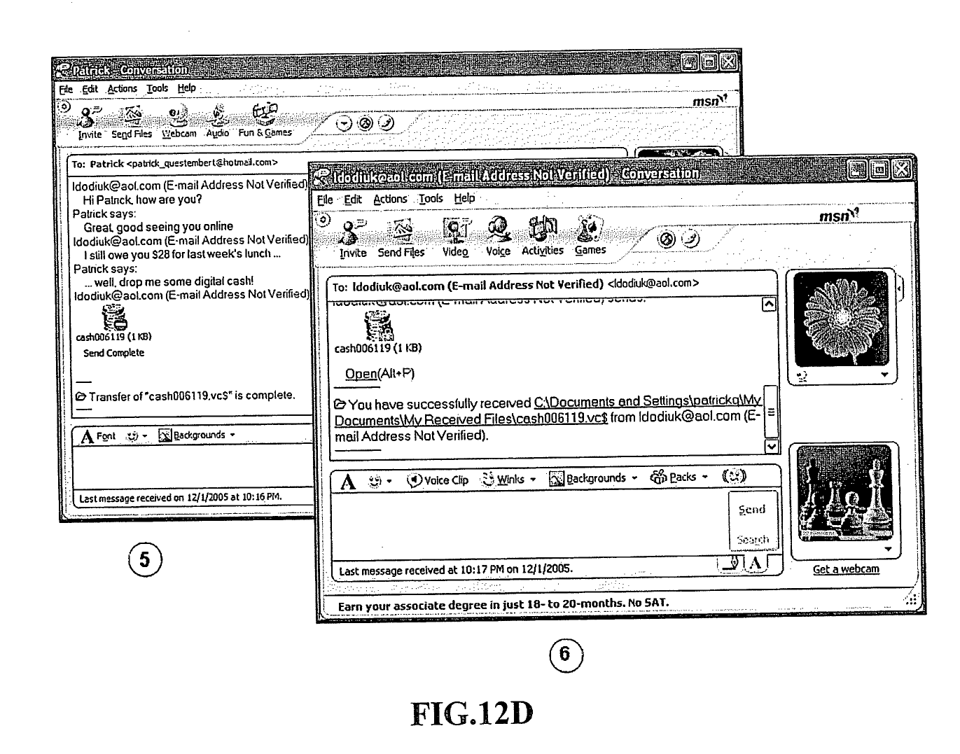

Microsoft MSN Messenger is one of several applications that support sending and receiving files. MSN Messenger can also act as a “drop target” for a drag-and-drop operation where the digital cash management application is the “drop source”. An embodiment of a digital cash management application implementing the drag and drop mechanism as described in the present invention would therefore allow two users to send or receive a digital cash bundle within a MSN conversation. FIGS. 12A-12D illustrate an exemplary scenario wherein two users conversing through MSN Messenger may send digital cash to one another.
Step 1 (FIG. 12A): Patrick (patrick.questembert@gmail.com) and Lani (Idodiuk@aol.com) start a conversation through MSN Messenger
Step 2 (FIG. 12B): Lani (the Sender) wishes to send Patrick $28, so she drags her electronic wallet icon onto the area of the MSN Messenger conversation where one enters text messages. The electronic wallet displays a dialog to prompt her for the details of the cash bundle.
Step 2a (FIG. 12B): The electronic wallet debits Lani by $28
Step 3b: (FIG. 12B) The digital cash management application creates a new digital cash bundle into the MSN Messenger application, which proceeds to send it to Patrick
Step 4 (FIG. 12C): MSN Messenger on Patrick's system notifies him of the income cash bundle
Step 5 (FIG. 12D): MSN notifies Lani that Patrick has accepted the cash bundle.
Step 6 (FIG. 12D): Patrick has accepted the cash bundle. Note that in this case, Patrick chooses to save the digital cash bundle to a local folder instead of opening (redeeming) it, so his electronic wallet is not credited for the amount at this time.
   Note how the digital cash bundle has a different appearance to the sender (Lani, Step 5) and the receiver (Patrick, Step 6): the sender decided to create the bundle assigned to the electronic wallet of the receiver, so the bundle shows with a “no-entry” sign indicating that the sender would not be able to redeem it. On the other hand, the receiver sees that bundle with a small lock sign, indicating the bundle has been assigned specifically to him.

It is noted that because the application (i.e. MSN) has no intrinsic digital cash functionality and/or because the application (i.e. MSN) is distinct from the digital cash management interface, this application (i.e. MSN) may be referred to as a “separate desktop application.”

### Generating Customized Digital Cash in Accordance with an Identifier under a Software Application Distinct from the Digital Cash Generator/Digital Cash Management Application

According to some variations of the above-described example, the digital cash management application may determine the email address of the counterpart in the MSN conversation that is the drop target. The digital cash management application could then use the email address of that target MSN user as a suggested target wallet, or as a default target wallet, in the cash generation interface (e.g. dialog 558) where the user is prompted for the value and other attributes of the digital cash bundle.

It is noted that in the MSN application, the email application provides identifiers of users under this software application. Thus, in general, in accordance with some embodiments of the present invention, the generated digital cash (i.e. cash generated by the digital cash management application) may be customized (in this example, customized with a target wallet identifier derived from the email address identifier of MSN messenger) in accordance with the identifier (in this example, the email address) of the user under the distinct software application (in this example, MSN messenger).

In another example, when the user drops a digital cash bundle and/or notification icon for generating a digital cash bundle into a Microsoft Outlook message window, if a recipient is already present in the “To:” field of the message, such as when replying to a mail message, the electronic wallet can automatically suggest that email address as the target wallet for the dropped digital cash bundle.

This may be done in accordance with a “data extractor” (not shown in the figures) which may recover data (i.e. data associated with an identity of a target or payee of the digital cash bundle, such as an email address) residing within, or provided by the software application distinct from the digital cash generator. The data extractor may make this extracted data (for example, identity data) available to the digital cash generator (for example, engine 112). Thus extracted data (for example, the email address) may be used in a number of ways, for example, for suggesting a target wallet as described in the previous paragraph.

SkyPE

The SkyPE IP telephony application (www.skype.com) is another example of an application that supports sending and receiving files. SkyPE may also act as a “drop target” for a drag-and-drop operation where the digital cash management application (i.e. an icon 552 representing the digital cash management application) is the “drop source”. An embodiment of a digital cash management application implementing the drag and drop mechanism may therefore allow two users to send or receive digital cash bundle within a SkyPE conversation.

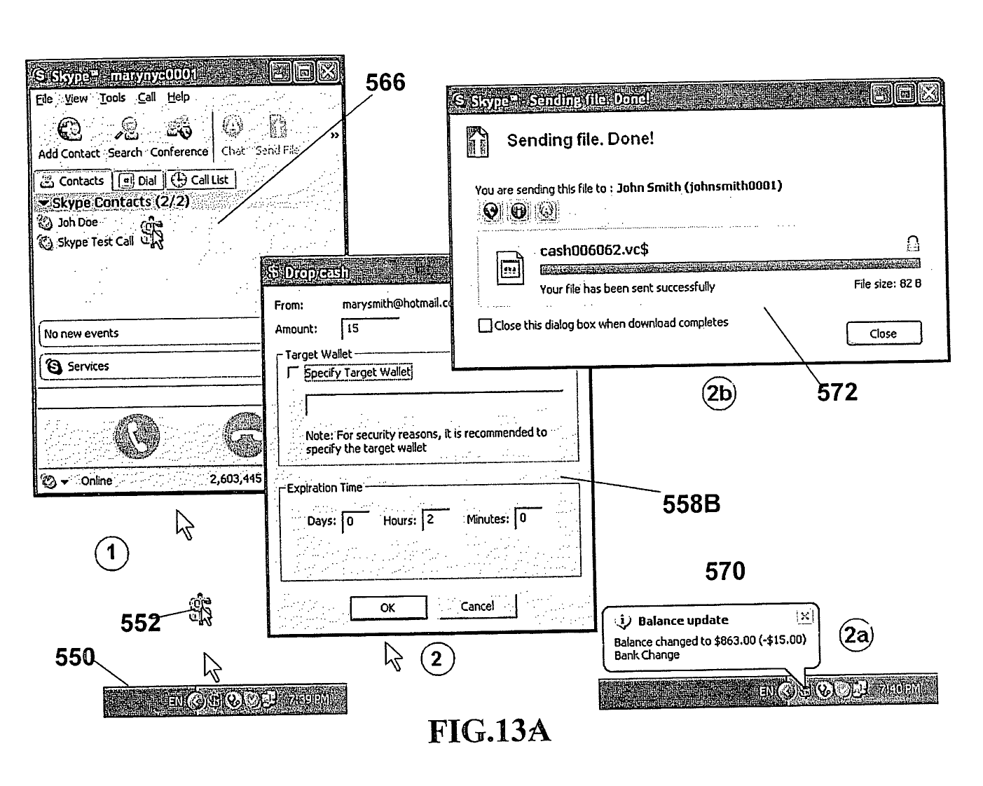

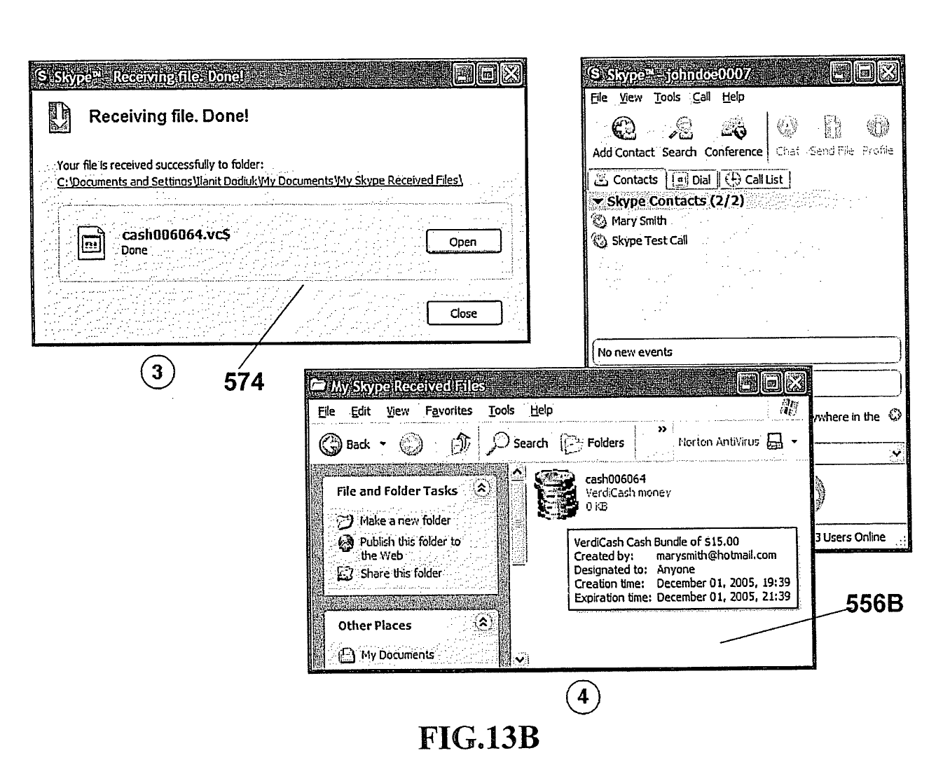

FIGS. 13A-13B illustrate an example where Mary sends John a digital cash bundle using SkyPE:
Step 1 (FIG. 13A): Mary drags and drop an icon 550 representing the digital cash management onto a frame 566 associated with the SkyPE application. In particular, the icon 550 is dropped in proximity of an area within the frame 566 associated with a contact called John that is online at that time;
Step 2 (FIG. 13A): In response to the drag-and-drop operation, an interface (i.e. a dialogue) 558 for generating digital cash is activated. Mary enters the details of the digital cash bundle payment she wishes to create, in this case a value of $15, expiring in 2 hours.
Step 2a (FIG. 13A): When she provides the information and confirms, a new digital cash bundle is created, Mary's electronic wallet is debited by $15, as indicated in the text message near the task bar;
Step 2b (FIG. 13A): The digital cash bundle is handed over to the SkyPE application, which sends the file to John as indicated in Skype panel 572.
Step 3 (FIG. 13B): The receiving user John is notified by SkyPE of the incoming digital cash bundle and he accepts the file, as indicated in Skype panel 574.
Step 4: In this case, John chooses to save the digital cash bundle to a local folder 556 instead of opening (redeeming) it, so his electronic wallet account is not credited for the amount at this time.

At this time, the SkyPE application does not publish the email addresses of SkyPE users. However, an embodiment is contemplated wherein the digital cash management application tracks the association made by the user between the target users of SkyPE, or another application involving other users, to which the local user has sent digital cash bundles in the past, and remembers to which target wallet name the user has assigned digital cash bundles thus created. For example, if the local user has sent digital cash to a SkyPE user called “Mary New-York” in the past and assigned the digital cash bundle sent at that occasion to “mdorfbach@msn.com”, the next time the local user drops cash to the “Mary New-York”, the digital cashi management application can suggest “mdorfbach@msn.com” as the target wallet.

Thus in some embodiments, the digital cash generation engine 112 is operative to customize generated digital cash using a digital cash account identifier provided by the user in a previous request for generating digital cash.

It is noted that the technique described above is applicable to any application used as a drop target for digital cash bundles where another user is associated with the drop target window, but for which one or more parameters for generating digital cash (for example, an email address) is not known. One non-limiting example of such application is an instant messaging application that identifies users by a friendly name and not by their email address.

### Emailing Digital Cash

Microsoft MSN Messenger and SkyPE are both applications that require a live online connection between two users. For other situations, when a user wishes to send digital cash to another user that is not necessary online, the user may choose to use electronic mail.

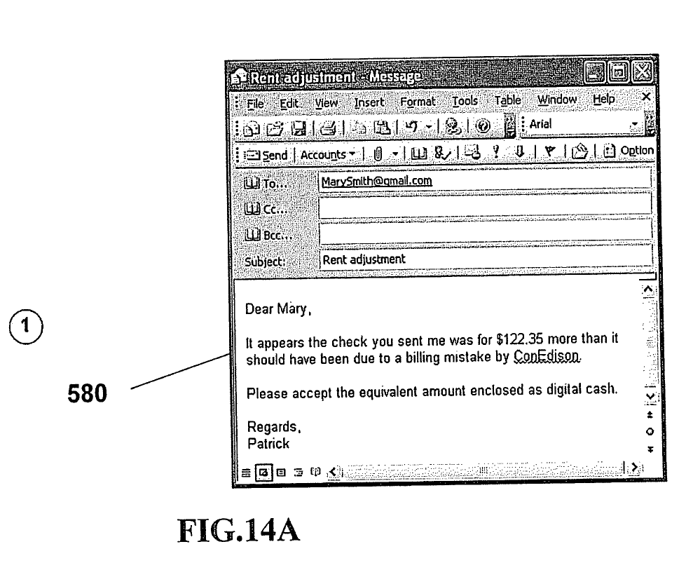

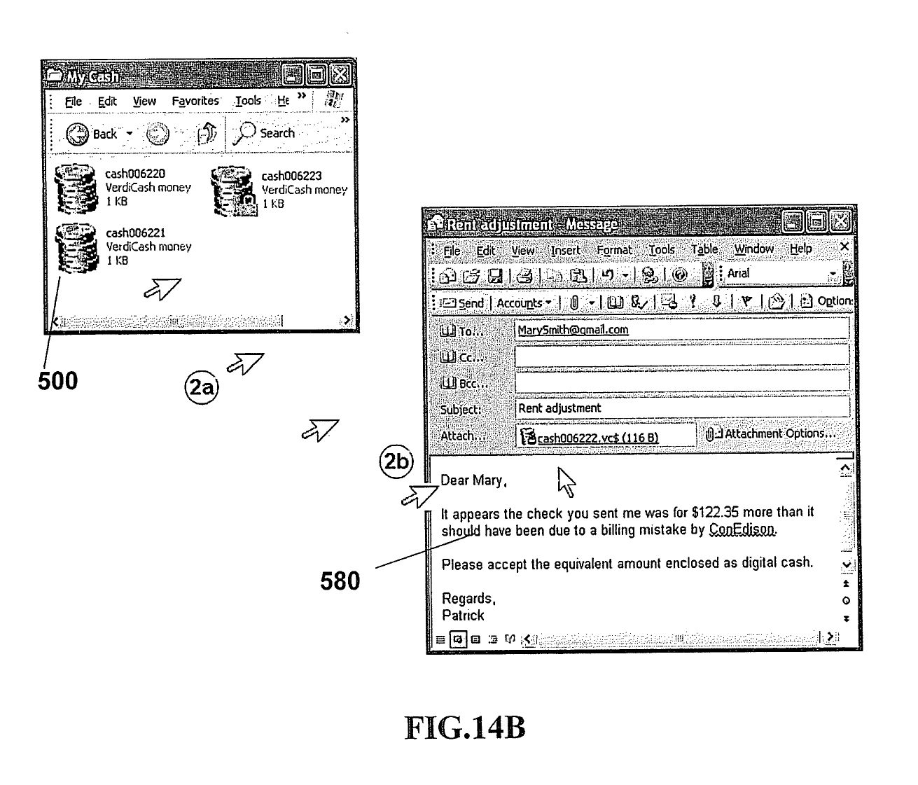

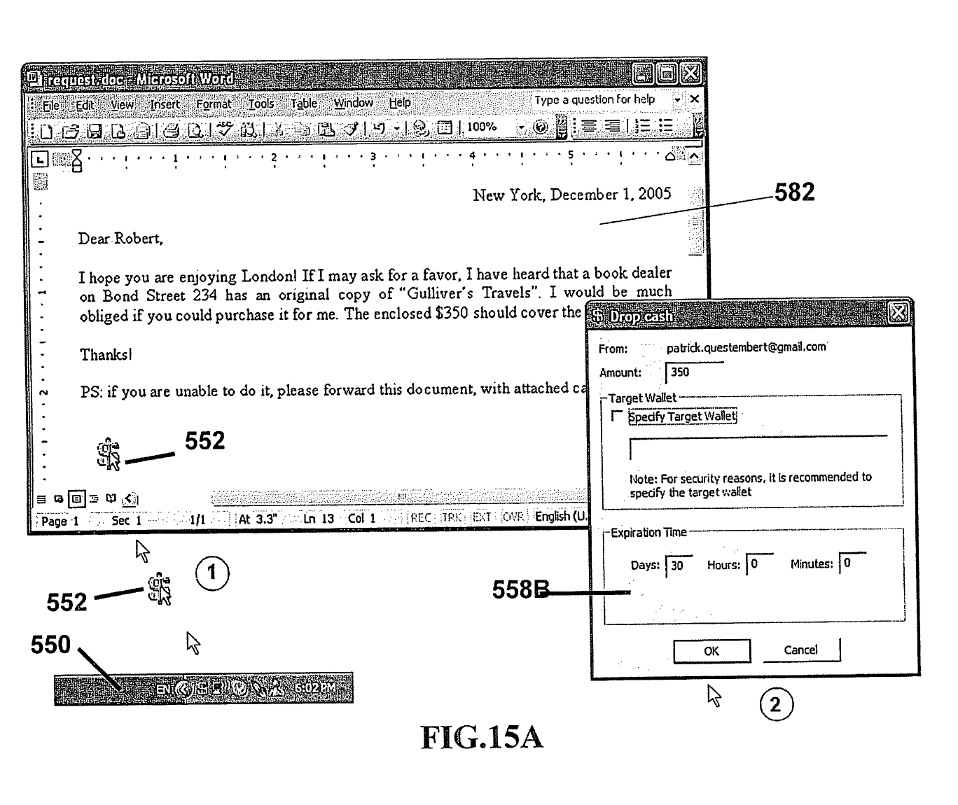

According to some embodiments, digital cash files may be sent by attaching a digital cash bundle to an email as illustrated in FIGS. 14A-14B, just as one would attach any other type of files. In certain situations, it is useful to send digital cash in this way, and the email may serve, in some examples, as a context for the payment, reminding the recipient why he is being offered cash.

Although the recipient may, in certain examples, redeem the received digital cash bundle file into a digital cash account, there are many situations where the recipient may choose not to do so. In one example, the recipient may forward the email with the embedded digital cash payment or bundle to another recipient without first redeeming the payment or bundle.

Exemplary email applications operative to provide a “drop target” for digital cash bundles (newly generated bundles and/or existing bundles) and to send and/or receive digital cash bundle files include but are not limited to Microsoft Outlook and Outlook Express. FIGS. 14A-14B illustrates an example wherein a drag and drop mechanism facilitates that attaching of digital cash bundles to a mail message in a single drag-and-drop operation.

In particular, FIGS. 14A-14B describe a use scenario related to attaching a digital cash bundle file to an email message:
Step 1 (FIG. 14A): The user composes an email message addressed to the intended recipient for the payment
Step 2a (FIG. 14B): The digital cash bundle 500 is dragged from the source file folder
Step 2b: The digital cash bundle is dropped into a region 580 associated with the target application (i.e. Microsoft Outlook), which is operative to transmit the digital cash bundle to the application (i.e. Microsoft Outlook), which attaches the digital cash bundle file to the mail message.

Note that, unlike the examples depicted in FIGS. 13A-B and 12A-D, in FIG. 14A pre-existing digital cash bundles are dragged and dropped into the region associated with the application (i.e. the region of the outlook mail message)

In some embodiments, the pre-existing digital cash bundle may be modified upon dropping into the application, for example, in accordance with data received by the digital cash management application from the target application. In one example, when the digital cash bundle is dropped into the region 580 associated with Microsoft Outlook, the digital cash management application receives an identifier associated with the target application (for example, Microsoft Outlook), and the digital cash bundle may be modified, for example, by configuring a digital cash attribute in accordance with data received from the target application. Thus, in one example, the digital cash management application receives one or more user identifiers (for example, e-mail addresses) from the application (for example Microsoft Outlook) and may either automatically modify the digital cash bundle in accordance with the received identifiers, or may activate an cash modification interface to allow a user to modify the bundle where the received identifiers are suggestions or default values.

The above discussion pertains to situations wherein the email application is an installed application which resides on the client and is registered with the Host operating system. Alternatively, digital cash bundles may be sent using an email application that does not support the drag and drop interfaces. For example, web-based email programs, such as Google's Gmail or Yahoo's mail, often do not act as drop targets. For situations where digital cash bundles are implemented as files, the digital cash bundle files may simply be attached to email messages handled by the web-based email program.

Embedding Digital Cash Bundles into Files of other Applications

The inclusion of digital cash bundles into software applications need not be limited to communication applications such as instant messaging, IP telephony and email. A variety of additional software applications also support the inclusion of files, which permits including digital cash into them Office applications such as word processing and presentation software are important examples. For example, both Microsoft Word and Microsoft Powerpoint support the inclusion of files into documents. This can be done by explicitly specifying an existing digital cash bundle to be included, or in one single step, as for Microsoft Outlook, by dragging the icon of the digital cash management application onto a Word or Powerpoint document, which creates a digital cash bundle and attaches it to the target document in one step.

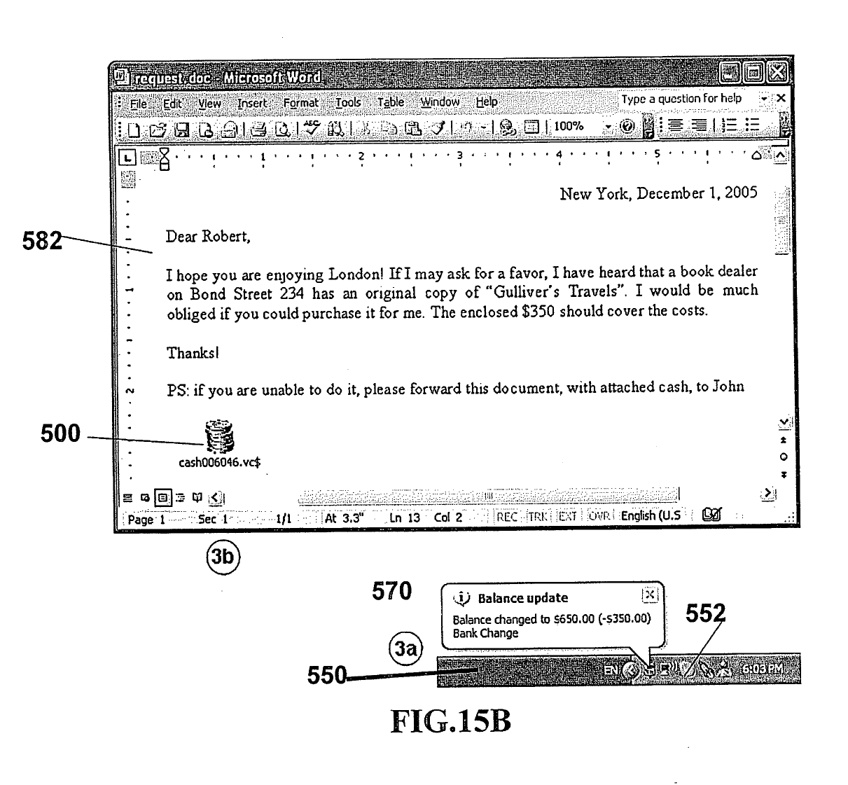

FIGS. 15A-15B illustrate a user scenario where a digital cash bundle is included or embedded within a Microsoft Word document:
Step 1 (FIG. 15A): A user drags and drops his electronic wallet into an open Word document 582
Step 2 (FIG. 15A): The dropping of an icon 552 associated with the digital cash management application (for example, a digital cash electronic wallet application) activates an interface (i.e. dialogue 558) for specifying attributes of the cash bundle to create. According to the exemplary scenario, the user specifies a value of $350 and expiry in 30 days
Step 3a (FIG. 15B): A new digital cash bundle is created in accordance with the specified parameters and a digital cash account directly or indirectly accessed by the digital cash management application is debited by the $350 value chosen for the digital cash bundle.
Step 3b (FIG. 15B): The newly created digital cash bundle 500 is transmitted to Microsoft Word and embedded into the document 582.
   Configuring other Applications to Display Cash Bundle Attributes

The principle of utilizing the Host operating system resources to allow visualization of digital cash bundles may also be extended to applications running under the Host operating system, when such applications manipulate digital cash bundles, or objects that are associated with digital cash bundles. An example application is Microsoft Outlook, which displays email messages that may contain digital cash bundles sent as attachments. Additional examples include other mail applications and utilities to manage desktop files.

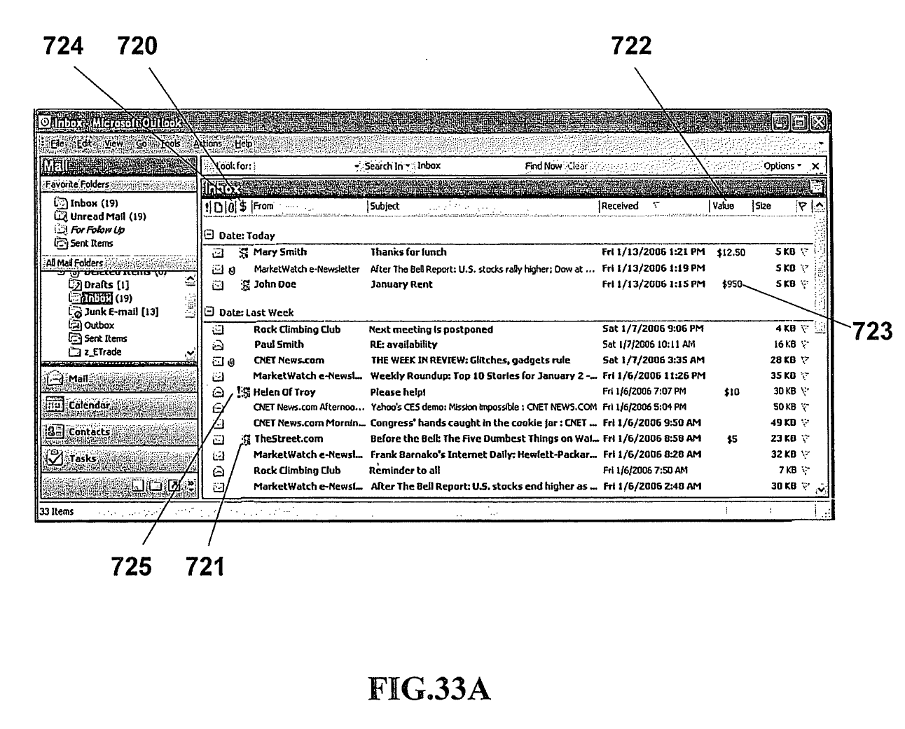

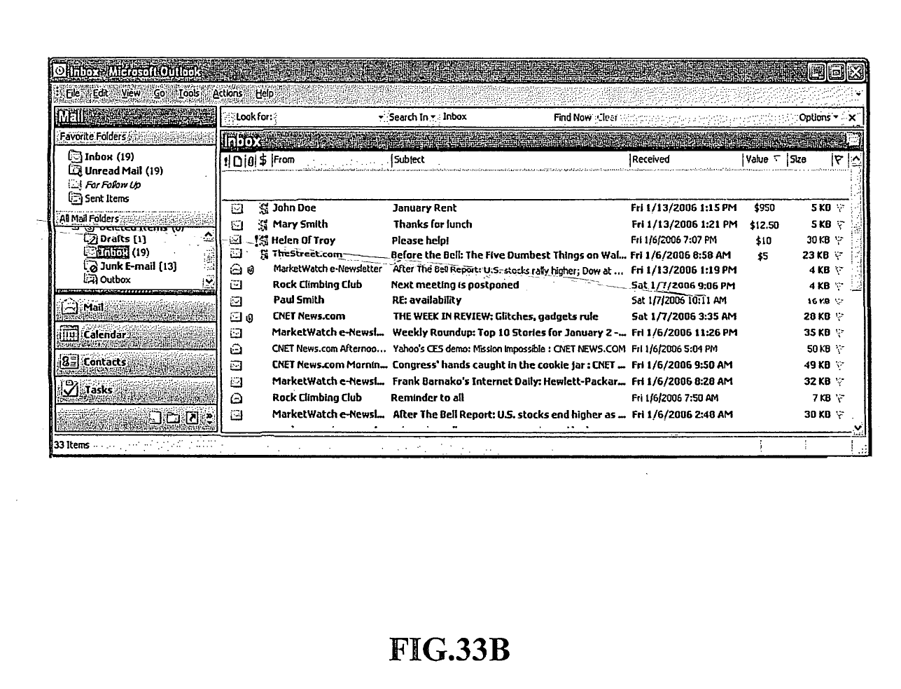

In the case of Microsoft Outlook, configuring Outlook to display digital cash bundles embedded in email messages may be done by implementing a Microsoft Outlook “plug-in”. A plug-in module registered with Outlook is invoked for each message and may perform manipulation on the message or display additional information about them. FIGS. 33A-33B illustrate an embodiment of the invention where the digital cash management application is implementing a cash management plug-in to Outlook:
Column 724 (FIG. 33A) in the Outlook message folder view is a standard column type displayed by Outlook, in this case to indicate the presence of attachments in mail messages
Column 720 (FIG. 33A) is a new column type, introduced by the cash management plug-in to indicate the presence of digital cash in mail messages. Messages containing embedded digital cash are shown with a small green dollar icon (such as icon 721)
Icon 725 (FIG. 33A), an exclamation mark associated with the green dollar icon, further augments the information provided by the user about the presence of digital cash in email messages, by indicating that the digital cash embedded in the message requires immediate attention, for example because the embedded digital cash is about to expire
Column 722 (FIG. 33A) is a new column type, introduced by the cash management plug-in to indicate the total value of digital cash in each mail message. Messages containing embedded digital cash are shown with a dollar amount in that column (such as amount 723)

The additional information displayed by the cash management plug-in may enable the user to treat messages containing digital cash with special care, such as not deleting them before redeeming the embedded digital cash. In addition, FIG. 33B illustrates how the user may also use the attributes exposed by the plug-in to sort mail messages, for example displaying messages by decreasing order of the value of the digital cash embedded in them. Note that an Outlook digital cash plug-in operation need not be limited to affecting the display of messages with digital cash, and may also process embedded digital cash silently, such as automatically redeeming digital cash in all or some of the incoming mail messages.

### Transmitting a Textual Representation of a Digital Cash Bundle to a Desktop Application

Some applications are not designed to support file attachments as described above that would allow including digital cash bundles. Instead, these applications limit their support for inclusion of external data to text only. For example, some instant messaging applications do not support sending and receiving text, but rather only text. It is possible to circumvent these limitations by transmitting a textual representation of the digital cash bundle to the application.

It is stressed that although the techniques described for transmitting a textual representation of a digital cash bundle to an desktop applications are useful for applications that do not support file attachments, as noted above, this is not intended as a limitation.

There are a number of textual representations of digital cash bundles that may be used, for example any field or combination of fields in the exemplary XML file.

In one example, the textual representation of the digital cash bundle is or includes a “redeeming sequence of characters or bits.” In particular, a discussion of some possible exemplary properties that may be associated with digital cash is provided. According to these exemplary properties, an instance, or unit, of digital cash has value because it has been manufactured by an entity which all parties trust to honor its promise to pay the bearer of this instance of digital cash the stated monetary value. This assurance does not need to depend on the manner in which digital cash is presented and/or manipulated and/or exchanged.

Thus, according some examples, it is not necessary for a user to present an entire digital cash bundle to this trusted entity (or a representative thereof such as a server), and it suffices to present only the numeric sequence identifying this instance of digital cash and presenting that print out at that institution in order to redeem the digital cash payment or bundle into a digital cash account or to convert the digital cash to real cash (e.g. hard currency).

According to many examples, this sequence becomes valid digital cash as the result of many protocols and systems known to the skilled artisan, the end result of which allows the implementations of systems permitting entities to exchange money in a secure manner, with provisions for addressing numerous issues such as double-spending, anonymity, or non-repudiation. The algorithms invented to address these issues depend on cryptographic protocols may be supported by modem computers and security devices. As long as the digital cash bundle or payment is properly formed and encrypted with the correct cryptographic keys, the following exemplary hypothetical sequence of bits could well represent a promise by a given financial institution (in one hypothetical example, the “Bank Of Metropolis”) to pay the bearer of this sequence the amount of $15:
M*7jHnn%4$L:Fakj˜″9)jjbzdwuihpˆ55kjkdfjo-098uyxflfhrui((8&O
The above is a text-based representation of a sequence approximately 420 bits long. It should be noted that the apparent obscure nature of the above sequence in no way implies that only the issuing institution (the Bank of Metropolis in this case) can decipher it, on the contrary. Depending on the details of the digital cash implementation, it is, in many examples, the reverse: only the Bank of Metropolis could have manufactured that sequence but every computing device can decipher it and display its details to the user. Furthermore, it is not suggested that the textual representation of digital cash necessarily follows the above format—an alternative could be, for example, a more flexible text format such as EXtensible Markup Language (XML). Any textual representation is within the scope of the techniques described herein.

Thus, in many embodiments, it is contemplated that the textual representation of a given digital cash payment or bundle includes a sequence of bits or characters which attests to the validity of a given digital cash payment or bundle, or which is operative to redeem the bundle into a digital cash account or convert the digital cash bundle to real cash.

In some embodiments, certain user manipulations of a graphical icon representing a digital cash bundle (for example, a dragging and dropping) are operative to produce a textual representation of the digital cash bundle. In particular, in some examples, a user designation of a desktop application (for example, a desktop application distinct from the digital cash management application) as a drag-and-drop target of a graphical icon is operative to transmit a textual representation of the digital cash bundle to the designated desktop application. In some embodiments, this transmitting is carried out in accordance with a detection that the designated desktop application accepts drag-and-drop input text. In particular embodiments, this transmitting is carried out upon detecting that the application supports only text-based exchange of data (as opposed to files).

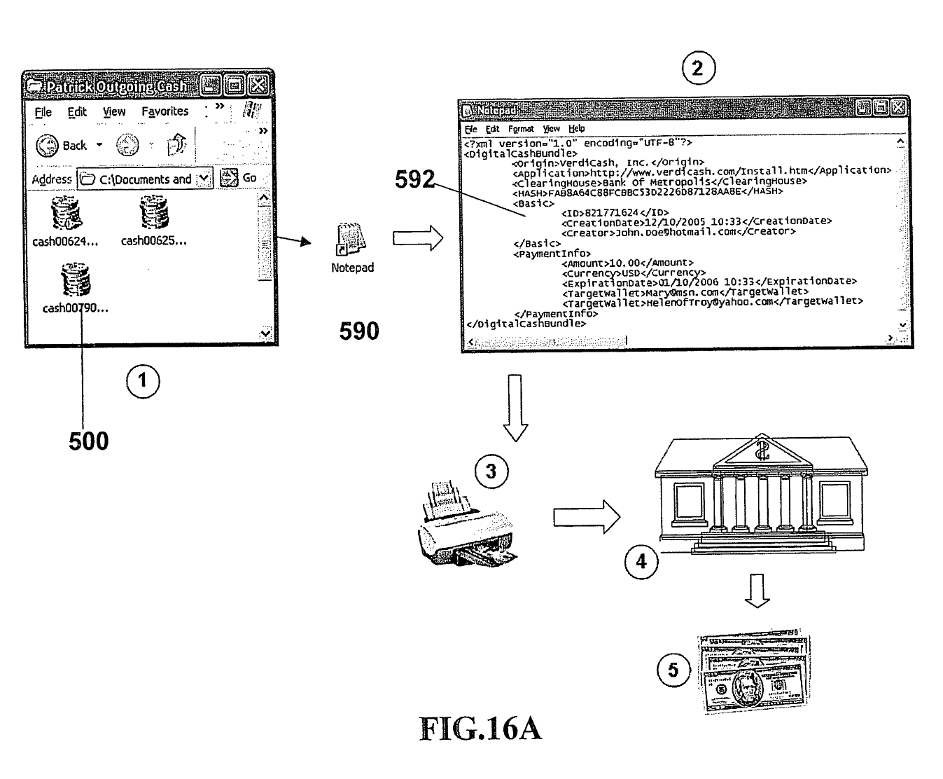

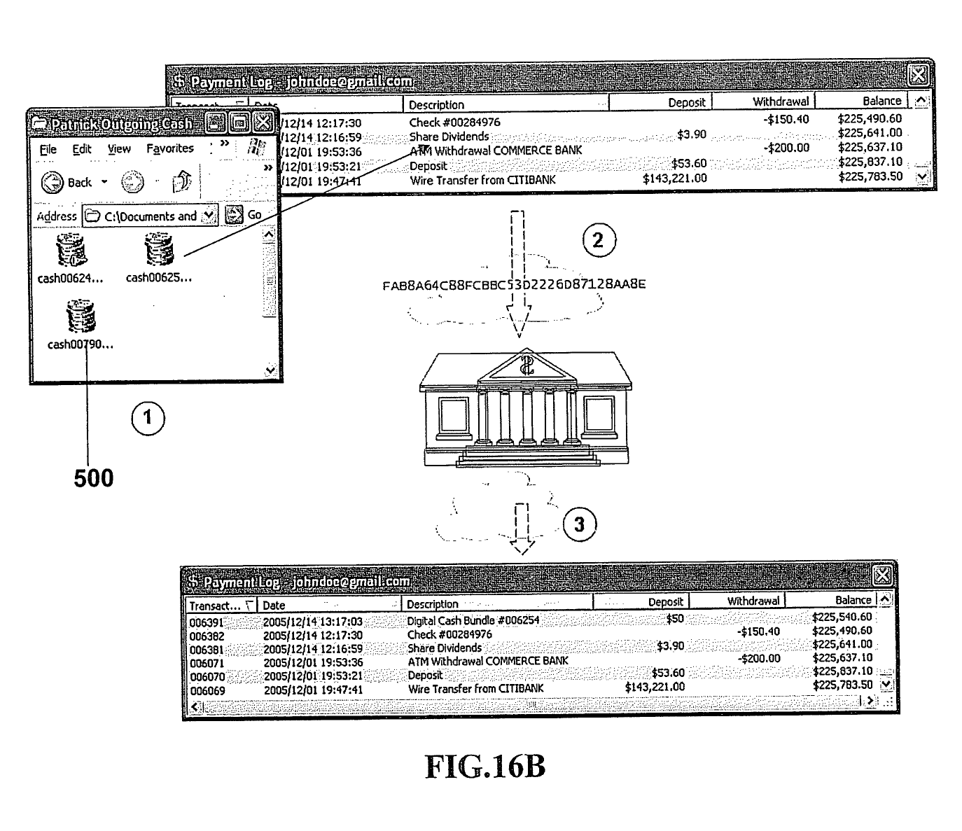

FIG. 16A shows a use scenario involving dragging-and-dropping a digital cash bundle 500 onto a desktop application which accepts drag-and-drop input as text (i.e. the desktop text editor called Notepad):
Step 1: the user drags and drops a digital cash bundle 500 onto the desktop icon for Notepad
Step 2: The Notepad application is activated, the digital cash management application recognizes that Notepad can only accept drag and drop content in text format. The digital cash management application creates a text-based representation of the digital cash bundle 592, using XML in this example
Step 3: the user chooses to print the details of the digital cash bundle
Step 4 & 5: the user brings the printout to the bank which redeems the digital cash bundle based on the printout into hard cash

Note although the textual representation 592 is displayed to the user in the example of FIG. 16A, this is not a limitation, and the manner in which the receiving application chooses to process the text-based representation of the digital cash bundle does not need to involve displaying that text representation to the user.

FIG. 16B describes a user scenario involving dragging-and-dropping a digital cash bundle onto a banking application, where a textual representation of the digital cash bundle is transmitted to the banking application but is not displayed to a user:
Step 1: the user drags and drops a digital cash bundle onto a desktop banking application. The digital cash management application transmits a text-based representation of the digital cash bundle to the banking application
Step 2: the banking application extracts the digital cash sequence from the textual representation it has received, and sends it over the Internet to the bank
Step 3: the user is credited for the value of the digital cash bundle

In some embodiments associated with Microsoft Windows, implementing the user scenario of FIG. 16B entails adding a “DataHandler” shell extension handler. This handler allows extending the available clipboard formats of a specific file type. For example, if the clipboard format of the digital cash bundle file type is extended to text format, the digital cash bundle file may be dragged-and-dropped into a window that accepts only text format. The window will receive the bundle file contents in its text format.

A “DataHandler” may be added by implementing several Component Object Module-interfaces, exposed by Windows in the Dynamic Link Library “SHELL32.dll”:
IPersistFile: Described previously by the IconHandler shell extension.
IDataObject: by implementing the “GetData” and “EnumFormatEtc” methods, the digital cash management application can return the formats it supports, and the relevant data, according to the contents of the digital cash bundle.

According to this exemplary implementation, to instruct the Windows Shell to use the above implementations, the digital cash management application should export a Global Unique Identifier (GUID) identifying the digital cash management application implementation of these interfaces and add a reference to it under the ProgID key in the registry, in a sub-key called “ShellEx\DataHandler”.

It is noted that in the example of FIG. 16A, the text representation of the digital cash bundle that is transmitted to the desktop application is explicitly displayed (for example, within a window of the desktop application). Nevertheless, this is not a limitation, and according to the example of FIG. 16B, the text that is transmitted is not displayed (i.e. the text is “silently” submitted to the desktop application).

Another non-limiting example of a Windows application supporting text-only external data is the Google Talk application, which at the time of this writing does not support exchanging files. By allowing such an application to receive a textual representation of a digital cash bundle, a user may send another user the textual representation of a digital cash bundlejust like any other message, and the receiving user may then manually or automatically reconstruct a digital cash bundle containing that sequence, thus effecting the transfer of digital cash. Another non-limiting example is the Windows Notepad application, into which a digital cash management application implementation following the present invention could allow dropping one of more sequences representing digital cash.

At this juncture, a description of other techniques for integrating digital cash bundles into a computational environment residing on the host computing device is provided.

Superseding Standard File Operations

Host computing devices with a graphical user interfaces typically present a set of functions applicable to files through pop-up or drop-down menus that is activated when the user selects a specific file. Such functions may include opening, renaming or deleting the specified file. In addition, applications associated with specific file types may specify that they should be invoked for some or all of these functions, in lieu of the standard mechanism provided by the Host to implement such functions. Such a mechanism is known in the art as “superseding the Host implementation of these functions” by alternate implementations. In accordance with some embodiments of the present invention, it is suggested to expose some of the functionality of the digital cash management application by having the digital cash management application supersede some of these functions for digital cash bundles. For example, the digital cash digital cash management application may redefine and replace the “delete” function for cash bundles, by checking whether the digital cash bundle contains valid digital cash, and if so, ask the user if she wishes to redeem (be credited) the digital cash bundle before deleting it.

Superseding the “Open” File Command

One of the operations available on files—and digital cash bundles for embodiments where these bundles are implemented as files—is opening a file. In one exemplary embodiment of the present invention, redeeming, or cashing-in, a digital cash bundle for the purpose of crediting a digital cash account by the value of the digital cash bundle may be performed when the user opens that digital cash bundle file. Thus, in accordance with some embodiments, it is recommended that the digital cash management application supersede the Host “file open” function. Thus when the user opens such a digital cash bundle, the digital cash management application may then perform the appropriate action, such as crediting the user's digital cash account by the cash bundle value. In addition, because the digital cash bundle may be rendered invalid once the user has been credited for its value, the digital cash wallet application may optionally automatically delete the opened or redeemed digital cash bundle.

It is noted that because of its importance, opening a file—or a cash bundle—is usually available to the user in additional ways besides the file action menu. Under Microsoft Windows, opening a digital cash bundle—or any file for that matter—may be done in several ways: right-clicking on the icon and selecting “open” in the menu of actions, as we described above, but also double-clicking the icon representing a digital cash bundle, or clicking then pressing the enter key. All such manners of opening a digital cash bundle would invoice the open method provided by the digital cash wallet application, and are within the scope of embodiments of the present invention.

Under Microsoft Windows, replacing (superseding) one of the standard file operations with an alternate implementation for a specific file type may be implemented by adding a sub-key to the ProgID key representing the file type, in the following form:

Shell\[Action Name]\Command, where the default value states the command to execute when this operation is chosen.

For example, to add a handler for the “Open” command for digital cash bundles, the key named HKEY_CLASSES_ROOT\ProgID\Shell\Open\Command” should have the default value set to the full path of the digital cash management application program, for example
“C:\Program Files\VerdiCash\Wallet.exe” %1
(“%1” will be set by Windows to the name of the digital cash bundle being opened)

It is noted that these embodiments of the present invention do not dictate what operation(s) should be performed when the user opens a digital cash bundle. Specific implementations may elect to provide additional functionality through the open operation. In particular, opening a cash bundle may allow the user to edit properties of the digital cash bundle (i.e. to “modify” the digital cash bundle, for example, by employing an engine 114 associated with digital cash modification), to effectively transform the digital cash bundle.

In one use scenario, a user may have received an advanced payment for a service to be rendered, and a digital cash bundle specifically assigned to her digital cash identification (i.e. an identification associated with a given digital cash account). If the user finds herself unable to perform this service to be rendered, she may elect to edit the cash bundle to assign it to the digital cash wallet of another user, who can render that service. This user who is unable to render the server may then forward this “service request” together with the modified digital cash bundle.

Operating on Digital Cash Bundle through Menu Commands

Some Host computing devices with a graphical user interface typically allow applications handling file types to not only replace standard functions available on files, but also to provide a richer set of functions by augmenting the standard operations offered by the Host operating system with new, more specific functions. For example, an implementation of a digital cash electronic wallet application could allow a user who has created a digital cash bundle to cancel the digital cash bundle and get refunded for its value, for example, if the user has decided that this cash bundle is not needed after all.

Thus, in specific exemplary embodiments, exposing functionality for canceling a digital bundle may be achieved by extending the file menu for digital cash bundles by adding a “Cancel” function, implemented by the digital cash electronic wallet application. For example, under Microsoft Windows, the user may perform actions on a file by way of right-clicking the icon representing that file on the desktop or an Explorer window, then selecting the appropriate action.

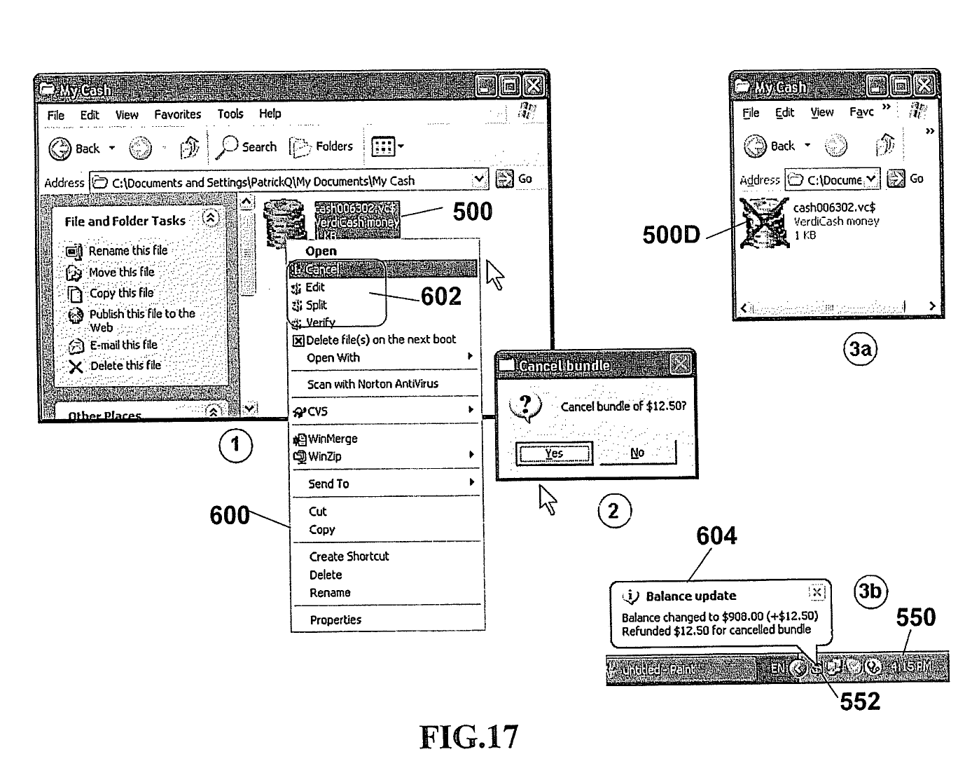

FIG. 17 describes how such extensions to the standard file menu options may be made available:
Step 1: The user right-clicks on a digital cash bundle, which brings up a list of commands 600 that can be operated on the file, including commands specific to digital cash bundles 602 as indicated by a green $ icon to the left of such commands, here “Cancel”, “Edit”, “Split” and “Verify”. The user selects the “Cancel” command.
Step 2: The digital cash management application asks the user to confirm his intention to cancel the digital cash bundle 500, which the user confirms.
Step 3a: The digital cash management application changes the “cancel” attribute of the digital cash bundle to effectively cancel the digital cash bundle. Nevertheless, the cancelled digital cash bundle continues to reside on the host device. This cancelled status of the digital cash bundle is detected by the digital cash status engine 102 associated with the digital cash management application. In accordance with this detected status, the digital cash management and/or visualization interface 104 associated with the digital cash management application is operative to display a visual indication of this status, namely the red “X” through the digital cash icon.
Step 3b: In addition, because the bundle was originally created by the user, upon cancellation of the digital cash bundle, the user's digital cash account is credited for the value of the digital cash bundle, as indicated in text message 604.

In the previous example, the “Cancel” function was augmented to the standard host file operations. It is appreciated, however, that the specific “cancel” function is just one example of an operation on a digital cash bundle that may be invoked using an augmented host menu for manipulating and/or modifying files or icons.

Furthermore, in specific implementations, digital cash bundles need not support this optional “cancel” functionality. Thus, in some embodiments of the invention, digital cash payments or bundles may be defined as an instrument that cannot be recalled, in order to allow a recipient to be confident in the validity of digital cash “offline”, i.e. with no online access to the Digital Cash Clearinghouse at the time of receiving the digital cash bundle. Other embodiments may allow digital cash bundles to be cancelled while also providing the ability to create digital cash bundles that cannot be cancelled, as an option to the creator of the digital cash bundle.

Furthermore, it is appreciated that the technique described above for canceling digital cash bundles is just one example, and other embodiments, for example, where the digital cash bundle is not implemented as a file, or embodiments where the digital cash bundle is implemented as a file but a different mechanism for canceling digital cash bundles is provided, are within the scope of the present invention

### Editing or Modifying Digital Cash Bundles

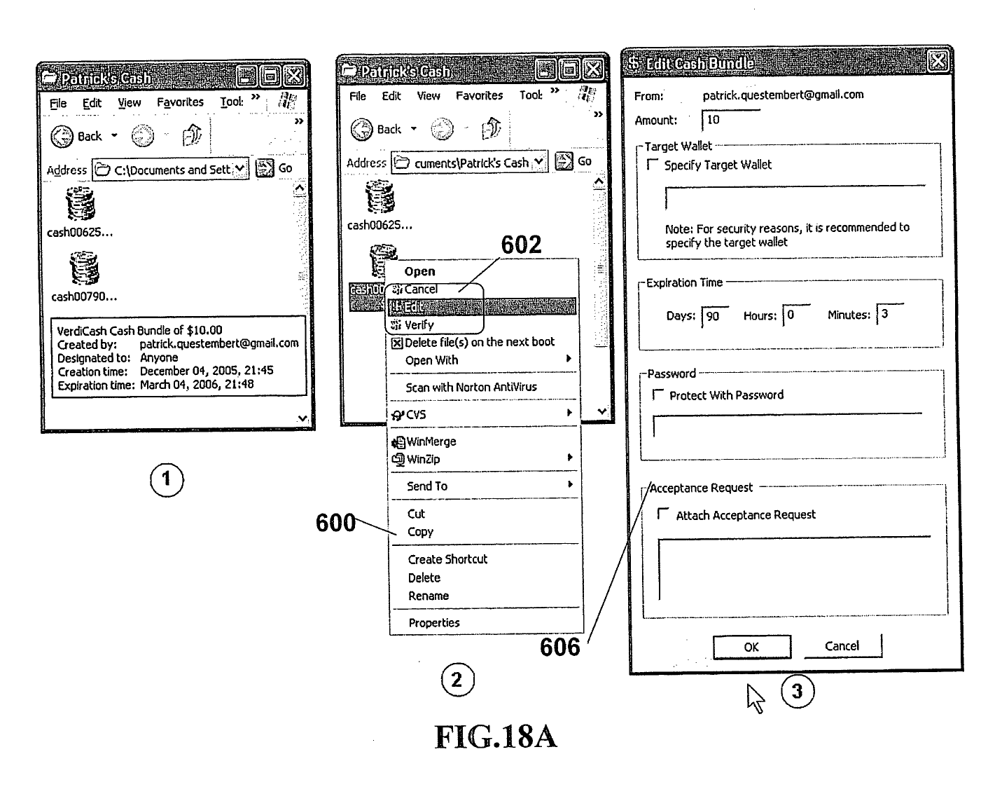

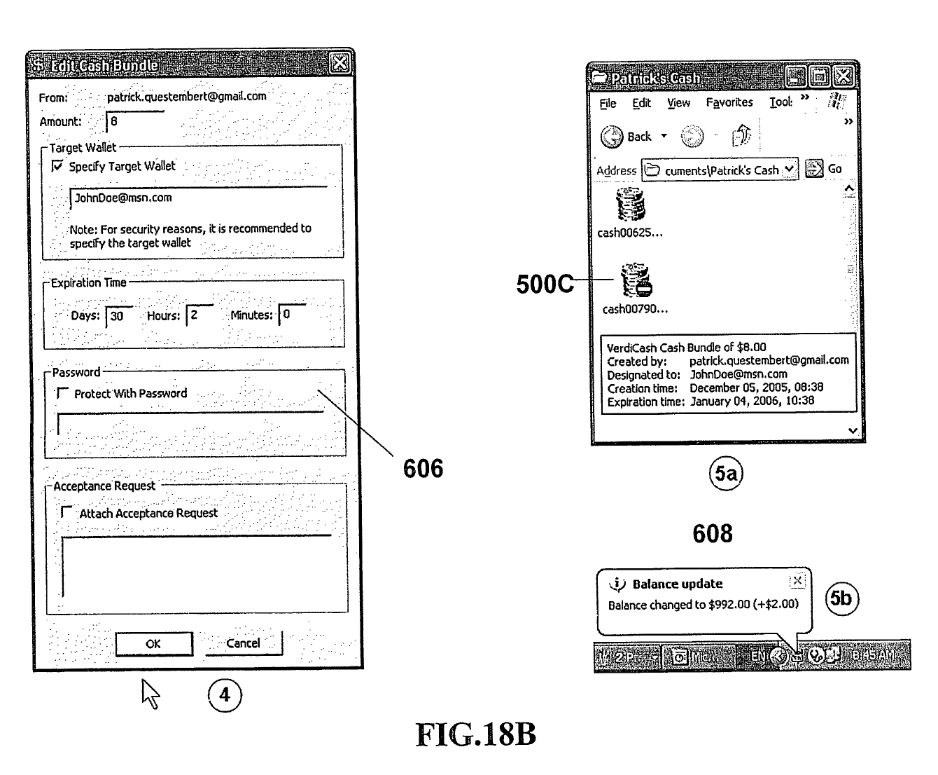

FIGS. 18A-18B illustrate a use scenario demonstrating another digital cash command that may be exposed through augmented menu options, namely the “Edit” functionality:
Step 1 (FIG. 18A): A file folder contains digital cash bundles 500, one of which is shown with textual details, worth $10, assigned to anyone and expiring on Dec. 4, 2005 at 21:45
Step 2 (FIG. 18A): The user right-clicks the digital cash bundle and selects “Edit”.
Step 3 (FIG. 18A): A cash modification interface 606 (for example, a dialog) is activated. This interface contains a plurality of fields corresponding to digital cash attributes. The default value in each field is the current value of the unmodified digital cash bundle.
Step 4 (FIG. 18B): The user decides use the modification interface 606 to reduce the value to $8, to assign the digital cash bundle to a specific target wallet, JohnDoe@msn.com and expiring in 30 days and 2 hours
Step 5a: The digital cash modification application (in particular, one or more digital cash engine(s) 114 associated with cash modification) applies the changes to the digital cash bundle (i.e. the changes received through the modification interface 606), the results of which are expressed in the displayed textual 608 information about the changed digital cash bundle. Note also the changed icon 500C, reflecting the fact that the digital cash bundle is now assigned to a specific wallet, which in this example, differs from the wallet associated with the user environment.
Step 5b: The user is credited by the difference between the new (reduced) value and the original value.

Under Microsoft Windows, augmenting the set of standard file operations with new operations for a specific file type may be done by adding sub-keys to the ProgID key, in the following form: Shell\[Action Name]\Command where the default value states the command to execute when this operation is chosen.

For example, to add a handler for the “Cancel” command for cash-bundles, the key named HKEY_CLASSES_ROOT\Verdicash.1\Shell\Cancel\Command” may have the default value of the full-path of the digital cash management application program, for example:
“C:\Program Files\VerdiCash\Wallet.exe”/Cancel %1
The “%1” represents the file which is being operated on. In the example shown above, the custom “Cancel” method of VerdiCash digital cash bundles is added, and “C:\Program Files\VerdiCash\Wallet.exe” with “/Cancel” flag will be invoked when the user chooses “Cancel” in the context-menu of a digital cash bundle. Note that if a behavior for a command with the specified name already exists, it is overridden by performing the above action, as shown earlier in the overriding of the “Open” command.

Furthermore, it is appreciated that the technique described above for canceling digital cash bundles is just one example, and other embodiments, for example, where the digital cash bundle is not implemented as a file, or embodiments where the digital cash bundle is implemented as a file but a different mechanism for modifying digital cash bundles is provided, are within the scope of the present invention.

Splitting Digital Cash Bundles

Real cash can be divided. For example, one may make a $6 purchase by presenting a $10 bill and receiving $4 back. In some embodiments, an analogous mechanism is provided for digital cash bundles. In certain embodiments, mechanisms and interfaces for splitting a digital cash bundle into a plurality of digital cash bundles is provided.

In exemplary embodiments this splitting operation entails the creation of one or more new digital cash bundles (worth $4 in this example) and adjusting the value of the original digital cash bundle (from $10 to $6 in this example). Alternatively, the original digital cash bundle is cancelled or discarded, and a plurality of “split” digital cash bundles are formed as a result of the splitting operation

A number of possible mechanisms may be employed for splitting digital cash bundles or payments. Thus, in some embodiments, a mechanism which allows a user to request the division of a cash bundle is provided, for example, as an augmented menu option 602 to a file menu 600 provided by the Host operating system.

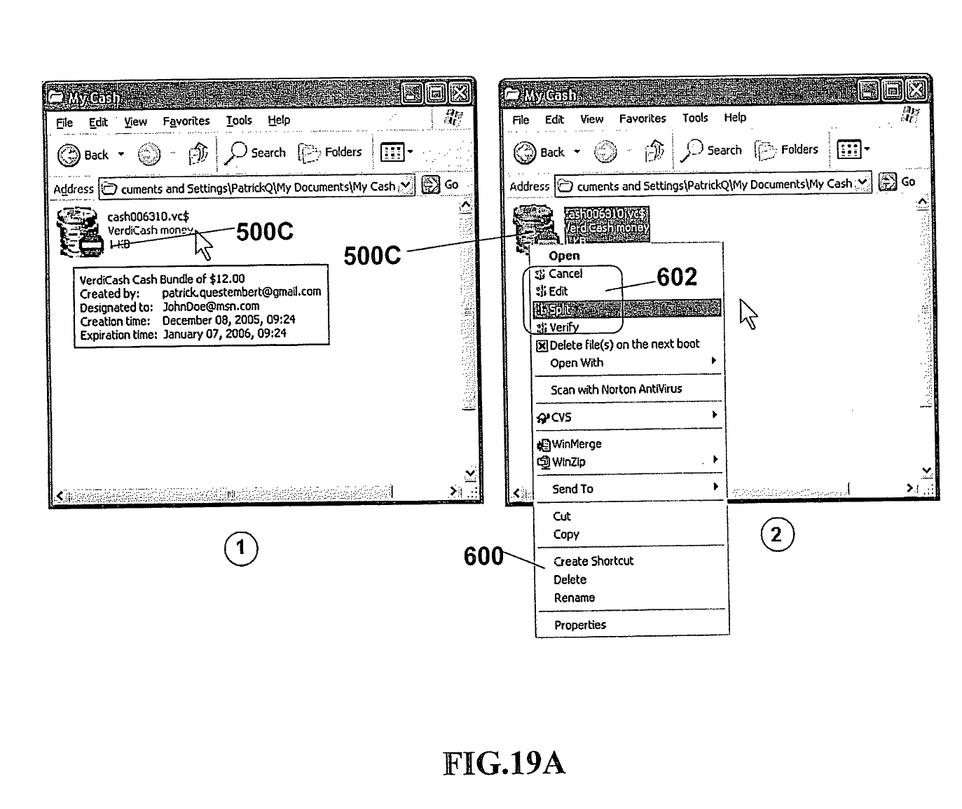

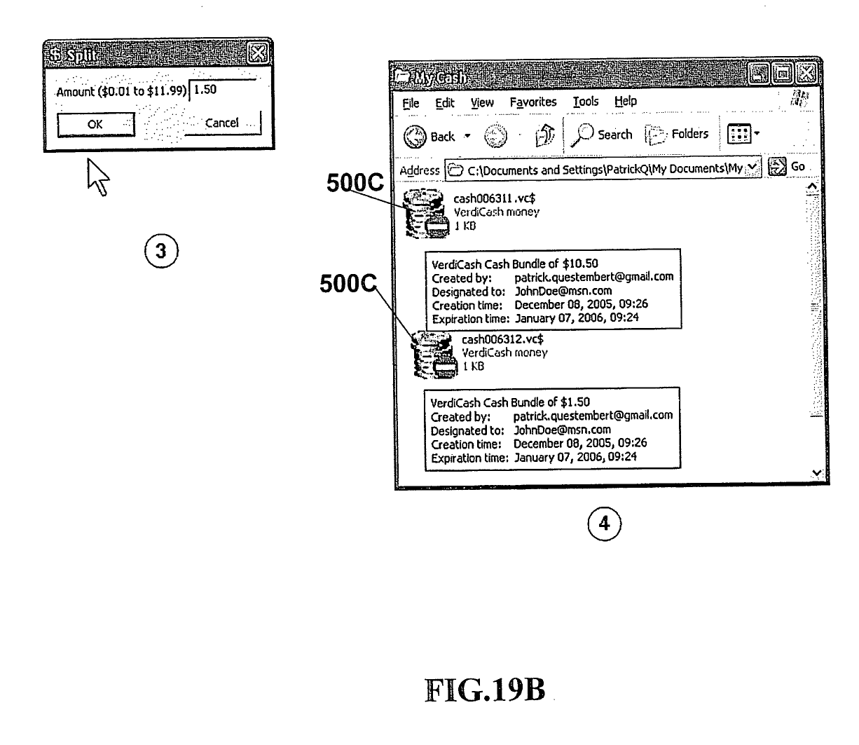

FIGS. 19A-19B illustrate a use case where a user splits one digital cash bundle into two digital cash bundles of equivalent total value:
Step 1: The user Patrick starts with one digital cash bundle 500C, worth $12 and assigned to a target user JohnDoe@msn.com.
Step 2: The user right-clicks the digital cash bundle 500C and selects the “Split” command from the menu 600.
Step 3: The digital cash management application prompts the user for the fractional amount to assign to the second cash bundle that is about to be created. The user enters $1.50 and confirms.
Step 4: As instructed, the digital cash management application creates a new digital cash bundle with value $1.50, while also creating a digital cash bundle with the remaining amount, here $10.50.

Note that in this particular example, the newly created cash bundles inherit the properties of the original cash bundle, so they are assigned to JohnDoe@msn.com and expire at the same time as the original digital cash bundle. Because the specified beneficiary or assigned owner (i.e. JohnDoe@msn.com) of the digital cash bundle 500C differs from the owner associated with the digital cash management application, the digital cash bundle is displayed with the “no-entry” sign.

Other implementations of the digital cash management application may prompt the user to choose the properties of the newly created cash bundles.

A second mechanism for handling the splitting of digital cash bundles is also contemplated. Thus, according to some embodiments, dividing a digital cash bundle may occur when dragging a digital cash bundle and dropping it onto a drop target, such as a vendor web site, that is expecting a specific amount or payment that is lower than the denomination of the original digital cash bundle. Thus, there may be a need to “make change.”

According to some examples, the drop target may specify its desire to accept only a portion of the value being dropped onto it, resulting into the creation of a digital cash bundle with a fractional value, possibly immediately consumed by the drop target, while the original digital cash bundle is adjusted to reflect the decreased amount. The use of digital cash bundles in more detail in the context of web sites is discussed later in this disclosure.

A third mechanism for handling the splitting of digital cash bundles is also contemplated. Thus, according to some embodiments, users are allowed to drag and drop a digital cash bundle onto a drop target, but instead of trusting the drop target to accept only a fraction of the value of the digital cash bundle being dropped, the user may control the fractional amount being deducted from the original digital cash bundle. This may be implemented using the “drag-copy” mechanism of graphical Host user interfaces. The term “drag-copy” means that the option is given to the user to drag items and drop items onto a target while making a copy of the source item, as opposed to the “standard” drag-and-drop operation where the items are moved to the target and concomitantly deleted from the source location.

On Microsoft Windows, drag-copy may be carried out by a user's holding the CTRL key down while dragging and dropping a digital bundle using the mouse and the left mouse button. When using that method (i.e. the “drag-copy” mechanism) on a digital cash bundle, the digital cash electronic wallet may prompt the user for the desired denomination for the target digital cash bundle, create the digital cash bundle with the specified denomination accordingly, and then reduce the value of the original digital cash bundle by the same amount.

According to one variation of the disclosed third mechanism for dividing digital cash, it is also possible to provide this functionality with an additional, specific user interface, as available on the Host. For example, in Microsoft Windows, such functionality may be provided when the user drags and drops a digital cash bundle using the right mouse button (as opposed to the left mouse button).

It is appreciated that the aforementioned techniques for splitting digital cash bundles by using the Host operating system resources is described in accordance with some exemplary embodiments of the present invention. According to other embodiments, for example, where the digital cash bundle is not implemented as a file, or embodiments where the digital cash bundle is implemented as a file but a different mechanism for modifying digital cash bundles is provided, other mechanisms may be provided for splitting digital cash bundles.

Combining Digital Cash Bundles

Bills and coins can also be exchanged for one bill with a denomination equal to the sum of the bills and coins for which it is exchanged. For example, one $5 bill and five $1 bills may be exchanged for one $10 bill. Digital cash should provide a mechanism for this type of operation.

According to some embodiments, a plurality of digital cash bundles may similarly be combined into a single digital cash bundle whose value is equal to the sum of the all of the constitutive digital cash bundles, for example, using a digital cash combining engine 118 provided by the digital cash management application.

In some embodiments, digital cash bundles may be combined to form a larger digital cash bundle by dragging one digital cash bundle onto another digital cash bundle. Both the drag source and the drop target in that operation are digital cash bundles, the result of the operation is a digital cash bundle with a value equal to the combined values of the two original digital cash bundle.

According to some embodiments, a new digital cash bundle with the combined value is created, the original source and target digital cash bundles are either deleted or marked them invalid Alternatively or additionally, the target digital cash bundle may be modified to receive the new combined value while the source digital cash bundles are concomitantly either deleted or marked invalid

Other attributes of the original digital cash bundles besides their values may affect the attributes of the resulting combined cash bundle, such as the cash bundle's time expiration, whether or not the digital cash bundle is assigned to a specific electronic wallet, whether it is protected with a password, and other attributes. This may lead to conflicts, for example if each digital cash bundle was assigned to specific but different recipient electronic wallets.

There are a number of possible mechanisms for resolving such conflicts, In some embodiments, a dialog may be displayed to allow the user to resolve the conflict, in this case by choosing one of the two target recipients, another one altogether, or none. In exemplary embodiments, a dialog is presented only when irreconcilable situations arise, while applying logical defaults rules in other cases, for example adopting the more limiting or secure setting. Exemplary possible default rules for combining digital cash bundles include:
If one bundle is unassigned (anybody can redeem it) while the other is assigned to a specific wallet, the combined digital cash bundle is assigned to the specific wallet
The combined digital cash bundle is configured to expire at the later of the expirations of the two original digital cash bundles.
If one bundle is protected with a password while the other is not, the combined digital cash bundle is protected with a password
If one bundle requires an Acceptance Request (described hereafter) while the other does not, the combined digital cash bundle is configured to require an Acceptance Request.

In some embodiments, should a user wish to adjust one of the properties (see FIG. 18) after the combined digital cash bundle is formed, he or she may do so.

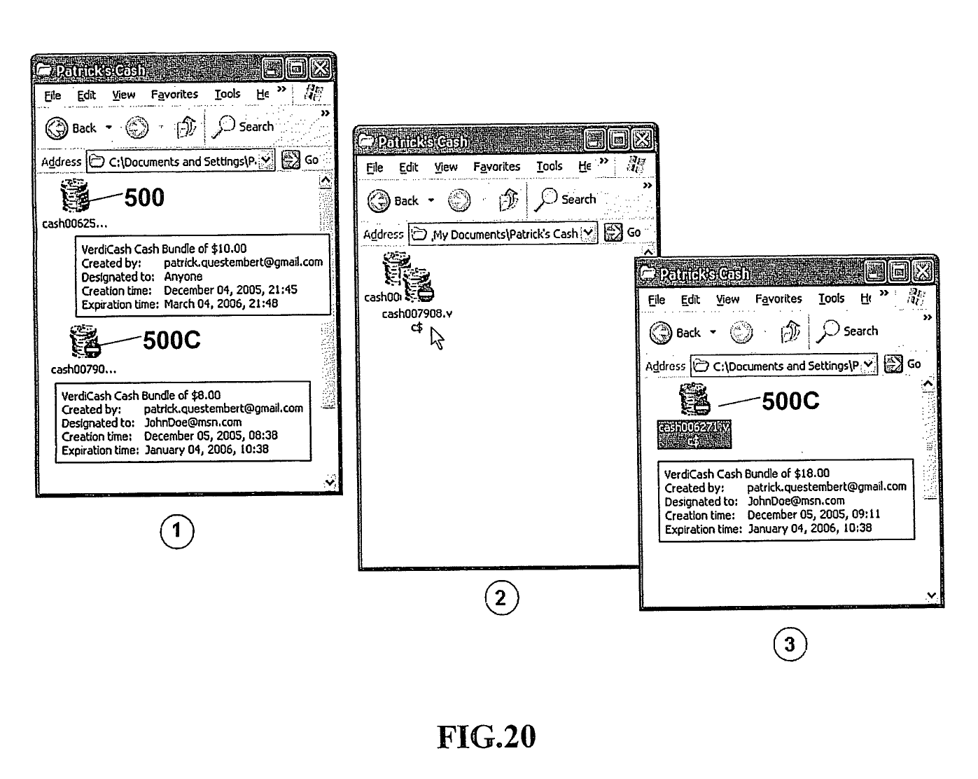

FIG. 20 illustrates an exemplary use case wherein a user combines two digital cash bundles:
Step 1: The user starts out with two digital cash bundles, one worth $10 and the other $8
Step 2: The user drags the icon of one digital cash bundle onto the other digital cash bundle
Step 3: The result is one new digital cash bundle with a value equal to the sum of the two original digital cash bundles, $18. Note that the resulting digital cash bundle is set with a target wallet assigned to JohnDoe@msn.com. This makes sense because the other cash bundle was unassigned, so it is a logical choice to adopt the more restrictive setting. We note that this use case is one example of a “silent” combining of digital cash bundles where the user drags and drops a first digital cash bundle onto a second digital cash bundle to create the combined digital cash bundle with no further input required from the user. In particular, the digital cash management application is operative to provide the resulting attributes without prompting the user for guidance. Note also the resulting expiration time: the top bundle expires on Mar. 4, 2006, at 21:48, the bottom bundle expires on Jan. 4, 2006 at 10:38 so the resulting digital cash bundle is set to expire on Jan. 4, 2006 at 10:38 (the earlier of the expirations)
   It is noted that the according to the example described in FIG. 20, there is no need to modify any balance of any digital cash account, because only existing cash bundles are combined. Furthermore, it is noted that according to the example of FIG. 20, the original two digital cash bundles are either deleted or rendered invalid at the time of the “silent” combining to generate a new combined digital cash bundle.

According to some embodiments, the above method is implemented on a Microsoft Windows system. Under Microsoft Windows, the above method for combining digital cash bundles may be implemented such that one of the plurality of digital cash bundles is a drop target, To achieve that, the digital cash management application may to implement a number of Component Object Module (COM) interfaces, exposed by Windows in the Dynamic Link Library “SHELL32.DLL” and the OLE infrastructure:
IPersistFile: the “Load” method of the “IPersistFile” interface may be implemented.
IDropTarget: by implementing the methods “DragEnter”, “DragLeave” and “Drop” of the “IDropTarget” interface, the digital cash management application can control the drag-and-drop operation performed on the target digital cash bundle.
   To instruct the Windows Shell to use the above implementations of the interfaces, the digital cash management application may add a reference to the digital cash management application GUID under the File-association key in the registry, in a sub-key called “ShellEx\DropHandler”.

It is appreciated that the aforementioned techniques for combining digital cash bundles by using the Host operating system resources is described in accordance with some exemplary embodiments of the present invention. According to other embodiments, for example, where the digital cash bundle is not implemented as a file, or embodiments where the digital cash bundle is implemented as a file but a different mechanism for modifying digital cash bundles is provided, other mechanisms may be provided for combining digital cash bundles.

Templates for Generating Digital Cash Bundles

Exemplary features of a digital cash generation engine 112 and associated digital cash generation interface as provided by the digital cash management have already been described. In some embodiments, a mechanism for defining how a family of related digital cash bundles may be generated is provided.

Thus, it is noted that there may be situations where a user needs to generate more than one digital cash bundle that share certain qualities. In one example, a user needs to create what is essentially the same digital cash bundle on a recurring basis. Requiring the user to individually generate each cash bundle may be burdensome to the user, and may also lead to user errors.

Thus, according to some embodiments of the present invention, a mechanism for creating digital cash bundles in accordance with directives received though a “template” is provided. In one example, such templates are provided as files, and may well have the same file extension as “regular” digital cash bundle files. According to this example, the digital cash bundle template files are nevertheless handled and displayed differently by the digital cash management application. Such digital cash template files may hold values for a subset of the attributes of digital cash bundles.

This digital cash template may not be associated with any cash value in itself. In some embodiments, a user dragging-and-dropping of a digital cash template object onto a drop target is operative to create a new digital cash bundle with attributes set to the values specified in the digital cash template. For example, this functionality may be included in the digital cash management application.

Thus, in one example, a user wishes to make a period payment (for example a rent payment) by generating and sending digital cash bundles. According to this example, the user may create a digital cash template specifying the rent amount, an identification of a digital cash account or electronic wallet associated with the landlord, and an expiration date which is set 29 days past the current time. Thus, according to this example, at the beginning of each month, the user composes an email to her landlord, and drags the prepared digital cash template into the email message. Once this template object or icon or file is dropped into a drop target associated with this email message, a digital cash bundle is created having the aforementioned defined attributes. According to this example, each month the user may then send the message with the respective embedded digital cash bundle to the landlord.

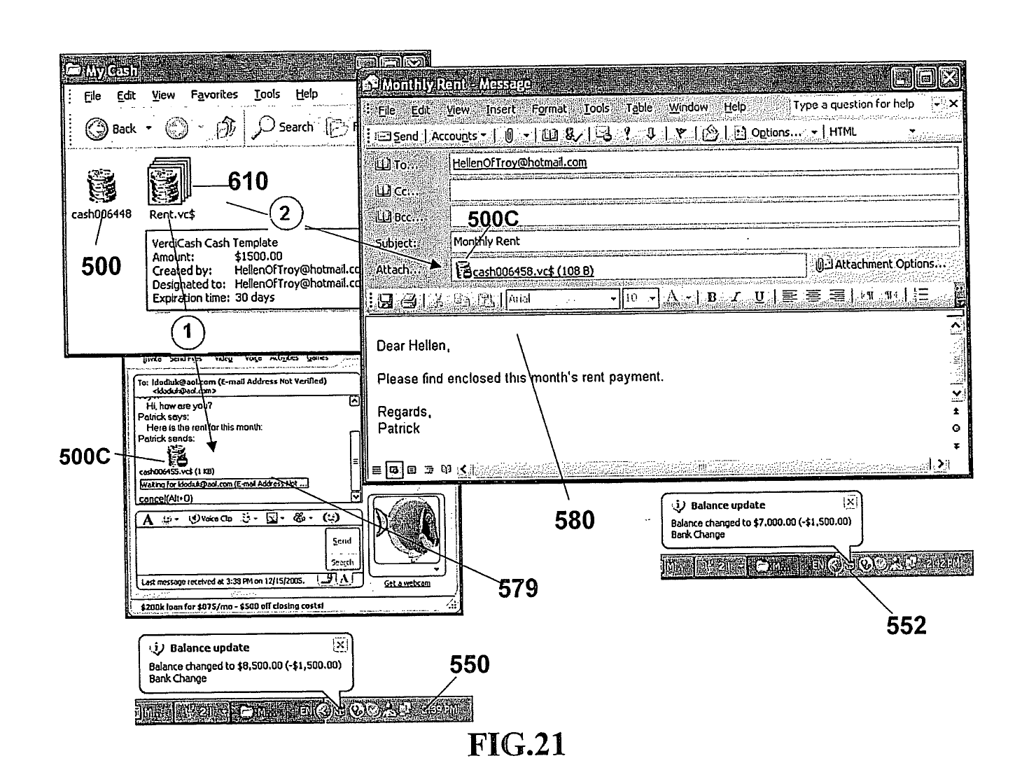

FIG. 21 describes an exemplary use scenario where a user keeps a graphical icon 620 representing a digital cash template (for example, a digital cash template file) in a local folder, and uses this template monthly to pay his rent:
Note the cash template file “Rent.vc$” 620 in the “My Cash” folder, alongside with a regular digital cash bundle 500. The template is displayed with a specific icon 620 indicating its nature. The template specifies that every cash bundle created with this template will have a value of $1,500, will be assigned to HellenOfTroy@hotmail.com, and will be configured to expire in 30 days.
Step 1: the user drags & drops the template into a frame 579 associated with a software application (i.e. a frame of a Microsoft MSN Messenger conversation). The digital cash management application generates a digital cash bundle with attributes set to those specified in the template and debits the user's digital cash account by $1,500. The software application (i.e. MSN) receives the generated cash bundle and sends it.
Step 2: one month later, the user decides to send the rent payment via email and drags-and-drops the object 620 representing template into a frame associated with a different software application (i.e. a Microsoft Outlook message frame 580). The digital cash management application generates a digital cash bundle with attributes set to those specified in the template and debits the electronic wallet $1,500. Outlook receives the cash bundle and sends the received cash bundle as an attachment to the email.
Note that in both steps 1 and 2, a new digital cash bundle is created at the time the template is dragged and dropped, but the user is not required to remember the details for the recurring payment, and thus saves the time entering these details. This is especially useful when a lengthy Acceptance Request (discussed later in this disclosure) is one of the attributes of the digital cash bundle used monthly. In this particular case, without digital cash templates, the user may need to recall and retype the Acceptance Request every month.

FIG. 21 highlights a useful business application of digital cash templates. As one may observe in the textual details shown for the cash template (i.e. textual details which visually indicate attributed of the digital cash template), the creator of the digital cash template is HellenOfTroy@hotmail.com. Yet the user utilizing the template is not Hellen, it is another user who is making a payment to Hellen (this may be deduced by the “no-entry” status of the generated icon representing the digital cash bundle embedded in the MS-Outlook message, because the creator of the digital cash bundle template is also Hellen). This corresponds to a business scenario where Hellen supplied the template to the user of FIG. 21, as a way to specify what payment she expects (in this case, $1,500, assigned to her wallet name, and expiring in 30 days). Note that a possible embodiment of the invention could prompt the user to confirm her intention to create a digital cash bundle with the details specified in any cash template not created by the user herself, to reduce the possibility of a first user defrauding a second user into making a payment different than the second user intended, by sending to the second user a template with unexpected values.

Digital Cash Bundles that are Assigned to a Particular User or Owner of a Digital Cash Account

The Internet is not safe. On the user's computer, the digital cash electronic wallet application may protect digital cash stored on the computer from unauthorized access by malicious users and programs. However, when a user sends a digital cash bundle or digital cash payment through the Internet, that digital cash is vulnerable to interception and misappropriation at least while in transit.

One possible technique for protecting a digital cash bundle entails associating the digital cash bundle (at a time of creation, or subsequently) with an explicit identification of a destination (for example, a destination user or digital cash account). According to some implementations, the format of the associated digital cash bundle is such that the digital cash is valid only when redeemed in an environment associated with this explicit identification (for example, redeemed by the target user or by the owner of the digital cash account).

Furthermore, financial institution(s) processing the assigned digital cash bundle or payment will only credit the destination digital cash account specified and will only provide real money in exchange for the assigned digital cash bundle or payment to a party that is identified as the assigned destination user.

As described earlier in the disclosure, in some embodiments of systems and methods for visualizing digital cash, the digital cash status engine 102 may detect this assigned status or attribute of a given digital cash bundle, and in accordance with this detected status, a visual indication of this status (i.e. the “no-entry” graphic) may be associated (i.e. by the digital cash visualization interface 102 of the digital cash management application) with a graphical icon 500C representing the digital cash bundle. This visual indication informs the user of the status of the digital cash bundle—i.e. the digital cash bundle is associated with a digital cash account other than the digital cash account of the digital cash management application

Cash Bundle Manipulation Operations

Various examples of operations for generating, modifying and manipulating digital cash bundles according to exemplary embodiments have thus far been described, and more will be described below. Some of these “cash bundle manipulation operations” are accessible by dragging-and-dropping a graphical icon, such as a graphical icon 500 representing digital cash bundles, or a graphical icon 552 associated with an installed software application.

Other cash bundle manipulation operations are accessible through user engagements of graphical icons representing digital cash bundles other than drag-and-drop engagements. For example, some cash bundle manipulation operations may be accessible by clicking an icon, or through an operation accessed by a modified file menu.

Exemplary cash bundle manipulation operations include but are not limited to modifying a cash bundle attribute, copying the cash bundle, verifying the cash bundle, opening or redeeming the cash bundle, splitting the cash bundle, and merging the cash bundle with another cash bundle.

Password-Protected Digital Cash Bundles

Specifying a destination digital cash account is not always possible or desirable. The destination account may not be known at the time the digital cash is created and sent. In one example, the digital cash may be destined to any of a group of persons, any of which could be the one who will receive credit for the digital cash bundle. According to another example, digital cash is sent to a person who does not even have a digital cash account or electronic wallet, and thus, it is not even possible to specifying a target digital cash account.

Certain embodiments of the present invention provide a framework for protecting digital cash bundle with a password. Thus, only a user that provides a correct password can successfully deposit the digital cash bundle into a digital cash account. Failure to provide the correct password will result in a failure of the user to be credited for the digital cash bundle. Some implementations may furthermore provide a mechanism where a user may provide a correct password to remove the password protection. One business scenario where this may be useful is where the recipient provides a password to “free” a digital cash bundle from the password protection, and later sends the unprotected (or unredeemed) digital cash bundle as payment to another user.

One possible embodiment entails using the password to generate a cryptographic key, which is then used to encrypt the contents of the digital cash bundle: only a user in possession of the correct password can provide it to her digital cash electronic wallet application, which can then properly decrypt the digital cash bundle According to a variation of this method, the digital cash clearinghouse is required to be involved in any attempt to decrypt the digital cash bundle with the password: in this manner, a mechanism for enforcing a limit on the number or frequency of attempts to decrypt the digital cash bundle is provided, thereby hindering brute force attacks aimed at determining the correct password by randomly guessing possible passwords. The cost of this alternate implementation of password-protected digital cash bundles may include a higher computational load on the digital cash clearinghouse.

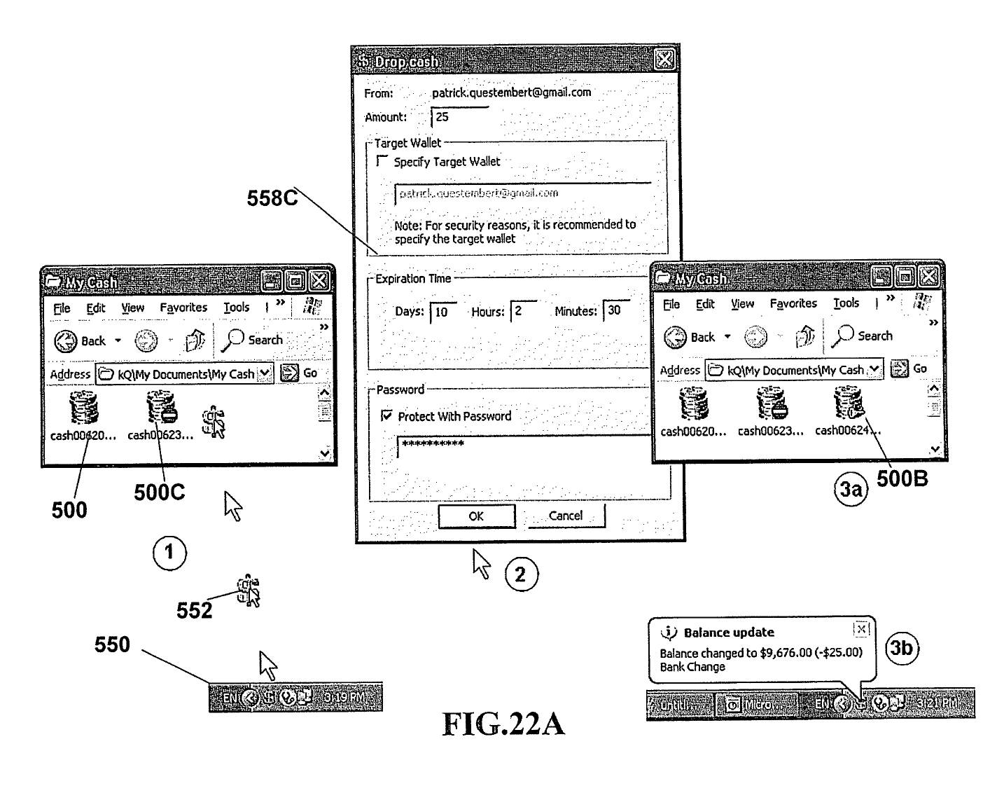

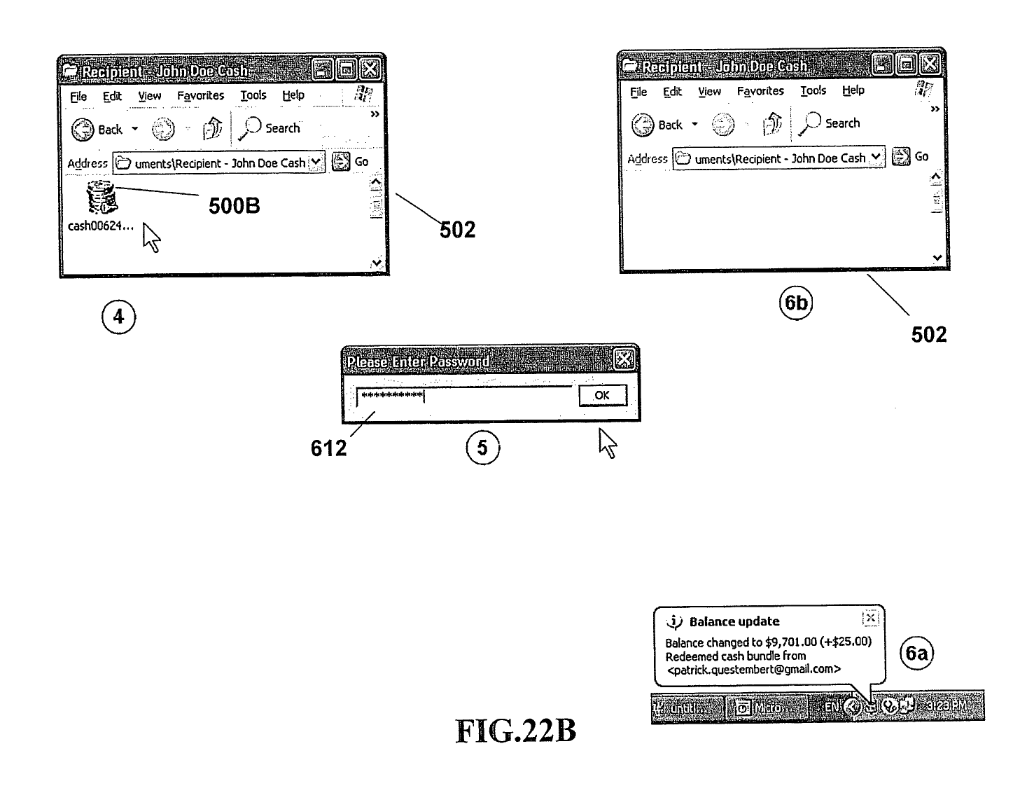

FIGS. 22A-22B describe exemplary use scenarios where a user may create a password-protected digital cash bundle and how a recipient user redeems that bundle:
Step 1 (FIG. 22A): A User creates a digital cash bundle, by dragging-and-dropping an icon 552 associated with the digital cash management application onto a “My Cash” folder 502
Step 2 (FIG. 22A): The User chooses to attach a password to the digital cash bundle and enters the desired password.
Step 3a (FIG. 22A): A new digital cash bundle 500C is created, with an attached password as indicated by the small key overlay on the icon of the new digital cash bundle
Step 3b (FIG. 22A): The digital cash account of the User is debited by $25, the value of the digital cash bundle
The password-protected digital cash bundle is sent to another user, the Recipient (step not shown)
Step 4 (FIG. 22B): On the Recipient machine, the Recipient double-clicks the digital cash bundle to redeem it.
Step 5 (FIG. 22B): The Recipient is prompted to enter the password
Step 6a (FIG. 22B): When the password matches, the Recipient electronic wallet is credited for the value of the bundle
Step 6b (FIG. 22B): The digital cash bundle, now consumed (redeemed), is now deleted.

In some embodiments, the digital cash bundles are implemented as files, and the password protection may be implemented as a password necessary to unlock the file (for example, a local password needed to unlock a “local” file).

Deferred Digital Cash Bundles

A need may arise in financial transactions where a person delivers payment significantly ahead of the time that payment is due. This may be thought of as analogous to a “post-dated” check, which may only be cashed after a certain time.

In some scenarios, this may be done to partially reassure the payee that the payer intends to honor this payment in the future, while allowing the payer to continue to enjoy ownership (and possible interest income) of the funds until the due date. For example, a renter may give her landlord 12 checks dated one month apart, which the landlord may deposit at the beginning of each month.

In another possible scenario, the payee receives a deferred digital cash payment or bundle in advance, but will know only at a specified later time whether or not he will be able to perform that service. If he cannot perform the service, he will decline to deposit the deferred digital cash bundle. Issuing the digital cash bundle for a future date may, in some scenarios, serve to avoid misunderstandings and remind the payee of the delayed nature of the service requested. Thus, in some embodiments, “deferred digital cash bundles” meet the aforementioned business requirements. An implementation of the invention that supports deferred digital cash bundles may include one or more of the following:
An attribute of cash bundles is defined as “Redeeming Date”, similar in format to the expiration date, and can be set by the creator of the bundle (the Payer) to any future date
Any attempt to redeem that bundle before the Redeeming Date will be denied by the Clearinghouse
Until Redeeming Date, the Payer's digital cash account is not debited. Note however that an embodiment of the invention may place a financial hold on the amount of the deferred cash bundle, to ensure that sufficient funds will be available at Redeeming Date.
At Redeeming Date the Payer's digital cash account may be debited by the cash bundle amount
Any time after the Redeeming Date the Payee may redeem the cash bundle at his convenience, if he deems he can deliver the requested service. In one example, the Payee may demand that the deferred bundle be created as “non-cancellable” so that the Payer cannot cancel the cash bundle before it the Redeeming Date is reached.

As stated above, in many scenarios, the Payer may continue to enjoy the benefits of the value of the cash bundle. Even if a financial hold is placed on that amount so that this amount may not be spent, this amount may earn interest income. From the Payee's point of view, the use of deferred digital cash may help to ensure that the cash bundle will be valid after the specified date. Finally, in many scenarios, the deferred redeeming date is in the interest of both parties when the service cannot be performed by the Payee at the redeeming date: the Payee will not accept the bundle, which will eventually expire, and in that manner there is no financial debit or credit in the accounts of either Payer and Payee—a preferred situation, avoiding issuance of a refund from Payee to Payer. Note that is some cases, such refund is not possible, such as when the identity of the parties is not known.

It is noted that digital cash bundles having an expiration date, and deferred digital cash bundles are just two examples of digital cash bundles that may be associated with a “specific time constraint.” Another example of a “time constraint” relates to bundles that may not be redeemable at certain hours of the time or certain days of the week. It is noted that in general, digital cash bundles that are not redeemable at one specific time (and will be redeemable at another specific time) may be transferred between users, and business methods reciting the transferring of such digital cash bundle are contemplated by the present inventor.

Repeat Digital Cash Bundles

In most cases, digital cash payment systems provide a mechanism for preventing “double-spending,” that is the redeeming of the same digital cash bundle or payment into a digital cash account more than once (or exchange of the same digital cash for real money more than once).

The present inventor is now disclosing for the first time that in certain business scenarios, it may be a desirable functionality of the digital cash system to in fact permit redeeming the same digital cash (any digital cash, including but not limited to digital cash payments or bundles) more than once. Thus, in one example, a Sender may wish to solicit paid advice from a large group of receivers, such as sending a request by email to a distribution list, but limit the expense to a given number of answers. Sending multiple distinct digital cash bundles to the group, in one example, may not be practical from the sender's point of view. Furthermore, in this example, the recipient group probably would not want the hassle of coordinating who gets which respective cash bundle.

Thus, some embodiments of the present invention provide systems, methods and computer-readable code for managing and/or generating and/or visualizing “repeat” digital cash bundles. A Repeat cash bundle may be similar to a “regular” cash bundle (i.e. cash bundles that are redeemable only once) in other aspects with the addition of one attribute, namely multiple redeemability. This may implemented by providing a decrementable integer “counter” that represents how many times a given digital cash entity (for example, a digital cash bundle or payment) may be redeemed or exchanged for real cash.

Returning to the particular example of a paid request for help sent to an email distribution list, let us assume the Sender is willing to pay $3 for each answer, and wants to receive no more than four answers. All that is needed is for the Sender to create one Repeat digital cash bundle with its counter set to 4, and to attach this unique digital cash bundle to an email sent to the group Assuming an honest group of recipients, only the first four respondents who feel they can provide an answer would redeem the bundle and reply. After four redeemings, the cash bundle is no longer valid and any responder trying to redeem this repeat digital cash bundle would fail.

In a particular embodiments, the “verify” function on a Repeat digital cash bundle provided by the digital cash management application would inform the user how many more available redeemings are possible. In some embodiments, the Repeat cash bundle icon or textual representation to indicate that attribute may be automatically updated.

Repeat cash bundle may place an additional burden on the digital cash Clearinghouse, which needs to count redeemings made oil such cash bundles. In some embodiments of the invention, the Clearinghouse prevents the same user from redeeming a Repeat cash bundle more than once, which means the Clearinghouse also needs to keep a list of which electronic wallets have redeemed the bundle so far. In other embodiments of the invention, the user creating the cash bundle would have the option to decide whether to allow the same user to redeem a Repeat cash bundle more than a specific number of times (for example, more than once). Note that there are valid scenarios where it would make sense to for a Sender to send a Repeat cash bundle to a Recipient while allowing the Recipient to redeem the cash bundle multiple times: for example, the cash bundle could be payment for to a consultant for a maximum number of billable hours spread over a long time, whereby the consultant would redeem the Repeat cash bundle each time he works one hour on the project, but no more than the count of the Repeat cash bundle.

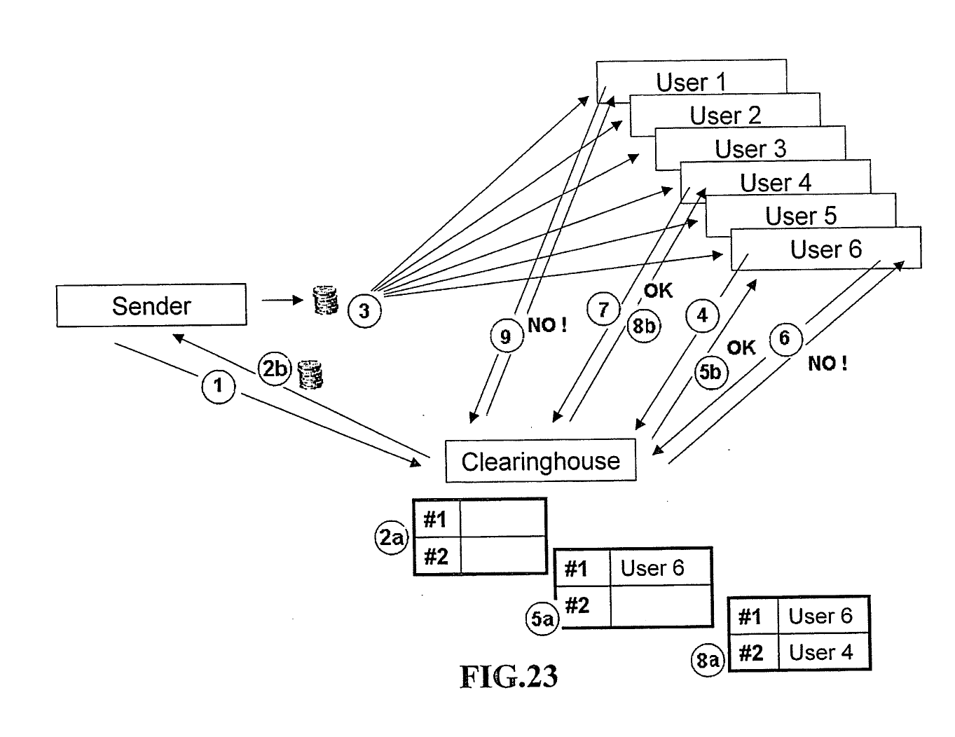

FIG. 23 illustrates a user scenario where a Sender creates a repeat digital cash bundle of value $10, with a Repeat counter set to 2, and distributes the repeat digital cash bundle to a group of 6 users:
Step 1: the Sender asks to create a Repeat cash bundle worth $10 (each redeeming) and with a Repeat counter set to 2.
Step 2a: the Clearinghouse complies with the request by manufacturing a Repeat cash bundle with the specified attributes by preparing a table to keep track of redeemings, with as many entries as the Repeat counter, in this case 2. Both entries in the table are initially empty
Step 2b: the Clearinghouse sends the cash bundle to the Sender and charges her electronic wallet by $10×2=$20 (the value of the bundle multiplied by how many times it can be redeemed).
Step 3: the Sender sends the Repeat cash bundle to 6 users.
Step 4: User 6 is the first to request to redeem the cash bundle
Step 5a: the Clearinghouse makes note of the fact that User 6 has redeemed the bundle
Step 5b: the Clearinghouse credits User 6's electronic wallet
Step 6: User 6 requests to redeem the cash bundle for a 2^{nd} time. In this example, the Clearinghouse denies the request because User 6 has already redeemed the cash bundle. Note that other embodiments of the invention may allow the same user to redeem a repeat bundle more than once, in which case the Sender would have the option to allow it or not when he creates the cash bundle.
Step 7: next, User 4 requests to redeem the cash bundle
Step 8a: the Clearinghouse makes note of the fact that User 4 has also redeemed the bundle. At this point, the Repeat bundle has been redeemed a number of times equal to its count property, so it cannot be redeemed.
Step 8b: the Clearinghouse credits User 4's electronic wallet
Step 9: User 1 requests to redeem the digital cash bundle—it is too late, the repeat cash bundle has been redeemed the maximum number of times, and the request fails.

One business scenario involving repeatable redeemable digital cash (for example, repeatably redeemable digital cash bundles or payments) relates to the case of an Internet site that wishes to conduct a promotional marketing campaign, and to advertise that digital cash will be available on the site at a certain time. Any visitor is invited to open and redeem a digital cash bundle displayed on the web site. According to this scenario, the Internet site would create the cash bundle as a Repeat digital cash bundle redeemable by each user only once, and with a count set to according to how much money the Internet site is prepared to invest in that marketing promotion. When the maximum number of visitors has redeemed the cash bundle, the promotion automatically ends and further visitors may receive an error message explaining that this cash bundle has been redeemed the maximum number of times.

Acceptance Request

One challenge facing any payment system, and particularly digital cash, involves dispute resolution. Digital cash multiplies the need for mechanisms to help address situations where goods or services are paid for but said services and goods are never delivered. This is an acute problem in the online world. When a consumer chooses the trust a vendor and pays before receiving the item, she is exposed to the risk that the vendor will not fulfill his obligation. This is even more problematic in the context of person-to-person transactions, such as items bought and sold using an “eBay” model (for example, used goods), where little may be known about the provider of the goods or services. Oftentimes, even some form of payment trail is not quite enough to ensure that a consumer can obtain restitution of payment for services not rendered. For example, the vendor or person who accepted payment could claim that the payment was made for a different service than claimed by the consumer.

Some embodiments of the present invention provide a mechanism to help address dispute resolution for payments made with digital cash bundles. In particular, some embodiments support an optional property of digital cash bundles to be called the acceptance request (hereafter “Acceptance Request”). One purpose of Acceptance Requests is to seek compliance by the recipient of a digital cash bundle with specified terns and conditions (for example, terms and conditions set out by the sender of the digital cash) offered so that acceptance of the digital cash bundle becomes binding (for example, legally binding) between the sender and receiver. Two exemplary types of Acceptance Requests are:
1. A statement declaring that the enclosed payment fully satisfies the recipient as compensation for a past event such as services rendered, goods delivered or compensation to settle a dispute, a bet, etc.
2. A statement committing the recipient to perform specified services or deliver goods at a future time.

The acceptance request may include a document written in any language understandable by the person receiving the cash bundle. In some embodiments, its format may be any digital format that may be rendered into human-readable text. Exemplary formats include but are not limited to text format, a Microsoft Word format and Adobe Postscript Description File (PDF) format.

Furthermore, it is appreciated that the acceptance request may be presented to a user using any communications medium, and may include any combination of text messages, graphical messages and multi-media message. Thus, embodiments providing a multi-media presenting of an acceptance condition (for example, a slide show) are also contemplated.

In some embodiments, the digital cash bundle may be associated with an attribute indicating that an acceptance request document is attached to the cash bundle. This may be implemented by making the Acceptance Request document an integral part of the digital cash payment or bundle (for example, by embedding at least a portion of the acceptance request, or a reference to the acceptance request, within the digital cash bundle file). The digital cash bundle (containing the Acceptance Request) may be sent to the intended recipient in any of the disclosed manner (for example, by email or using a peer-to-peer application), irrespective of the associated acceptance request.

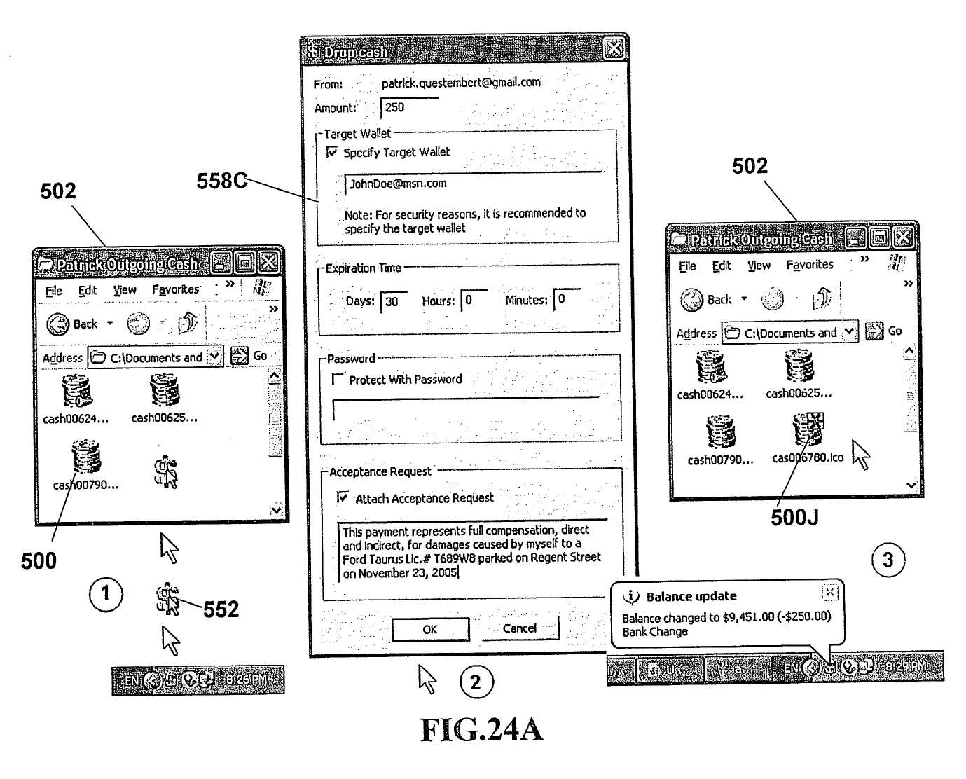

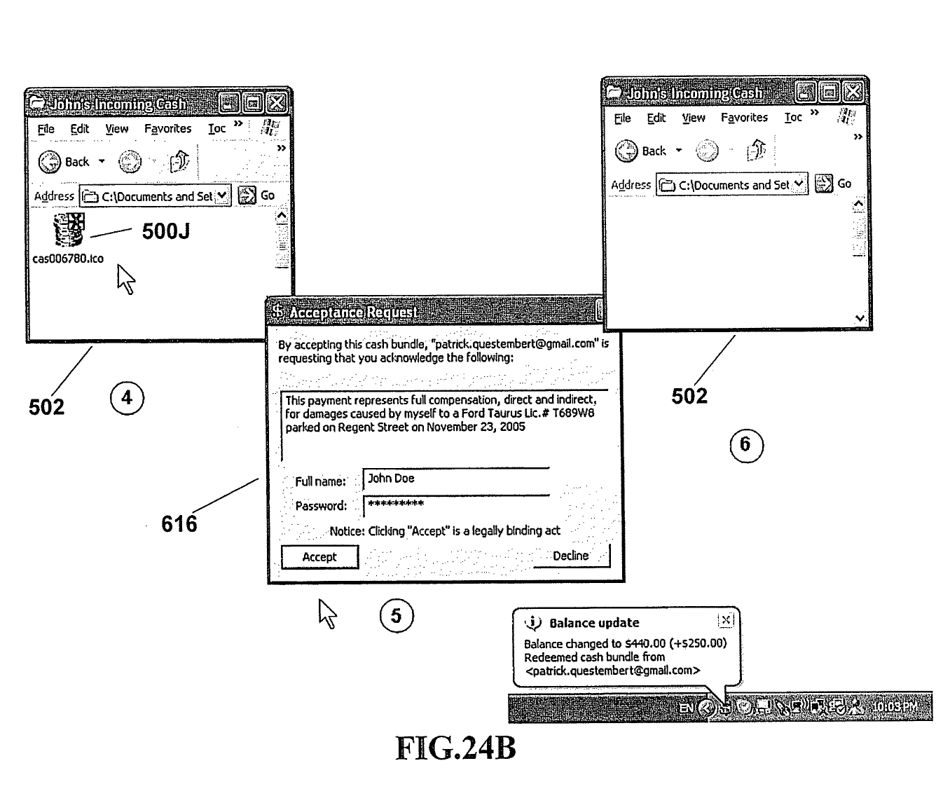

In some embodiments, a user may be alerted to the presence of the acceptance request associated with the digital cash bundle even before opening or attempting to redeem the digital cash bundle. For example, the digital cash bundle may have a digital cash attribute related to the acceptance request (for example, the presence of the acceptance request, or the type of acceptance request), which is detectable by the digital cash status engine 102. In particular, the digital cash management application (i.e. the Digital Cash Management And/or Visualization Interface 104 of the digital cash management application) may be operative to associate a visual indication of the presence the acceptance condition with a graphical icon (for example, 500J of FIG. 24) representing the digital cash bundle.

It is noted that when the user opens the cash bundle associated with the digital cash bundle, the digital cash management application displays the Acceptance Request to the user, and a choice is presented to her: the user may proceed to open/redeem the digital cash bundle and be credited (for example, to a digital cash account) for the value of the digital cash bundle, but if the user chooses to do so, she first has to explicitly acknowledge that she has read the Acceptance Request and agrees with the statement(s) made in that request. Only then will the user be credited for the cash bundle (or, alternatively, only then will the acceptance request be removed from the digital cash bundle).

In some embodiments, the digital cash management application may take steps to compellingly ascertain that the recipient has read the Acceptance Request and acknowledged it. This may involves one or more several known mechanisms such as making the default selection on the Acceptance Request screen be “Cancel” and not “Accept” so that the user must explicitly click on the “Accept” button. Other steps may include asking the user to type his first and last name in an entry field, and requiring him to enter the password associated with his electronic wallet or digital cash account.

In some implementations of the digital cash management application, customizable forms may be provided to users with recommended legally binding phrasing for a variety of common business needs, such as dispute resolution, rent payment, advance payment for goods to be delivered, and more. Users would be able to choose one such template where they can modify the appropriate sections to fit their specific case.

In exemplary embodiments, a number of technologies and institutions could be brought to bear in order to transform the Acceptance Request into a legally binding document. For example, certain technologies may be used to certify whether or not a digital proof of the acceptance by a recipient of an Acceptance Request is indeed authentic and not a digital forgery.

In order to describe these technologies and institutions, first roles and attributes of the agents involved in processing a digital cash bundle will be described, then a discussion of the technology and processes that make digital cash bundles verifiably authentic will be provided.

In the context of this discussion, it is noted that the Digital Cash Clearinghouse represents the entity(ies) manufacturing, verifying and redeeming digital cash bundles. The “Sender” refers the user issuing a digital cash bundle with Acceptance Request sent to the Recipient. The “Recipient” refers to the user receiving the digital cash bundle and accepting the Acceptance Request.

Recall first that digital cash bundles may be digitally signed by the Clearinghouse. In the context of this disclosure, it will be assumed that the Clearinghouse is using public-key cryptography, although other cryptographic algorithms may be used instead and are within the scope of embodiments of the present invention. The authenticity of a digital cash bundle may stem from the fact that the Clearinghouse has signed a portion (or all) of the digital cash bundle with its private key. The Clearinghouse's public key is typically made available to all interested parties, for example by trusted servers on the Internet. Furthermore, this public key is typically a key that has been issued by reputable trusted certification authorities such as Verisign Inc, to assure users that the encryption key is indeed owned by the Clearinghouse. Furthermore, assume also for the purpose of this discussion that only the Clearinghouse is empowered to ultimately confirm that a digital cash bundle is valid and exchange this digital cash associated with the acceptance for real money (or alternatively, credit one or more digital cash accounts). Assume further that the Clearinghouse and the electronic wallet application together implement a security infrastructure that ensure that digital cash bundles may only be redeemed by the legitimate user owning the electronic wallet for which a digital cash bundle is intended. This provision implies that a cash bundle will only be delivered to the intended user and into the correct electronic wallet, as vouched for by the Clearinghouse secure technology. For the purpose of this discussion, assume that this security provision is met by way of some form of encryption protocol whereby the Recipient electronic wallet communicates with the Clearinghouse using an encryption key unique to the Recipient electronic wallet.

On the basis of the above background, here is an exemplary sequence of events that may lead to the sender obtaining a digital proof of the acceptance by the recipient of the Acceptance Request:
1. Sender creates a digital cash bundle, assigned to the recipient (and only to the recipient), with an Acceptance Request attached containing any text the Sender wants the Recipient to acknowledge.
2. In response, the digital cash Clearinghouse includes in the digital cash bundle a signed version of the Acceptance Request, signed with the private key of the Clearinghouse. The entire digital cash bundle is composed in a manner that it is coherent and valid only with the untampered Acceptance Request attached.
3. Sender sends the digital cash bundle to the Recipient, via email or any other mean
4. Recipient receives the digital cash bundle and opens it, which corresponds to a request to his electronic wallet application to credit his electronic wallet by the value of the cash bundle.
5. As he does this, the Recipient is shown the text of the Acceptance Request. If he declines to acknowledge the text of the Acceptance Request, nothing happens and he is not credited for the value of the digital cash bundle. He may of course return to that cash bundle at a future time if he changes his mind.
6. If the recipient accepts the Acceptance Request, a notification of that fact, along with the cash bundle, is sent to the clearinghouse. That notification is the digital equivalent of a guarantee that the correct Recipient has acknowledged the right Acceptance Request, using the correct electronic wallet. One embodiment of that notification could be a combination of the password entered by the user+the first and last name he has entered+the text of the Acceptance Request, all this signed in a unique manner by the electronic wallet, or any other secure protocol implemented between the electronic wallet and the Clearinghouse that uniquely identifies the electronic wallet of the Recipient.
7. The Clearinghouse credits the electronic wallet of the Recipient by the value of the cash bundle.
8. The Clearinghouse then forwards to the Sender a notification of this sequence of events having taken place, signed with the Clearinghouse private encryption key. An alternative could be that the Clearinghouse just makes a record of this event, and provides a certified letter to that effect upon request.

As is apparent from this example, the ability of this mechanism to withstand challenges as legally admissible evidence in legal venues chosen to resolve disputes where the plaintiff introduces a digital Acceptance Request acknowledgment as evidence may depend on the reputation of the Clearinghouse and the technologies involved. In some examples, interested parties involved in a dispute may need to convince the court hearing the case that the acknowledgment indicates that the named defendant has indeed accepted the digital payment after reading the attached Acceptance Request.

Naturally, it is expected that most disputes will be deterred or resolved with the aid of this Acceptance Request mechanism without resorting to bringing the matter to court.

It is appreciated that other mechanisms for producing legally acceptable evidence are within the scope of the present invention, and it is noted that the aforementioned mechanism is provided as an example.

Much of the above Acceptance Request mechanism has been described based on an embodiment of the invention where a central trusted entity (the Clearinghouse) must be involved in the transaction and thus is able to ascertain acknowledgment by the Receiver of the Acceptance Request attached to a digital cash bundle and provide digital proof of it to the Sender. However, the presence of such a central trusted entity is by no means a requirement for the implementation of the Acceptance Request mechanism described herein. One alternate embodiment could be implemented in what is called “peer-to-peer” systems where Sender and Receiver interact directly. In that case, the assumption may be that each of both parties have her own private key (or equivalent encryption mechanism). Known protocols and techniques whereby two parties can exchange information back and forth while implement authentication (unequivocal identification of both parties) and non-repudiation (meaning that the sender of information cannot deny having sent it) using public-key cryptography may be employed. These protocols could be applied to implement the exchange of a digital cash bundle without the intermediation of a trusted server, with the inclusion of a step in the protocol whereby the Recipient signs the Acceptance Request with his private encryption key.

FIG. 24 describes an exemplary use scenario where a sender Patrick creates a digital cash bundle with an acceptance condition, and sends this digital cash bundle to a recipient John. According to this example, John may then redeem Patrick's digital cash bundle only after acknowledging the acceptance request:
Step 1 (FIG. 24A): Patrick drags and drops a notification icon 552 of the digital cash management application to a folder 502 where digital cash bundles 500 are presented and/or stored;
Step 2 (FIG. 24A): When presented by the digital cash management application with the drag-and-drop dialog 558C, Patrick chooses to attach an acceptance request to the digital cash bundle
Step 3 (FIG. 24A): Patrick's digital cash management applications debits Patrick's digital cash account for $250 and creates the requested digital cash bundle 500J with the attached acceptance request in the selected folder. Note the icon 500J of the newly created digital cash bundle, showing the presence of an acceptance request
Patrick sends the digital cash bundle to John (step not shown)
Step 4 (FIG. 24B): John has received the digital cash bundle and temporarily saved it in a folder 502. Note the icon 500J providing the visual indication to John of the presence of an Acceptance Request John attempts to open (redeem) the digital cash bundle (for example, by engaging the icon, for example, by clicking or double clicking on the icon 500J)
Step 5: John is presented with the acceptance request 616 attached by Patrick
Step 6: John acknowledges the acceptance request and can now be credited for the value of the digital cash bundle

Although the previous example relates to embodiments where the acceptance condition is associated with a digital cash bundle at a time of cash bundle generation, it is appreciated that in some embodiments, acceptance conditions may be associated with pre-existing digital cash bundles, thereby modifying one or more attributes of the digital cash bundles.

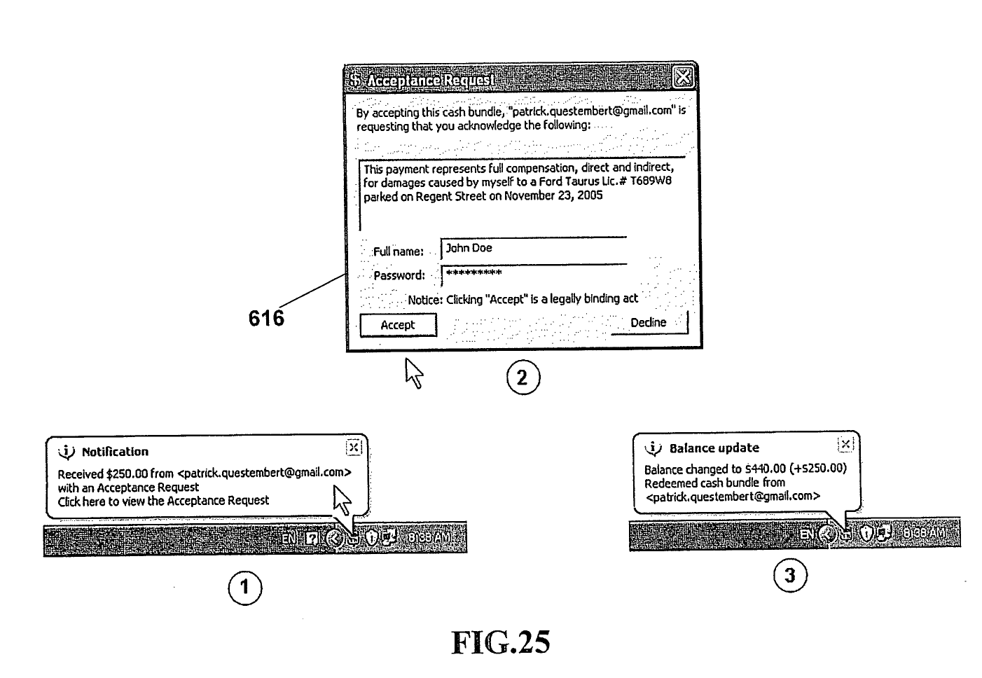

Some embodiments of the present invention associate an acceptance request mechanism with digital cash that is not necessarily provided in the form of a digital cash bundle Thus, it is noted that an acceptance request may also be attached to any digital cash payment, as long as the system ensures that such payment can only be received after the recipient acknowledges the acceptance request. FIG. 25 shows the equivalent process where no digital cash bundle file is used:
Patrick sends digital cash to John along with an acceptance request, which his digital cash management application transmits to John's digital cash management application using an appropriate protocol (step not shown)
Step 1: John's digital cash management application receives the digital cash and acceptance request and notifies John
Step 2: John clicks on the notification message 616 and is presented with the acceptance request
Step 3: only when John acknowledges the acceptance request, he is credited for the amount of the digital cash payment.

It is recognized that there are many scenarios where it is important to maintain appropriate records of the redeeming user's agreement to the acceptance condition, for example, for presenting in a court of law. Furthermore, there may be certain circumstances where it is preferable that this record not be maintained exclusively on the host device of the user redeeming the digital cash. Thus, according to some embodiments, an application supporting redeeming digital cash bundles with acceptance conditions (for example, the digital cash management application) may send a notification of the user's notification to another machine. In one example, this notification may be carried out in accordance with instructions to send or make available a piece of legally admissible evidence of the user acceptance that is associated with or embedded within the redeemable digital cash bundle.

In all of the aforementioned examples, the acceptance request is sufficient for redeeming of the digital cash bundle. This should not be construed as a limitation. It is noted that the fulfilling the acceptance request may be a necessary but not necessarily a sufficient condition for redeeming the digital cash bundle. Thus, embodiments are contemplated where in addition to fulfilling the acceptance request, further actions must be taken to redeem a particular digital cash bundle.

It is noted that acceptance of the digital cash bundle or payment may be operative to mace the digital cash bundle redeemable, and this is said to a form of “granting access” to the digital cash bundle or payment. It is noted that “full access” is not necessarily granted, as discussed in the earlier patent, where it was explained that fulfilling the acceptance request is a necessary but not sufficient condition for redeeming the digital cash payment or bundle.

Acceptance Software Consent

Consumers have grown very cautious about installing non-essential software applications, or even visiting web pages with embedded scripts. Operating systems and browsers have become better at warning and protecting PCs from unwanted software, and some laws have been formulated to allow prosecuting makers of unwanted unauthorized software. Some of these limitations may be circumvented in accordance with exemplary embodiments described herein.

In particular, a new acceptance format called Acceptance Software Consent is defined, whereby:
1. A new code element is added to the digital cash bundle comprising an executable code module or code segment which the creator of the digital cash bundle wishes to execute on the computer where said digital cash bundle is being redeemed.
2. An Acceptance Request text is attached, as in the previous mechanism, but whereby part or all of the text of the Acceptance Request details what the attached software code performs.

It is noted that the new code element is code that is distinct from the redeeming code—i.e. that includes directives other than those associated with the actual redeeming of the digital cash bundle.

A user who wishes to redeem the digital cash bundle may now be required to acknowledge the Acceptance Request, where this acknowledgement also authorizes the execution of the embedded software code.

There is no limitation on how the embedded software code is provided. Thus, in some embodiments, the actual code is not necessarily embedded, but rather a reference to the desired code (for example an Internet URL pointing to an application or script located on a web site) is provided. This may provide an indication to the user of the origin of said software code. In some examples, this knowledge would help the user overcome his or her reluctance to execute the software code on the host device. For example, users may tend to assume that code which resides within the www.microsoft.com domain is software provided by Microsoft Corporation as no other entity has the access rights to place software on this domain, and is therefore less likely to be malicious.

In another embodiment, the mechanism for signing code modules with certificates identifying the software vendor may also be used to authenticate the software code embedded in the digital cash bundle.

Relevant business scenarios related to associating the executable code with the digital cash bundle or payment include, but are not limited to, the following scenarios:
An Internet company desires for individual users to set their default home page to a certain web page. In order to provide an incentive for users change their default home page, digital cash bundles associated with software script code that sets the user's home page to the vendor's portal, and an Acceptance Request text asking to user to acknowledge his consent to that operation may be provided. The incentive for the user to agree to that setting is not only a marketing tool: it may also provide the Internet vendor a legally admissible proof that said installation was performed with the user's consent.
In other scenarios, the embedded software code may not install anything or make any changes to the user's computer and instead may just be a consumer survey to be completed. Thus, the digital cash provides an incentive for the user to participate in this survey.
In yet other scenarios, the digital cash bundle is a rebate offered to users of a commercial software application, subject to the condition that they authorize the execution of a registration process or possibly authorizing their copy of the application to send (anonymous) feedback to the software maker about how the application is being used.

According to some embodiments, a mechanism is provided to notify the creator of the digital cash bundle that not only did the embedded software code begin to execute, but that the code execution process was allowed to be completed. This may be implemented by providing a coordination mechanism by which the embedded software code may signal its successful completion to the digital cash engine so that the redeeming of the digital cash can be allowed to proceed.

Message Display Request

A variation on the acceptance request mechanism is provided wherein the creator of a digital cash bundle attaches a message she wishes displayed on the recipient machine, when a user redeems the digital cash bundle. Unlike the acceptance request, the purpose is simply to inform the user redeeming the bundle, and not to obtain his consent to the content of an acceptance request. The electronic wallet of the recipient guarantees the creator of the cash bundle that the message is displayed.

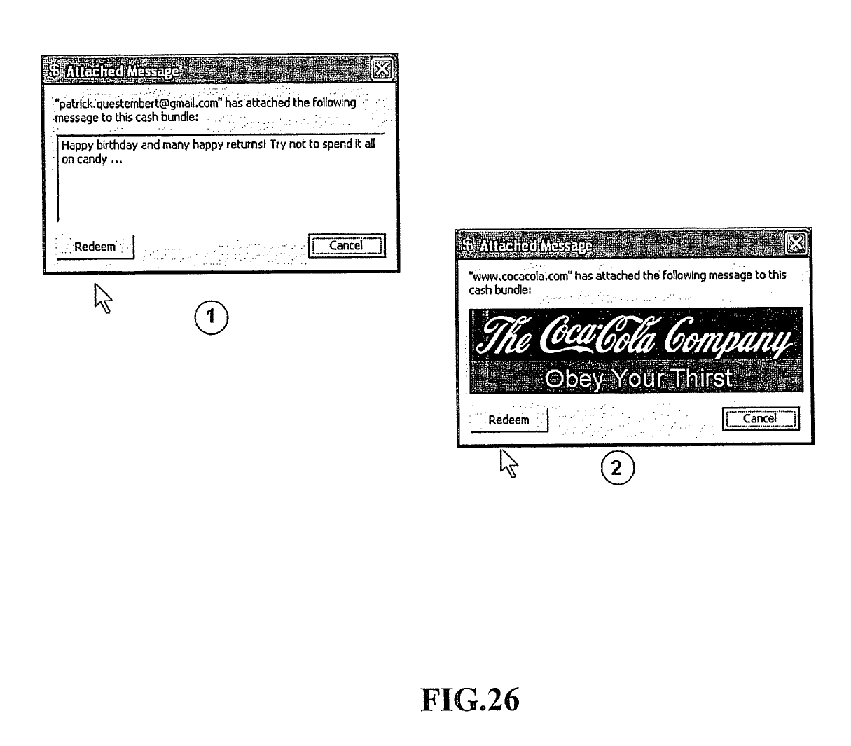

FIG. 26 shows two examples of messages attached to a digital cash bundles. In each example, the message is displayed as a result of a user request to redeem the digital cash bundle. The step of attaching the message as part of the creation of the digital cash bundle is not show—it is similar to that step shown in the acceptance request figure:

### EXAMPLE 1

An informative message explaining the reason for the small cash gift, at the occasion of a birthday.

### EXAMPLE 2

A commercial advertising message from the Coca-Cola Company, including graphical elements.
It is appreciated that the “informative message” may include any combination of text messages, graphical messages and multi-media messages.
According to another scenario, an employee is paid with a digital cash bundle where his pay stub or other financial information message is provided as an informative message.

As used herein, an “informative message” is a message which includes content whose meaning transcends the messages related to the act of redeeming.

It is noted that in some embodiments, the digital cash bundle is said to be redeemable “concomitant” with a viewing of the message This notion of the digital cash bundle being redeemable concomitant includes the case where the digital cash may only be redeemed when the message is viewed in its entirety. Alternatively, in some embodiments, the digital cash bundle which is redeemable concomitant with a viewing of the message is also redeemable after the process of viewing the message commences, and interrupting the presentation of the message does not adversely affect the redeeming of the associated digital cash bundle.

Furthermore, it is noted that in different embodiments, the redeeming of the digital cash bundle may occur before the presentation of the message, while the message is being presented, or after the presentation of the message.

A Discussion of Exemplary Digital Cash Attributes that May be Represented by the Digital Cash Management and/or Visualization Interface 104

As discussed throughout this disclosure, the digital cash management and/or visualization interface 104 may be configured to associate a visual indication of one or more digital cash attributes with a graphical icon represent the digital cash bundle.

One exemplary digital cash attribute is the monetary value of the digital cash bundle. In one example, an indication of the monetary value of the digital cash bundle appears on the bundle itself. Alternatively or additionally, this value may be presented upon a user engagement with the icon representing the digital cash bundle, for example, by passing the mouse pointer over the icon.

In some embodiments, one or more visual indications of one or more parameters indicative of a source of the digital cash bundle may be associated with a graphical icon 500 representing the digital cash bundle (i.e. one or more visual indications of these one or more parameters may be associated with the graphical icon). Non-limiting examples of the “source” of the digital cash bundle include the identity of the actual creator, whether or not the digital cash bundle came from an employer or from a bank (e.g. the type of the creator), the country in which the digital cash bundle was created, and any other parameter related to the source of the digital cash bundle.

In some embodiments, one or more visual indications of one or more parameters indicative of a creation time of the digital cash bundle may be associated with a graphical icon 500 representing the digital cash bundle. Exemplary parameters indicative of a creation time of the digital cash bundle include are not limited to the actual time of creation, and a parameter indicating whether or not the digital cash bundle was created during a specific time period (for example, in the last week, more than one week ago, etc).

In some embodiments, one or more visual indications of one or more parameters indicative of an expiration and/or an earlier possible redeeming time of the digital cash bundle may be associated with a graphical icon 500 representing the digital cash bundle. In one example, the interface 104 may provide a visual indication about whether or not a given bundle has already expired. In another example, the interface 104 may provide a visual indication of when a bundle is about to expire (for example, within the next day, or the next hour), and this may serve as a warning to users to hasten them to redeem the bundle.

In some embodiments, one or more visual indications of one or more “destination” parameters (i.e. parameters related to who or where a given bundle may be redeemed) of the digital cash bundle may be associated with a graphical icon 500 representing the digital cash bundle. Exemplary destination parameters include but are not limited to, an identity of one or more target digital cash accounts electronic wallets that are authorized to redeem the digital cash bundle (for example, a digital cash account associated with the digital cash management application), the region of the world where a digital cash bundle may be redeemed (in one example, a digital cash bundle is issued by a business trying to encourage people to visit the physical premises of the business, and this bundle may only be redeemable in a certain region of the country), and a number of users that may redeem the digital cash (for example, for repeat digital cash bundles—in one example, as other users redeem the digital cash bundle, this number may be updated).

In some embodiments, one or more visual indications of one or more parameters indicative of the ability of the present user to redeem the digital cash bundle may be associated with a graphical icon 500 representing the digital cash bundle. Thus, seen in icon 500C of FIG. 2B, the “do not enter” symbol may indicate that the present user may not redeem the digital cash bundle.

In some embodiments, one or more visual indications of one or more cancellation status parameters of the digital cash bundle may be associated with a graphical icon 500 representing the digital cash bundle. One example of a “cancellation parameter” is a cancellability status, i.e. whether or not the creator or a third party has permission to cancel the digital cash bundle. Another example of a “cancellation parameter” is whether or not the creator or third part has already cancelled the digital cash bundle, when this digital cash bundle was cancelled, or who cancelled this digital cash bundle.

In some embodiments, one or more consistency status parameters of the digital cash bundle may be associated with a graphical icon 500 representing the digital cash bundle. One example of a consistency status parameter is whether the digital cash bundle is corrupted (for example, a corrupted file), or is possibly corrupted.

In some embodiments, one or more parameters indicative of an earliest valid redeeming time may be associated with a graphical icon 500 representing the digital cash bundle. Non-limiting examples include the earlier time or date the bundle may redeemed, and whether or not this “event” occurs in a given period of time, for example, within the next week or the next month.

In some embodiments, one or more multi-redeeming parameters indicative of an earliest valid redeeming time of may be associated with a graphical icon 500 representing the digital cash bundle (for example, whether or not a given bundle is a repeat bundle, how many redeemings have already been recorded for a given bundle, how many times the bundle may still be redeemed).

In some embodiments, visual indications of one or more acceptance condition parameters attached to the digital cash bundle may be associated with a graphical icon 500 representing the digital cash bundle. One non-limiting example of an “acceptance condition parameter” is a presence or absence of an acceptance condition. Other examples of acceptance conditions parameters include but are not limited to the media in which the acceptance condition is presented (e.g. whether or not it is pure text or a graphical presentation), whether or not the acceptance condition requires a voice acceptance recording or just typing in an acceptance, whether or not the acceptance condition requires more than one users to accept, etc.

In some embodiments, a notification of redeeming status parameter of the digital cash bundle may be associated with a graphical icon 500 representing the digital cash bundle. One exemplary redeeming status parameter relates to whether or not the creator of the digital cash bundle or some third party has requested to receive notification of redeeming.

In some embodiments, one or more security status parameters of the digital cash bundle may be associated with a graphical icon 500 representing the digital cash bundle. One exemplary security status parameter is whether or not the digital cash bundle is password protected.

In some embodiments, a notification of modifiability status parameter of the digital cash bundle may be associated with a graphical icon 500 representing the digital cash bundle, for example, whether or not someone can attach new conditions (e.g. an acceptance condition)) to the digital cash bundle or otherwise modify a digital cash attribute.

In some embodiments, an online redeeming status of the digital cash bundle (i.e. whether or not the bundle can be redeemed off-line) may be visualized.

In some embodiments, an informative message status (for example, whether or not the digital cash bundle is associated with an informative message, the type of informative message, the size of informative message, etc.) may be associated with a graphical icon 500 representing the digital cash bundle

In some embodiments, a currency status parameter (for example, a currency of the bundle) may be associated with a graphical icon 500 representing the digital cash bundle.

### Environmental and Dynamic Digital Cash Attributes

It is noted that many different types of digital cash attributes have been presented. Many of these attributes may be labeled as “environmental” attributes—i.e. digital cash attribute whose “value” is determined in accordance with events that transpire outside of the actual confines of the digital cash bundle. In one example, some attributes may depend on a current time. For example, one may define a “cash bundle is redeemable at the current time” attribute indicative of whether or not a given digital cash bundle may is presently redeemable. The “value” or “setting” of this attribute may change in accordance with the present time. Thus, according to particular examples, if a digital cash bundle has an earliest redeemable time of 4:35 PM, then the “cash bundle is redeemable at the current time” would have a “negative” value at 3:48 PM, and would have a “positive” value at 4:39 PM. Exemplary environmental factors on which attribute values may depend (and hence, environmental factors which may effect visual properties associated with graphical icon representing a digital cash bundle) include but are not limited to attributes a current time, a location in which the digital cash bundle resides (i.e. an identity of a machine), and factors associated with a digital cash management application that is running (for example, an identity of the active user/logged in user or an identity of a group to which an active user belongs)

It is noted that many of these “environmental factors/parameters” are also dynamic factors/parameters” which may vary in time and in accordance with different events that transpire (for example, an issuer of a digital cash bundle canceling the cash bundle).

One example of an environmental factor is a “financial institution environmental factor.” Financial institution environment factors are derived from events that involve one or more financial institutions. Exemplary financial institution environmental factors include but are not limited to whether or not the issuer cancelled the bundle, whether or not other people have cashed a repeat bundle, a foreign currency exchange rate, how many people have cashed a repeat bundle (“a number of external cashings of a repeat cash bundle”), etc.

Password-On-Delivery

There is an ongoing need for systems and business methods which are useful for protecting buyers and/or sellers of business transactions (for example, online purchasing) from fraud. In many instances, buyers may be reluctant to send payment for an item before the item is received. Furthermore, sellers or vendors may be averse to providing goods or services before appropriate payment is received. It is noted that this issue has been around for decades in the context of making purchases by telephone or by mail order. After a buyer mails or phones or sends his order to the vendor, the vendor ships the goods to the residence of the seller. A common solution used for such situations is “cash-on-delivery”, whereby the Buyer pays only upon receipt of the items shipped, and receives the items only if she pays.

The present inventor is now disclosing that digital cash can also be a powerful tool for protecting buyers and vendors from fraud in certain transactions. In accordance with some embodiments of the present invention, business methods are provided for facilitating transactions involving digital cash. Some of these presently disclosed business methods may be useful for protecting a buyer and/or a vendor from fraudsters.

Assume that the Buyer wants to purchase a physical item offered online by the Vendor. The buyer pays for the item with a digital cash bundle or payment. Although the presently disclosed method will be described in terms of paying with a digital cash bundle, it is appreciated that the method may be implemented using any digital cash payment.

The Buyer and the Vendor may agree on the following conditions of payment in the form of a digital cash bundle created by the Buyer as follows:
1. Value: the required amount to purchase the item
2. Assigned: the Buyer creates the bundle assigned to a digital cash account controlled by the Vendor. This means that only the Vendor and nobody else may be credited upon a redeeming of this digital cash bundle, although in some embodiments, a third party may perform the act of redeeming the cash bundle on behalf of and to the credit of the Vendor.
3. Password: a password chosen by the Buyer which is not initially revealed to the Vendor
4. Expiration: whatever time is sufficient for the Vendor to ship the item, and to receive the password information back from the shipment company (see description of the system below), with an optional margin of safety
5. Cancellation: the Buyer creates the bundle with the attribute that it cannot be cancelled

After agreeing on the aforementioned form of digital cash payment, the Buyer sends the digital cash bundle to the Vendor.

The Vendor then may verify at least one of: that the digital cash payment or bundle bears the correct amount, that the digital cash payment or bundle is assigned to the Vendor, that the digital cash payment or bundle cannot be cancelled by the buyer and that the expiration allows for sufficient time to ship the item. Note that the Vendor cannot redeem the digital cash bundle at this time, as he does not know the password. This protects the buyer from being defrauded by a Vendor who wants to receive payment without providing the item.

The Vendor then submits the item to a shipping agent (for example, UPS, Federal Express or the US Postal Service) or an agent thereof for delivery to the Buyer. In addition, in some embodiments the Vendor submits to the shipping agent a copy of the digital cash bundle that the Vendor has received from the Buyer. It is noted that the shipping agent cannot redeem the cash bundle as this cash bundle is assigned to the Vendor and also protected by an unknown password.

Before the shipping agent delivers the item to the Buyer (for example, at a time of delivery immediately before the shipping agent hands off the item to the Buyer), the shipping agent may demand from the Buyer the password for verification. After verification, the item is given to the Buyer.

In one particular example, the Shipping Agent uses a portable computing device capable of performing the cryptographic algorithms required to verify the password with the digital cash bundle. This portable device is brought by a representative of the shipping agent to a delivery location, and upon receiving the proper password from the Buyer, the representative may verify the validity of the password using the portable device on which the digital cash bundle (or another electronic file or data structure associated with the digital cash bundle) resides.

In particular embodiments, the password may be verified offline, that is without requiring the Shipping Agent's portable computing device to be online with access the digital cash Clearinghouse. It is noted that techniques for verifying passwords offline are known in the art. Note that the Shipping Agent still cannot redeem the digital cash bundle, because it is assigned to the Vendor.

Upon verifying the password of the digital cash bundle, the Shipping Agent may then notify the Vendor of the password. Note that in some embodiments the password may be sent in the open, for example within an email sent by the Shipping Agent to the Vendor, because that password is only useful for that particular digital cash bundle which has not been publicly distributed. Note that while the password is being sent to the Vendor, the Buyer cannot cancel the digital cash bundle because it was created with the “cancelable” option set to “no” (see condition 5 above).

The Vendor receives the password and may now redeem the digital cash bundle.

In some embodiments, the actual digital cash bundle or digital cash payment file is given to the Shipping Agent. Nevertheless, it is noted that this is not a limitation of the present invention. In an alternate embodiment, the Vendor does not need to send the actual digital cash bundle to the Shipping Agent. Instead, the Vendor provides a portion of that cash bundle designed to allow a 3^{rd} party to verify the password of the digital cash bundle using that specific portion, without needing to possess the cash bundle itself.

Providing only a portion of the digital cash bundle virtually eliminates the risk that the Shipping Agent will redeem the bundle for itself in an unauthorized manner. Because the risk of fraudulent behavior by the Shipping Agent is thus reduced, this allows the Buyer and the Vendor to effect payment without needing to assign the digital cash bundle to the Vendor.

The method above (all three alternate embodiments) reduces the risk that the Buyer may pay for an item that ends up never to be shipped: If the Vendor does not ship the item, the Vendor will never be given the password and will not be able to redeem the cash bundle. Eventually, past the reasonable shipping time allotted by the Buyer, the cash bundle will expire and the Buyer will be refunded.

The method (all three alternate embodiments) also reduces the risk that the Buyer will cheat the Vendor: the Buyer cannot receive the item without providing the (valid) password. In addition, the Buyer cannot cancel the cash bundle right after receiving the item, because the cash bundle has been created as “non-cancelable”.

In the event that the Buyer refuses to accept shipment, the Shipping Agent may send the item back to the Vendor, who has lost only the shipping costs. This is no different that the traditional cash-on-delivery mechanism.

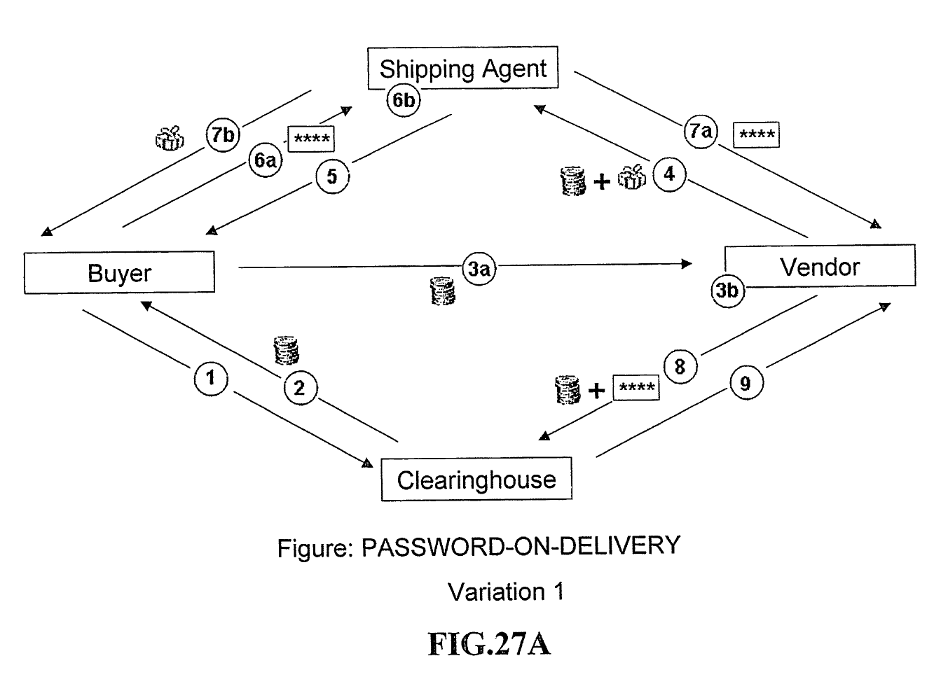

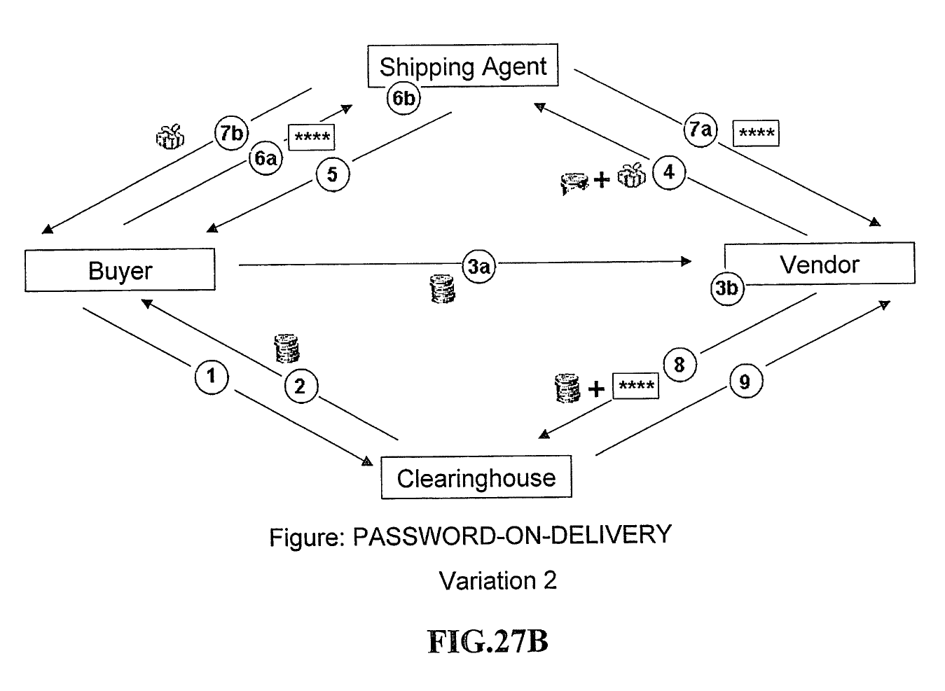

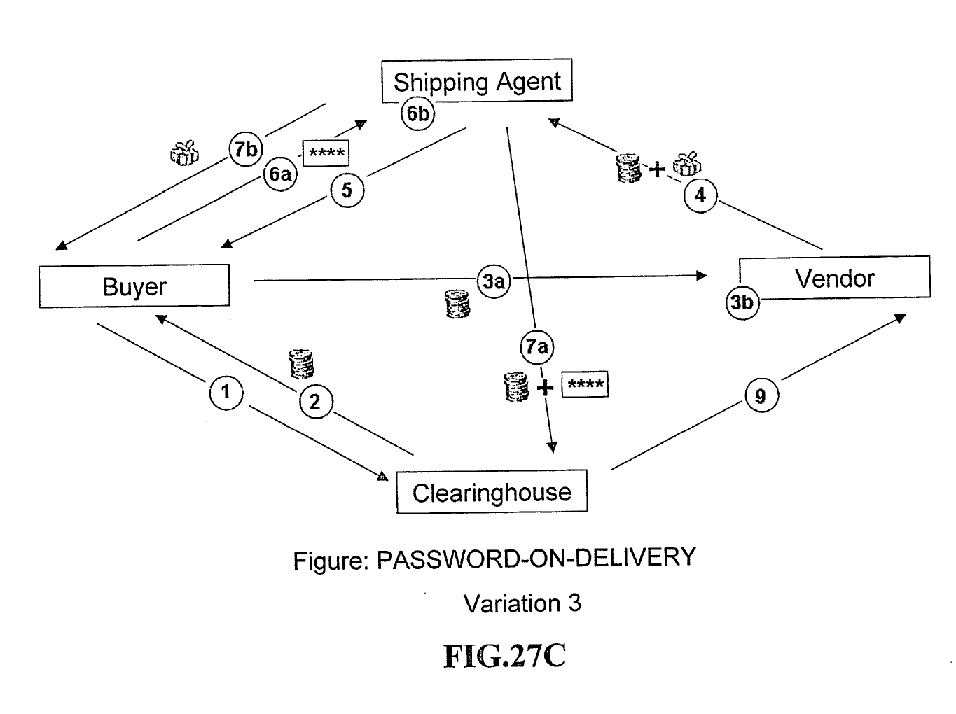

FIG. 27A illustrates a use case of a complete transaction between a vendor and a buyer who wishes to purchase an item from him:
1. Buyer contacts the digital cash Clearinghouse and requests a digital cash bundle of the amount required to purchase the item, assigned to the Vendor, with expiration set to the time expected for the vendor to ship the item, non-cancelable, and protected with a password.
2. Digital Cash Clearinghouse manufactures the required digital cash bundle and sends it to the Buyer. The Buyer electronic wallet is debited by the amount.
3a. Buyer orders the item from the Vendor and sends the digital cash bundle as a digital cash payment-on-delivery.
3b. The Vendor verifies that the cash bundle is for the correct amount, is assigned to him, is non-cancelable, and allows for sufficient time to ship the item.
4. The Vendor hands the item and a copy of the digital cash bundle to the Shipping Agent.
5. The Shipping Agent contacts the buyer and requests the password.
6a. The Buyer provides the password to the Shipping Agent.
6b. The Shipping Agent verifies the password.
7a. The Shipping Agent provides the password to the Vendor.
7b. The Shipping Agent releases the item to the Buyer
8. The Vendor presents the digital cash bundle to the Clearinghouse
9. The Clearinghouse credits the electronic wallet of the Vendor.
   Note on steps 1, 2, 8 and 9: in some embodiments of the invention, creating and redeeming digital cash stamps in some cases can be done by the Buyer or Vendor without communicating with the Clearinghouse.
   Note on steps 3b and 6b: in some embodiments of the invention, these steps can be performed on the local machine and offline. In other implementations, steps 3b and 6b cannot be performed on the local machine and require communication with the Clearinghouse.

FIG. 27B shows an alternate embodiment of the invention described above, where the Vendor does not need to provide the digital cash bundle itself. This figure is equivalent to FIG. 27A except:
In Step 1, the Buyer does not need to assign the cash bundle to the Vendor
In Step 6a, the Vendor does not provide the digital cash bundle to the Shipping Agent. Instead, he provides a portion of the cash bundle intended only for verification of the password.

FIG. 27C shows an alternate embodiment of the invention described above, where the implementation of the system allows a 3^{rd} party (the Shipping Agent in this case) to redeem a cash bundle assigned to another party, on his behalf. In this case, the Vendor provides the digital cash bundle he has received from the Buyer, but when the Shipping Agent receives the password from the Buyer, the Shipping Agent does not need to send the password to the Vendor, instead the Shipping Agent can cause the Vendor's electronic wallet to be credited directly. This figure is equivalent to FIG. 27A except:
Step 6b (verifying the password provided by the Buyer): if the portable computing device used by the Shipping Agent is online with access to the Internet, step 6a is not required as the password will be verified as part of step 7a, when the Shipping Agent attempts to credit the Vendor for the cash bundle.
In Step 7a: instead of sending the password to the Vendor, the Shipping Agent redeems the bundle on behalf of the Vendor himself, using the password provided by the Buyer. If the password provided by the Buyer is correct, the Shipping Agent releases the item in the hands of the Buyer. Note that in some implementations, steps 5, 6a, 6b and 7a may be combined into a single operations where the Buyer is simply presented with the portable electronic device used by the Shipping Agent, where the local electronic wallet asks the Buyer to enter the password to unlock the digital cash bundle which the Vendor supplied to the Shipping Agent (the very same digital cash bundle prepared by the Buyer in the first place). One of the advantages of this variation of the method is the fact that the Shipping Agent or the Vendor never need to see the password, which the Buyer can enter in confidentiality on the portable computing device used by the Shipping Agent. When the Shipping Agent gets confirmation from the electronic wallet that the Clearinghouse has successfully redeemed the cash bundle (to the Vendor's credit), the Shipping Agent can release the item in the hands of the Buyer. Note that step 7a may occur after step 7b (delivery of the item to the Buyer) in case the computing device used by the Shipping Agent is not online at the time of delivery. In this case, step 6b is maintained (validating that the password is correct, which can be done offline).
Step 8 is eliminated (the redeeming is performed directly by the Shipping Agent)
Step 9: behaves essentially like FIG. 27A, the Vendor gets credited for the value of the cash bundle, but the difference could be the method by which the Vendor will be notified of this event (credit now triggered by the Shipping Agent, not the Vendor)

The password-on-delivery method will now be described from the point of view of the shipping agent. Thus, according to some embodiments, a method for facilitating the transaction is provided, where the method includes the steps:
a) receiving an indication that the item has been sent from the vendor for delivery to the buyer (for example, receiving the actual item, as in step 4 of FIGS. 27A-C);
b) receiving (for example, from a buyer, for example, at a time of delivery, as in step 6A of FIGS. 27A-C) a key (for example, a password) for redeeming the digital cash payment]; and
c) in accordance with a successful validation of the key (for example, authorizing using a portable computational device) authorizing the providing of the item to the buyer (as in step 7B of FIGS. 27A-27B).

In some embodiments, this method of facilitating further includes, authorizing the sending of the key to the vendor in accordance with the successful validation of the key (for example, step 7A).

Alternatively or additionally, when the key is successfully validated, the shipping agent may authorize a crediting of an account of said vendor with an amount derived from a value of said digital cash payment (i.e. the amount of payment for the item).

Digital Cash Bundles with Digital Cash Management Application Auto-Install

It is noted that certain implementations of various features for visualizing and managing visual cash employ a digital cash management application, which is typically installed oil the Host device and registered with the Host operating system. In many situations, users may be reluctant to procure a non-volatile media (for example, a CD ROM) and install the digital cash management application, and may be reluctant to visit a Web site in order to download this software.

Thus, in certain embodiments of the present invention, it may be possible to induce the user to install the application by allowing the user to first download a given digital cash bundle to his or her Host device, where the digital cash bundle is associated with installation code to install the digital cash management application. It is postulated that there are many situations where a user would be more amenable to first copying a digital cash bundle to his Host device, and then, having experienced digital cash to a certain extent, installing the application.

It is noted that methods, systems and computer readable code for installing software for managing and/or visualizing digital cash may facilitate the penetration of digital cash technology in the marketplace.

Thus, it is noted that in some embodiments, digital cash payments or bundles are provided as files, and it is possible to associate with a digital cash bundle file code for installing or upgrading an installation of the digital cash management application. Thus, according to some embodiments, each file will include at least two elements:
1. The first element is an installation package for a digital cash management application or a reference (e.g. an Internet location) to an installation package for a digital cash management application.
2. The second element is the digital sequence representing the digital cash itself.

The two elements may be composed in such a format that the operating system will automatically run, or download and then run, the digital cash management application. This can be achieved in several manners.

One embodiment is to include (i.e. embed) the digital cash management application and its installation program within the digital cash bundle file itself, A variation of that embodiment is to include only a diminutive version of the digital cash management application that provides only a limited set of functionality available immediately to the user while it fetches the full version of the application from an Internet location. On Microsoft Windows, such an embodiment could be in the form of a MSI (Microsoft Windows Installer File) package, with the digital cash bundle sequence embedded within the package as an installation parameter.

Another embodiment is to associate with the digital cash bundle a reference to an Internet location (URL) where the installation instructions for a digital cash management application can be found, with the digital cash sequence embedded in the URL itself as a parameter. This does not require that a particular version of the digital cash management application be installed—instead, it only includes an Internet shortcut to such an application, which allows updating the application on the server without needing to change the digital cash bundles in circulation. One possible implementation of this embodiment is using installation package formats that support specifying an Internet location pointing to the installation package. For example, the aforementioned Microsoft MSI format allows specifying an Internet location (URL) as part of the MSI package. Another possible implementation is to use the format used by the operating system to represents Internet shortcuts, such as the files with a .URL extension under Microsoft Windows. Using that implementation, when the user opens the digital cash bundle, it is treated as a URL by the host computer, which launches the installation of a digital cash management application, with the digital cash sequence passed to that installation package as a parameter. As soon as the digital cash management application is installed, its first action will be to process the digital cash bundle, as instructed by the sequence passed as a parameter.

It is noted that on a computer where a digital cash management application is already installed, it is possible for this application to register itself to handle Internet shortcut files. By doing so, when prompted by the operating system to process an Internet shortcut, the application may recognize that this shortcut represents a digital cash bundle. Thus, the installed application may ignore the URL portion of the file and only consider the digital cash sequence. On that basis, the digital cash management application will be able to handle the digital cash bundle just as we have described throughout the present disclosure, with the appropriate icons and behavior corresponding to the attributes of the digital cash bundle.

According to one example related to Microsoft Windows, an embodiment of the invention choosing to adopt the URL format could represent a digital cash file as the following text file with a .URL extension:

[InternetShortcut]
URL=http://www.verdicash.com/DigitalCashInstall.exe?Bundle=M*7jHnn%4$L:Fakj˜″9)jjbzdwuihpˆ55kjkdfjo-098uyxflfhrui((8&O
WorkingDirectory=C:\WINDOWS\
ShowCommand=7
IconIndex=0
IconFile=C:\WINDOWS\SYSTEM32\url.dll
Modified=20F06BA06D07BD014D
HotKey=1601

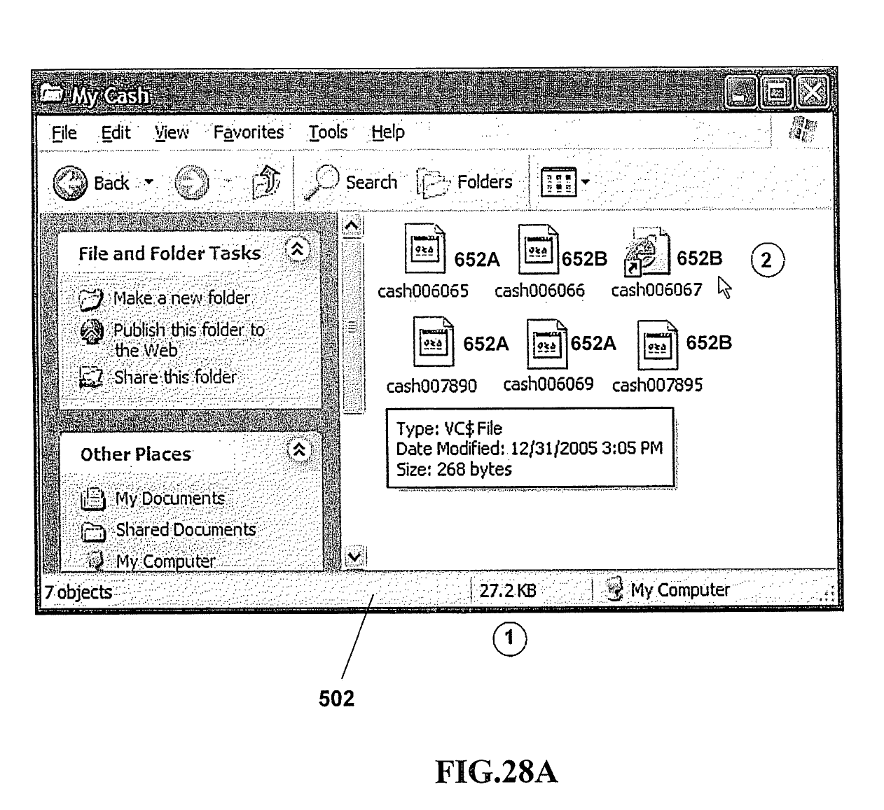

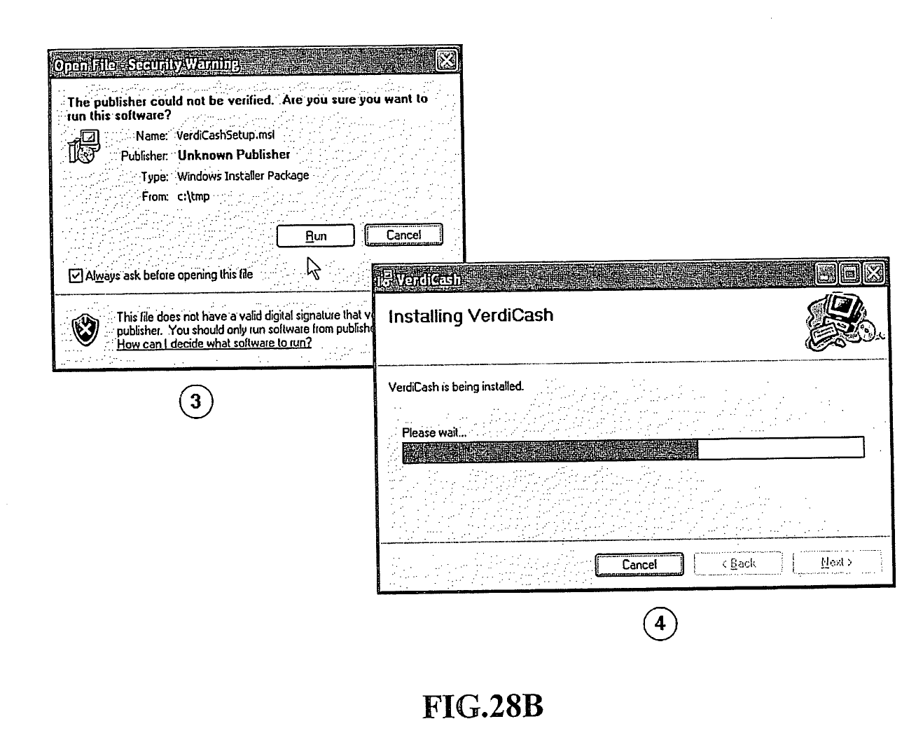

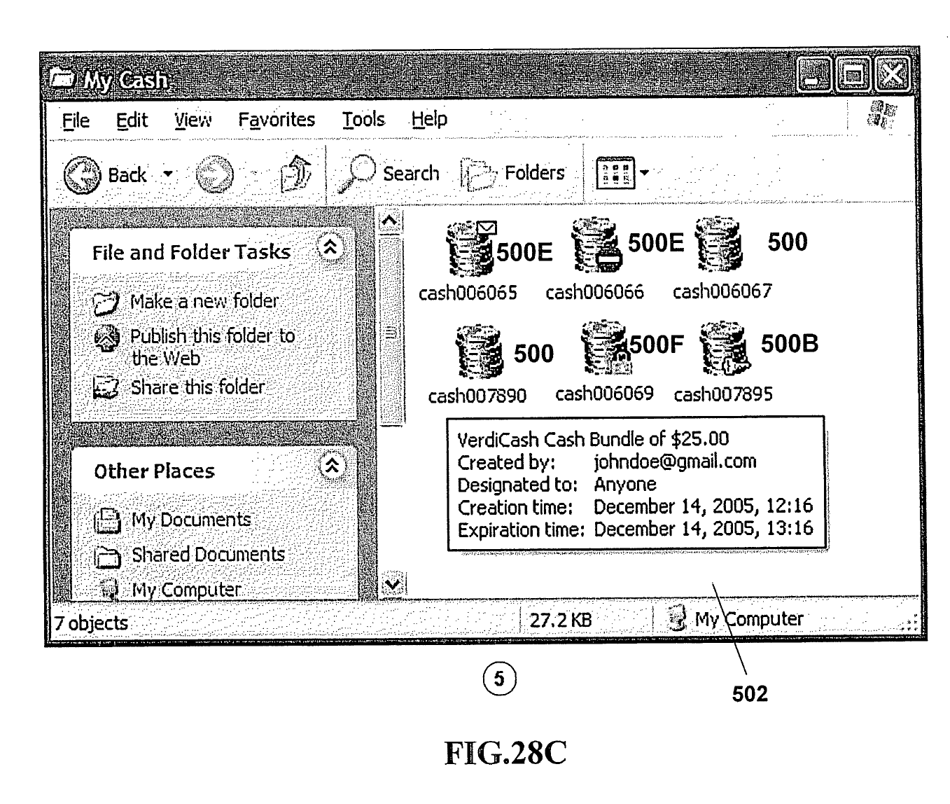

FIGS. 28A-28C presents an exemplary user scenario illustrating the effect of a user engagement with a digital cash bundle that includes installation instructions, using an embodiment with the .URL format:
Step 1 (FIG. 28A): a user has received a number of digital cash bundle files. The user's host device does not have an installed digital cash management application. The files 652 are shown by the operating system as files 652A of unknown type (except for the file 652B shown in the upper-right corner of the folder—see Step 2), and do not have the special behavior provided by a digital cash management application
Step 2 (FIG. 28A): one 652B of the six digital cash bundles 652 is different from the other digital cash bundles in that it includes instructions to install a digital cash management application. The example is given on Microsoft Windows, and using an embodiment where the auto-install combined digital cash bundle format is implemented as a .URL file. This combined digital cash bundle file is shown in the upper-right corner of the folder, and is shown by Windows as an Internet shortcut. The user engages that icon (for example, by double clicking the icon).
Step 3 (FIG. 28B): the launch of the installation package is initiated and Windows prompts the user for his authorization.
Step 4 (FIG. 28B): the user authorizes the installation, and the installation program installs a digital cash management application
Step 5 (FIG. 28C): digital cash bundle files 500 are now displayed with all the richness of visualization and associated functionality provided by the digital cash management application. Note that installing the digital cash management application affects all digital cash bundles on the machine and not just the combined digital cash bundle that included the installation instructions.

It is noted that the digital cash bundle files represented by icons 652 (and in particular, 652A) may be thought of as “inert” files, with reduced or no particular defined behavior and/or dynamic representation. In the example of FIG. 28, these “inert” files are files of unknown file extensions. Thus, it is noted that embodiments where the digital cash bundles (for example, bundles 500) exhibit “rich” behavior have been presented throughout this disclosure, the present invention does not relate only to such digital cash bundles (i.e. rich digital cash bundles). Many embodiments of the present invention relating to manipulating “inert” digital cash bundles are also contemplated, and in some embodiments, the digital cash management application is operative to handle these inert bundles. In some embodiments, these “inertly visualized bundles” may exhibit dynamic behavior (for example, behavior supported by or implemented by the digital cash management application) in aspects other than visualization.

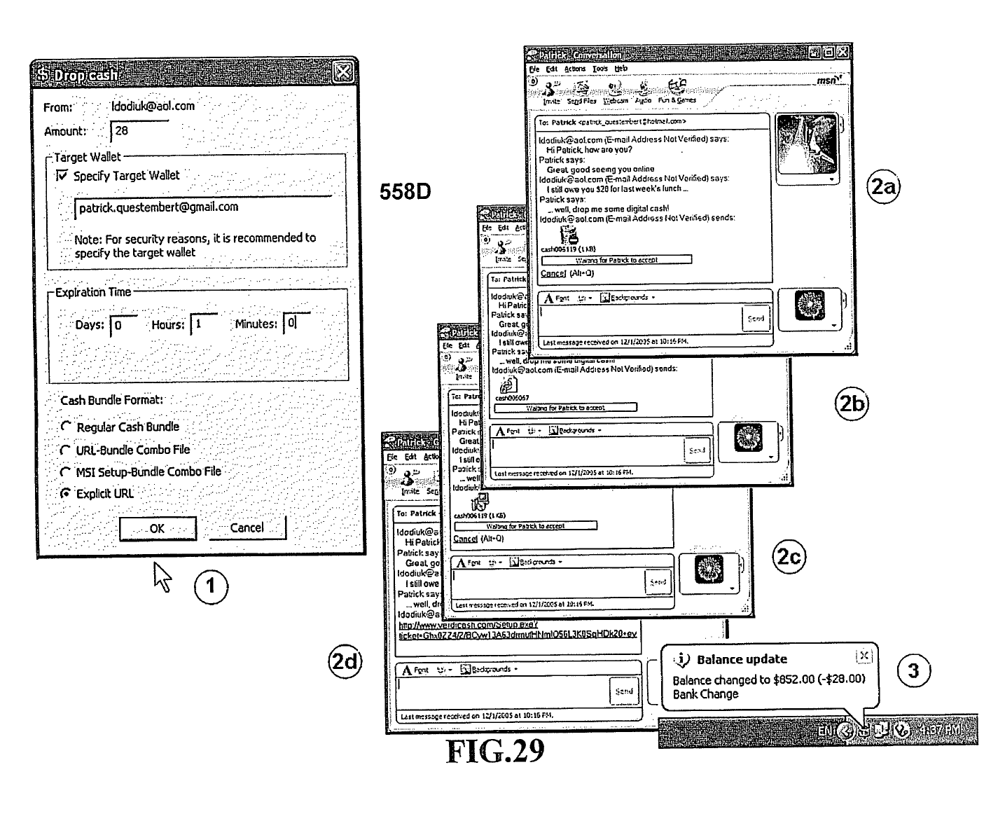

FIG. 29 shows other possible formats to provide digital cash bundles to users who have never received digital cash bundles in the past. The figure describes a use scenario where a user drags- and-drops cash into an MSN conversation with another user, and is presented with four different formats for generating the resulting digital cash bundle:
Step 1: The digital cash electronic wallet application prompts the user for the details of the resulting digital cash bundle she wishes to create (using dialog 558D), in this case with a value of $28, assigned to patrick.questembert@gmail.com and expiring in one hour. Note the additional options at the bottom of the dialog, whose meaning we will detail in the description of step 2 below.
Step 2: The digital cash electronic wallet application creates a digital cash bundle in the format chosen by the user in step 1, as follows:
   2a: This is the default format, a digital cash bundle file. This choice would be suitable if the recipient user can be assumed to have a digital cash management application installed on his system, that will allow him to properly visualize the incoming digital cash bundle and manipulate it.
   2b: This is a special format already shown in FIG. 28 whereby the digital cash bundle is combined with a reference to the network (e.g. Internet) location from where a digital cash management application can be installed. It is one of the formats available for cases where the user assumes that the recipient does not have a digital cash application installed
   2c: This is a special format whereby the digital, cash bundle is combined with the digital cash management application installation code itself (or part thereof). It is one of the formats available for cases where the user assumes that the recipient does not have a digital cash application installed. When the recipient opens that file, the digital cash management application is installed (possibly by way of downloading a part of the installation program from a network location).
   2d: This is a special format whereby what is passed to the recipient is a URL explicitly formed to invoke the installation application for a digital cash management application from a network (e.g Internet) location. As part of that URL, the digital cash sequence corresponding to the digital cash just created is specified. Of the four formats shown on this slide, this is the only format that is not a computer file, but the results are the same as the preceding two formats described above: when the recipient clicks on that URL, the digital cash management application will be installed and will form a digital cash bundle corresponding to the specified sequence (or simply redeem that digital cash payment). Note that the URL specified would typically be the same as the one embedded in the combined .URL file of 2b above. The difference between this method and 2b is that in the present case, not special file is created and instead the network location for the installation is given explicitly (along with the digital cash ticket details as a parameter).
Step 3: regardless of the format chosen to send the digital cash payment to the recipient, the user's electronic wallet is charged by the value of the digital cash payment.

Embodiments of the invention that choose not to implement auto-install digital cash bundle files may assist users in locating an installation package for the digital cash management application on the Internet. Modern operating systems and Internet browsers offer several mechanisms. Under Windows, the first place Windows searches when encountering a new file type is http://shell.windows.com, for example
http://shell.windows.com/fileassoc/0409/xml/redir.asp?Ext=vc$
   If no information is found there, users are referred to http://cknow.com (equivalent to http://filext.com). The authors of the digital cash management application can submit information to that site on where to find the installation package for the application.

At this point, exemplary embodiments relating to how digital cash bundles may be used to interact with Internet web sites offering goods and services will be described.

Web Page Elements Accepting Digital Cash Bundles:

Embodiments of the invention relating to the topic of commerce on the Internet will now be described. At the time of writing of this disclosure, utilizing an electronic payment system usually involves specialized code embedded within web pages that supports only a specific method of payment and interacts with a specific application.

It is now disclosed for the first time that digital cash bundles 500 may be used for payment on the Internet. In particular, it is now disclosed that on the client machine, a browser window 660 may be designated as a drop target, and a user dragging-and-dropping of the digital cash bundle into the targeted browser may be operative to transfer a payment associated with the digital cash bundle to a web site associated with a page displayed in the browser.

According to some embodiments, specific embeddable web components are provided which are operative to receive the digital cash payment. When embedded in a web page displayed in the browser window on the client machine, these web components may be operative to provide functionality associated with at least one of: receiving and/or accepting a digital cash bundle (i.e., a digital cash bundle file), verifying the validity of the payment, sending a digital cash bundle to the vendor, crediting a digital cash account of the vendor, and communicating receipt of the payment to the vendor.

In some embodiments, after receiving the payment, certain actions indicating an awareness that the payment was received may be performed, such as displaying a link to digital content just purchased, or notifying the user that an item has been shipped to him. These “post-payment” operations may be carried out by the embedded components and/or another component in accordance with a reporting of payment by the embedded component.

According to some embodiments, this aforementioned web component implements the same interfaces as any other element that acts like a drop target, such as a file folder.

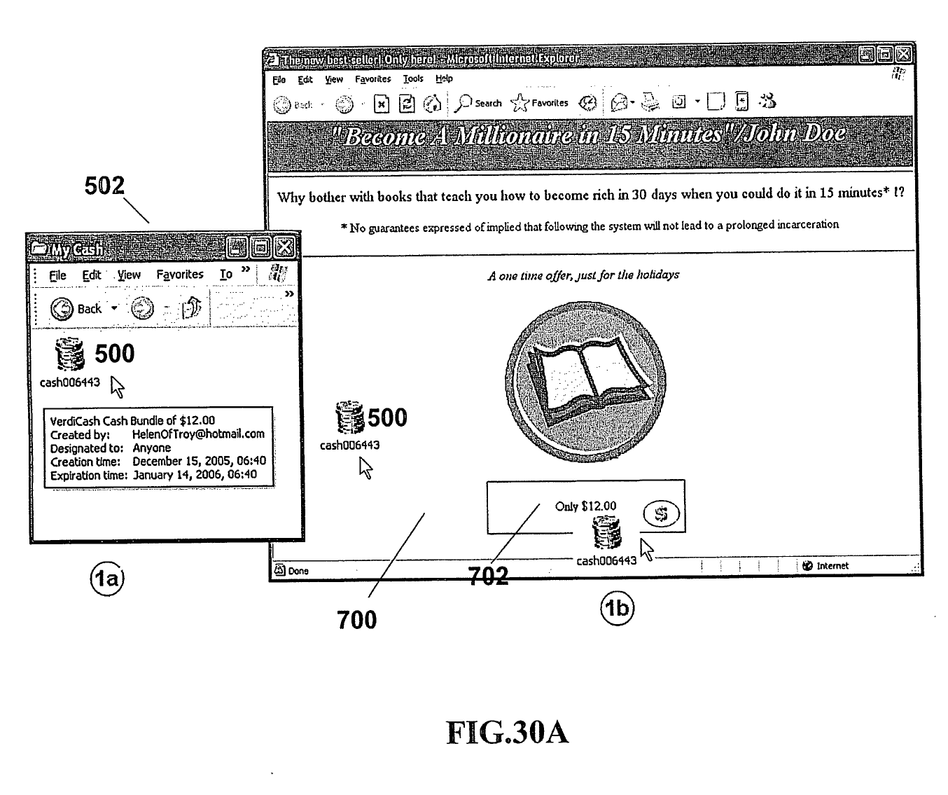

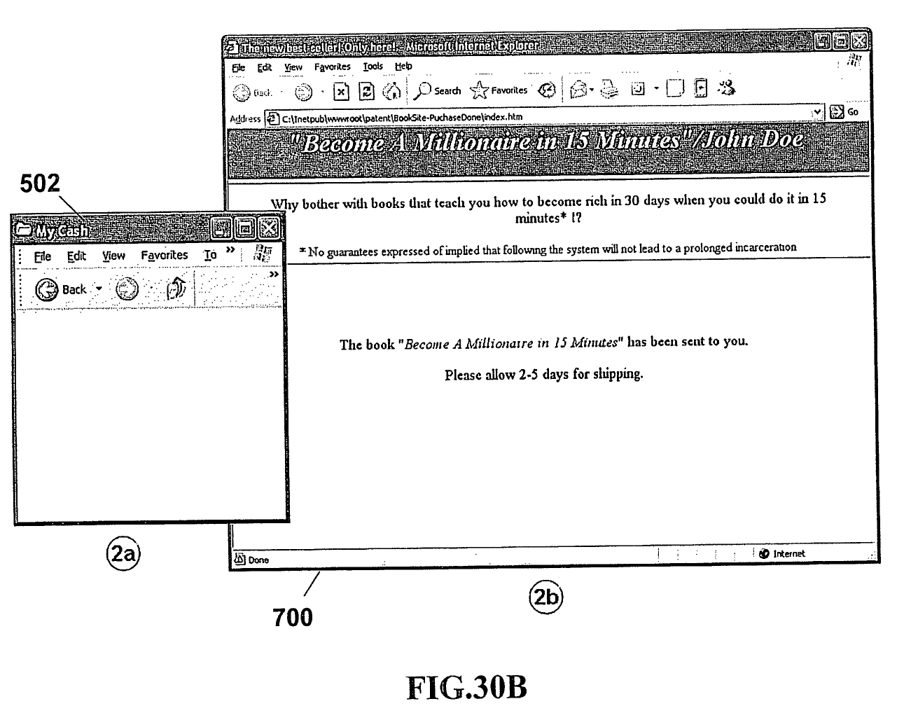

FIGS. 30A-30B describes an exemplary use case. In order to purchase a book entitled “Become a Millionaire in 15 minutes”, the user (step 1) drags-and-drops digital cash bundle 500 from folder 502 into browser window 700, to a designated region 702 associated with the item to be purchased. The web component embedded within the web page is operative to detect the designation of region 702 as a drop target of the digital cash bundle 500, and receives the payment.

After payment is received, an indication that payment has been received is provided to the user (step 2B, FIG. 30B). In the example of FIG. 30B, this indication is a textual indication “The book Become A Millionaire in 15 Minutes has been sent to you. Please allow 2-5 days for shipping.”

There are many ways to implement a drop target component inside a web page. Exemplary components that may be used include but are not limited to JavaScript components, Java Applets, ActiveX controls, and browser Plug-Ins. Regardless of the method chosen, the user typically may see a graphical element on the web page onto which digital cash bundles may be dropped.

Furthermore, in exemplary embodiments, the embedded web component(s) provide the user the flexibility to drop several digital cash bundles, one at a time. In particular embodiments, when the use drops a plurality of digital cash bundles into the web browser frame drop target, this is operative to transfer digital cash whose value equals the total of the individual values of the digital cash bundles.

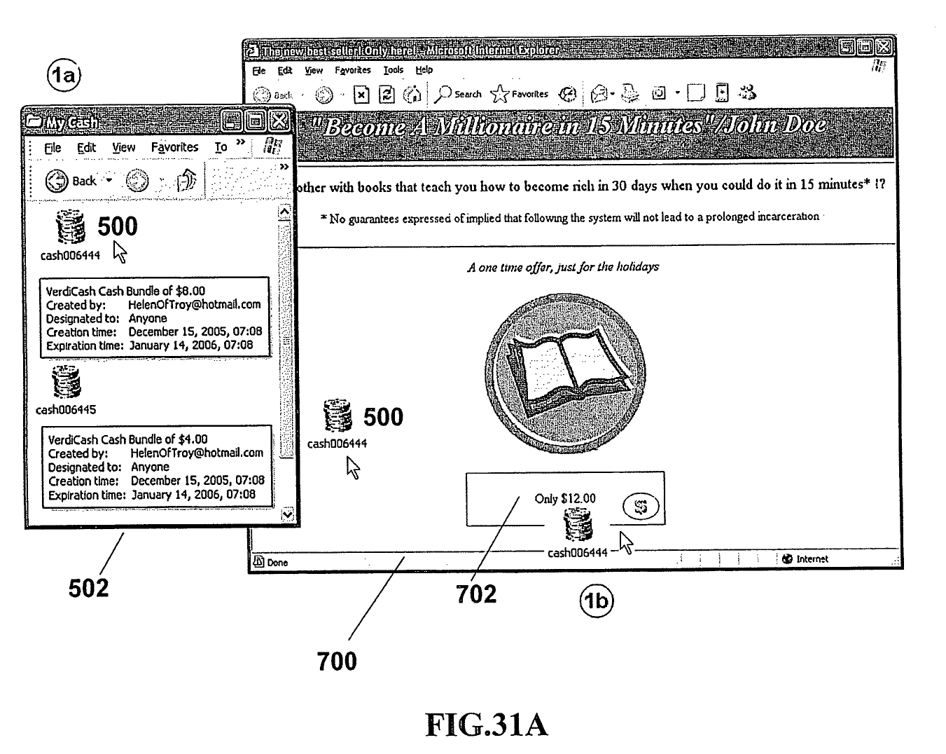

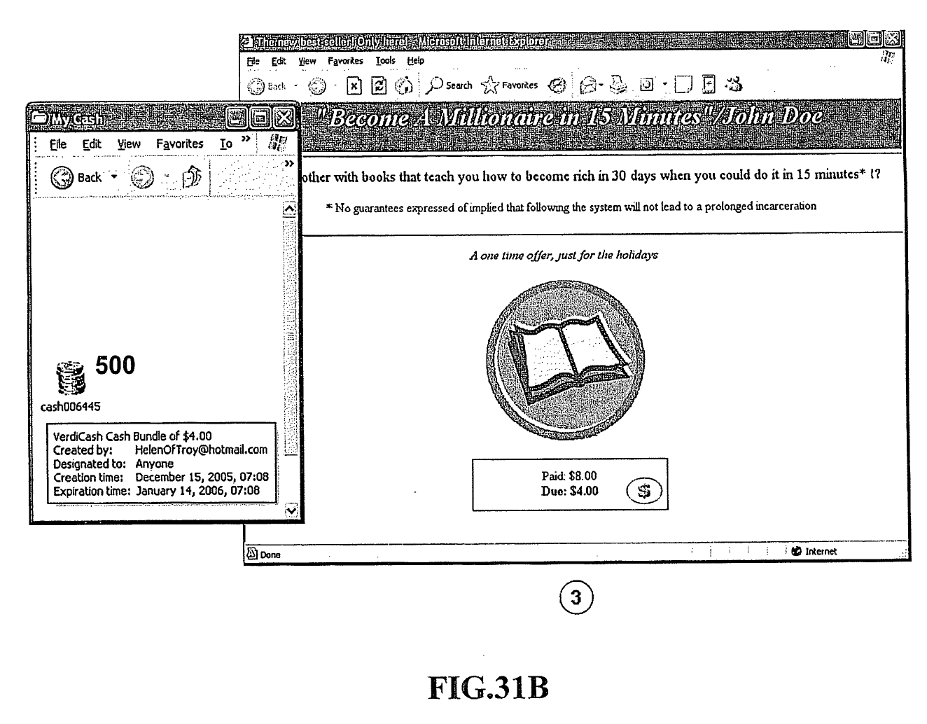

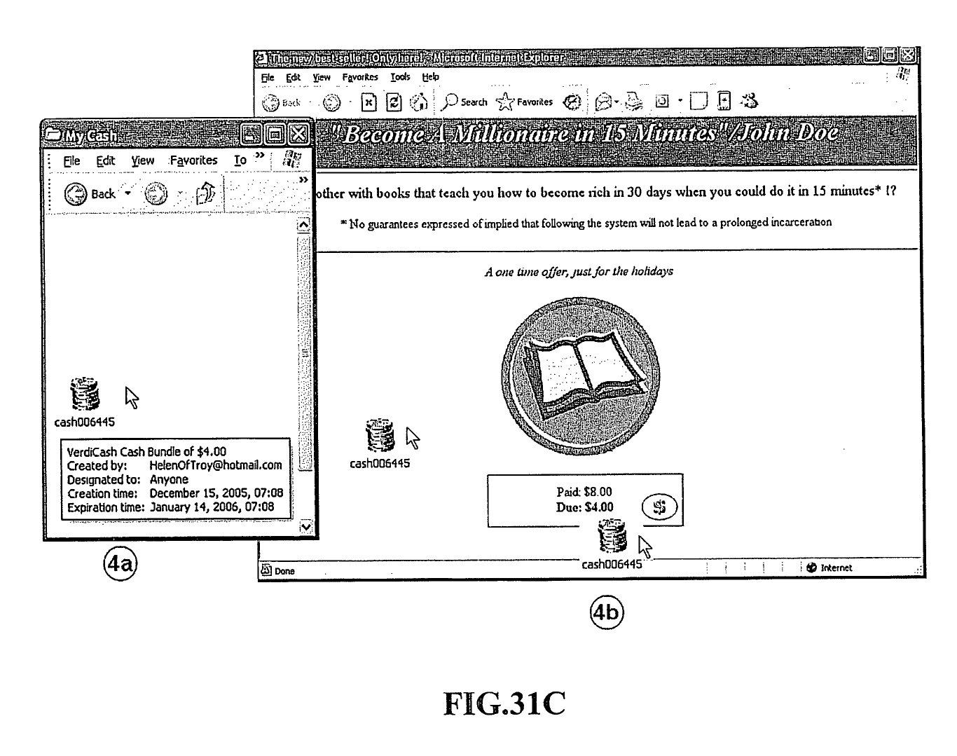

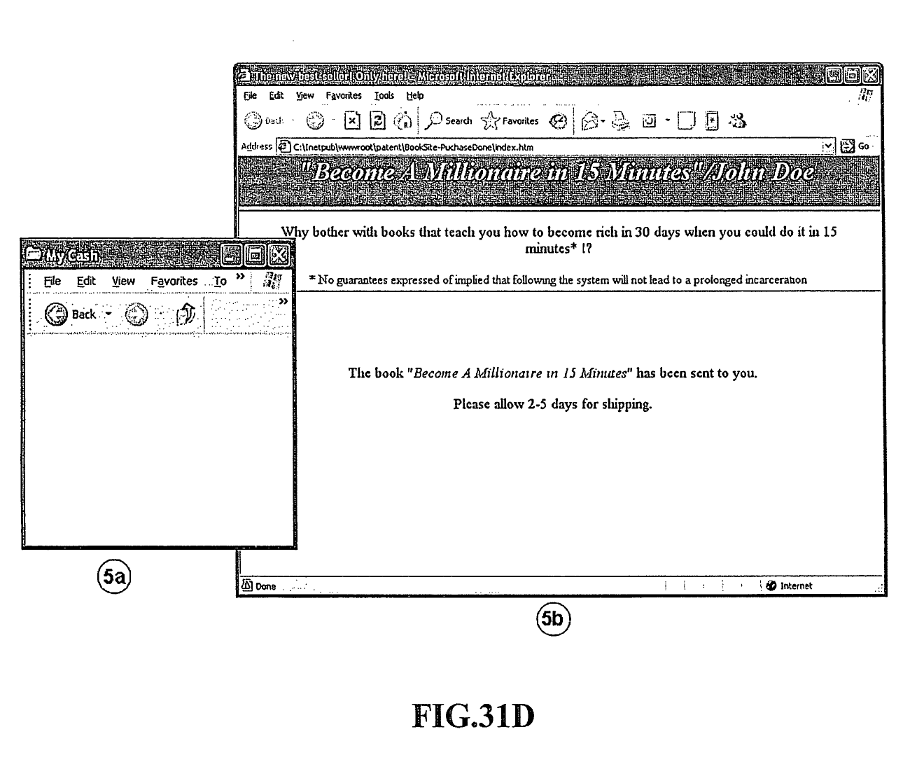

FIG. 31A illustrates a user scenario wherein a plurality of cash bundles 500 are dragged-and-dropped from a folder onto the designed region 702 of the browser window .700. In particular, a first bundle (cash006444) worth $8 and a second bundle (cash006445) worth $4 are transferred to the web site.

It is noted that the cost of the book is $12.

In this example, step 1b is a snapshot of the situation right before any cash bundles are dropped in the designated area to effect payment. Thus, at that time (i.e. in FIG. 31A), region 702 still indicates that $12 are due. In FIG. 31B, the first digital cash bundle has already been received by the web component, and thus, in region 702 there is an indication that $8 has been paid and $4 is due. The user may then pay for the balance (i.e. $4) using the second cash bundle (cash006445).

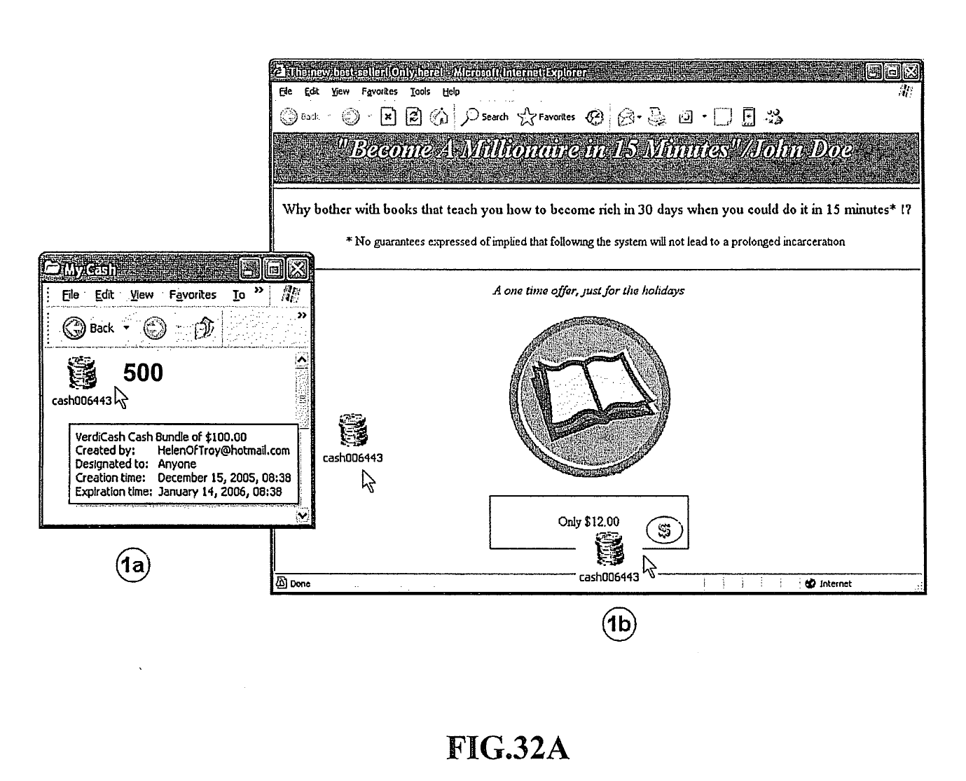

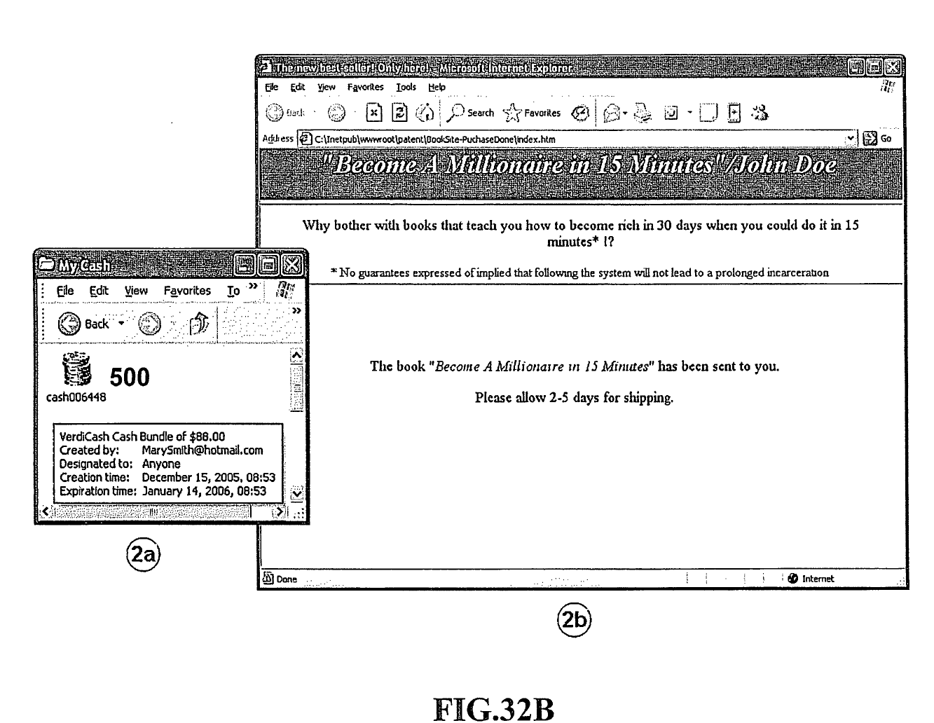

In some embodiments, if the total amount of cash transferred exceeds the purchase price of an item offered for sale, digital cash “change” may be provided to the user, for example, in the form of a digital cash bundle. A user scenario of describing this is illustrated in FIGS. 32A-32B, where a bundle having a value of $100 is used to pay for an item (i.e. the book) having a price of $12. A “change” digital cash bundle is provided to the client machine, and as seen in FIG. 30B, this change digital cash bundle has a value of $88.

In the description provided below, the following terms are employed:
The “Vendor” is an Internet merchant offering items for sale
The “Vendor web site” is one or more web pages showing such items and their prices
The “Vendor web server” is one or more servers on the Internet responsible for processing payments received by customers and shipping items to them.
The “User” is a customer who wishes to purchase items from the Vendor.

As stated earlier, the web component for handling digital cash may be implemented using a number of technologies. Some exemplary implementations are described below. The description of these implementations are not intended as limiting.

Microsoft® ActiveX® Controls

Microsoft® ActiveX® controls, formerly known as Object Linking and Embedding (OLE) controls or OCX controls, are components (or objects) that can be embedded into a web page or an application to reuse packaged functionality someone else has programmed. For example, the ActiveX controls that are included with Microsoft Internet Explorer version 3.0 or higher allow you to enhance your web pages with sophisticated formatting features and animation.

A key advantage of ActiveX controls over Java applets and Netscape plug-ins is that ActiveX controls can also be used in applications written in many programming languages, including all of the Microsoft programming and database languages.

Adding ActiveX controls to a web page is done with the standard HTML <OBJECT>tag. The <OBJECT>tag includes a set of parameters that specify which data the control should use and control the appearance and behavior of the control.

To expose a method of payment that accepts cash bundles, a Vendor can include on his web site an ActiveX control that is a drop target and accepts files for every purchasable item. To indicate that fact to the User, this ActiveX control should make itself visible on the web site in a manner that indicates to the User that it accepts digital cash bundles, typically by displaying a logo similar to the icons used by popular digital cash management applications. When a digital cash bundle is dropped onto the control, the ActiveX control may send the necessary portion of the content of the cash bundle to the Vendor's web server. The Vendor's web server verifies the validity, amount and other attributes of the cash bundle, and if the Vendor determines that the purchase can be completed based on the payment provided, the Vendor redeems the digital cash bundle(s) and performs whatever action is required to complete the purchase. In the case of purchases of digital content, such as music or video files, or downloadable software applications, the result of completing the purchase could be displaying to the User the URL of the item he just purchased. In other cases, when physical goods need to be shipped, the Vendor may display a page confirming the item is being shipped to the User.

Such ActiveX controls are expected to be provided by the companies implement the digital cash management application, and are registered on the local machine by the digital cash management application, with a GUID identifying the control (as required from every ActiveX control. An example for a GUID: 9F971049-67BB4BAD-89EB-4D36A43A5662).

A way to embed the ActiveX control inside a Web site is with the OBJECT HTML tag, followed by some PARAM tags that identify and provide more information about the purchase itself such as the item purchase price, or action to take on purchase. For example:

<object classid=“clsid: 9F971049-67BB-4BAD-89EB-4D36A43A5662”
height=“48”
width=“64” align=“left”>

<param name=“ticket”
value=“E!@TFu8fFSD#45jvn23bLKgr45GERG”/>
<param name=“item” value=“Chair234”/>
<param name=“onpurchase” value=“/images/image.jpg”/>

</object>

The “classid” attribute defines the specific ActiveX control using its GUID. The “height”, “width” and “align” attributes specifies the size and location of the control. The “ticket” parameter may specify the Vendor's account, and the purchase price of the item. The “item” identifies the item to be purchased, and the “onpurchase” parameter may specify the action to be taken after purchase is done.
When displayed inside a Web browser, it may show a relatively small icon (64×48 pixels), presenting the logo, and the purchase price. When the user drops a cash bundle with the required value, the ActiveX sends to the Vendor web server the bundle content along with information identifying the item. The Vendor web server looks up the item in its database to validate the cash bundle value against the specified item purchase price. If a match is made, the Vendor web server redeems the bundle, and sends back to the user a notification about the successful transaction.

In order for the ActiveX control to act as a drop target, the control should register itself as an OLE drop target using the RegisterDragDrop function (exported from OLE32.DLL), and provide a IDropTarget COM interface implementation (described previously).

When the control receives the cash bundle, it can send the content of the cash bundle and the specification of the item to purchase to the Vendor web server in a single operation using a URL containing a “query string” that includes the information. URL query strings are commonly used to send information to web sites. URL may look like:
http://www.we-sell-all.com/purchase.php?bundle=vbS3GF5gxazzd76&item=Chair234
The first part of the URL (http://www.we-sell-all.com/purchase.php) defines the CGI program to run on the Vendor web server. The second part includes all information needed to make the purchase (?bundle=vbS3GF5gxazzd76&item=Chair234). The CGI program purchase.php receives the query string, processes the transaction, and the result is returned and displayed as an HTML page to the User.

According to some variations, the case where a user drops a cash bundle with a value exceeding the item purchase price is handled. Two exemplary methods for handling this situation are now described.

The first method is to let the ActiveX control send the cash bundle to the vendor's web server, and leave it to the vendor to compensate the user for the difference between the value of the bundle and the item purchase price by including as part of the successful completion of the purchase the presentation of a new cash bundle created by the vendor and presented to the user within the browser. The user can then download the cash bundle offered and redeem it.

According to the approach of a second method, the ActiveX control will split the cash bundle into two separate bundles. One is created with a value set to the purchase price of the item and is sent to the Vendor's web server for the purchase. The second cash bundle with a value set to the difference between the original value of the cash bundle and the purchase price is created to replace the original source bundle used by the User. Another extension to this invention is to use not just one bundle file, but a number of smaller cash bundle files until the total amount has been provided by the aggregate value of the digital cash bundles. The ActiveX control may update its display to indicate the remaining amount for the payment, and wait till the total value meets the required purchase price and the User confirms the purchase. In some embodiments, the ActiveX control may implement a data structure within the component that adds dropped cash bundles one by one, and keeps track of the total aggregate amount, but combines them to one bundle only when the total amount is reached (and possibly returns change for the fraction of the last cash bundle). The combined bundle will be sent to the vendor's server as described earlier. Alternatively, the ActiveX control may send each digital cash bundle to the web server of the vendor, which could keep track of them but would not redeem them until the user has confirmed the purchase.

Browser Plug-In: a browser plug-in can be used instead of an ActiveX control. Plug-ins are extensions to the browser functionality. A plug-in may be used to simplify the vendors' web site HTML code. Instead of using the OBJECT and PARAM HTML tags, regular tags such as IMG (used to display images) or A (primarily used as a hypertext link) tags may be used with additional attributes. For example, a simple regular IMG tag may look like: <img src=“image.jpg”> and an extended tag may look like:
<img src=“image.jpg” ticket=“E!@TFu8fFSD#45jvn23bLKgr45GERG” item=“Chair234”>

The plug-in may replace or hook the normal drop target behavior of the browser. When the plug-in detects a drag operation, it will delegate the operation to the browser as long as the drop target is a regular control. When the plug-in detects that the drop target is a special control as described previously (a regular HTML tag with extended attributes), it won't delegate the drag operation to the browser, but handle it by itself The same payment algorithm should be used as used by the ActiveX control.

JavaScript: an alternate method uses JavaScript. The advantages of JavaScript over Java are that JavaScript is simplified, it does not have to be compiled, and the source code resides within your HTML document (or within an external document).

In order for a JavaScript embodiment to implement a drop target, support is required from the Internet browser to notify the JavaScript code when the user interacts with web page elements with which the JavaScript is associated.

In some embodiments, the JavaScript drag and drop ability may not allow dropping of files. Rather, text or URLs may be dropped. “Currently, for data security reasons, Internet Explorer prevents any drop target in the browser from accessing data that originates in another security domain or in another desktop application” (see http://msdn.microsoft.com/workshop/author/datatransfer/overview.asp)

Supporting dropping files in text format can be done by adding a “DataHandler” shell extension handler, as described earlier in the context of drag and drop in text format in general.

To help vendors use digital cash bundles with the digital cash JavaScript extension within their web site, an embodiment of the digital cash management application is disclosed wherein vendors are provided with a JavaScript file that includes all the needed functionality. A vendor who wishes to include such a JavaScript package on his web page would add the following HTML tag to that page:

<script language=“javascript” src=“www.verdicash.com/cash.js”></script>

The use of this JavaScript package to add the drag-and-drop functionality is similar to the plug-in usage, with a small addition:

<img src=“image.jpg” ticket=“E!@TFu8fFSD#45jvn23bLKgr45GERG”
item=“Chair234” onload=“cash_init_buy(this)”>

The attribute “onload” must be added with the specified value so the JavaScript package will be able to handle this image as a drop target.

The “onload” attribute specifies the function to run after the object has been loaded. It is used to initialize the drag and drop handlers of the specific object. The following function comes as a part of the JavaScript package:

function cash_init_buy (img)
{

img.ondragenter = cash_cancel_default;
img.ondragover = cash_cancel_default;
img.ondrop = function( ) {cash_buy(img);};

}

When the User drops a bundle file into the image, the “cash_buy” function will be called. “cash buy” will handle the bundles as they are dropped to the image.

Java Applet: an embodiment using a Java applet may have the same security restrictions as the JavaScript, except that the Java applets work on every popular browser at the time of the writing of this disclosure. Java Applet drag-and-drop is designed to be used also with dropped files, with could yield richer functionality, offset by security restrictions at the time of writing of this disclosure that disallow Java Applets to read the files' content. So the same technique as described in the JavaScript embodiment is suggested. That is to use the shell's “DataHandler” to add a text format to the drag and drop of bundle files.

Adding the Java Applet into the HTML code can be done using the following:

<applet code=www.verdicash.com/DigitalCashBuy.class width=“64”
height=“48”>

<param name=“ticket”
value=“E!@TFu8fFSD#45jvn23bLKgr45GERG”/>
<param name =“item” value=“Chair234”/>
<param name=“onpurchase” value=“/images/image.jpg”/>

</applet>

As the ActiveX control embodiment, parameters are transferred using the PARAM tag. The Java Applet may reside in an external location such as:
http://www.verdicash.com/DigitalCashBuy.class

Implementation of the Java Applet is based on the java.awt.dnd library. First a drop target should be declared by implementing a DropTargetListener and creating a DropTarget object. The DropTargetListener will receive notifications about the drag operation. The dropped data can be queried by implementing the “drop” method.

The JavaScript and Java Applet embodiments may not be able to return change to the User by splitting the original cash bundle (as described for the ActiveX solution above), because of security restrictions imposed on JavaScript and Java Applets as of the time of writing this disclosure. Thus, according to some Host operating system configurations, when JavaScript or Java Applets is used, only the second method for returning change is available, namely having the Vendor create a new cash bundle with the change and present it to the User.

The JavaScript and Java Applet embodiments can support paying with multiple cash bundles by keeping track of all cash bundles submitted by the User and sending them to the Vendor web server when the total matches or exceeds the item purchase price.

Digital Cash Bundle as Means for Web Site to Pay a Visitor

A business scenario on the Internet for which existing payment solutions may be inadequate is the case whereby a web site wants to deliver digital cash to users visiting that site, as an immediate cash payment, without requiring from such users to provide their personal details. The ability to do so could open extremely successful marketing strategies for Internet web sites to drive traffic to their site. For example, a search engine may jockey to regain the lead in terms of traffic by offering cash payments on the spot to visitors selected at random. However, for such a marketing strategy to be effective, it may not be desired to require users to enter any personal information in order to receive the payment, as this may deter many based on privacy concerns or on the time it would take to enter such information. Furthermore, in order for that incentive to work, it may be desirable for such cash payments to be in a form acceptable by anyone, recognized by all as cash. Existing online payment solutions do not meet that need. Credit cards as a method for users to accept cash suffer from the same shortcomings as they do as a method of payment online. Other online payment systems are also not convenient from the point of view of the Internet vendor, as each is relevant only to a small subset of the population, and require web sites to implement multiple specific interfaces. In addition, existing payment systems online require that the recipient of payment identify herself. Digital cash bundles solve all these problems very well, insofar as digital cash bundles may be created with attributes such that anyone may receive them—many such examples have been described throughout the figures of this invention.

According to some embodiments, a method for a web site to offer a digital cash bundle to a user is simply by displaying within the browser of the user a graphical element representing a digital cash bundle, similar or identical in appearance to the icons displayed by digital cash management applications implementing the present invention. A hyperlink (URL) is associated with that graphical element, pointing to a digital cash file of the desired denomination on the web server. When the user clicks on the graphical element, it activates the hyperlink, which causes the Internet browser to download the digital cash bundle; the user can then open the digital cash bundle and get credited for its value. Note that, according to this example, at no time during this process is the identity of the user exposed to the web site.

It is noted that according to some embodiments, this business method may be combined with presently disclosed techniques for automatically installing a digital cash management application on the computer where a user receives a digital cash bundle for the first time.

The presently disclosed techniques for paying visitors to web sites is very useful when users are not required or requested to provide personal details. Nevertheless, it is appreciated that this is not a limitation of the presently disclosed techniques for paying visitors to web sites.

### Exemplary Business Methods for Dispensing Digital Cash

A number of business methods for distributing digital cash are now provided. Many of these methods may be implemented by first providing the digital cash on removable non-volatile media (for example, as a digital cash payment or bundle, or in particular, as a digital cash bundle file), and then distributing the removable non-volatile media, though it should not be construed that methods for distributing digital cash may only be implemented using non-volatile memory. Some methods of distributing digital cash involve making digital cash (for example, a digital cash bundle or payment) available for download.

According to some embodiments, it is indeed chosen to distribute digital cash by distributing a removable non-volatile medium on which digital cash resides. In some embodiments, the digital cash on the removable non-volatile medium is not “tied” to any properties of the host device on which it was generate—i.e. the distributed digital cash is said to be “accessible” —i.e. it may be read and manipulated using digital cash operations by any machine irrespective of the contents of memory of the user machine at the time the file was written to non-volatile memory and/or the digital cash is said to be “valid”—i.e. can be redeemed on at least one machine other than the host device on which the digital cash was generated and/or the host device which wrote the digital cash to the removable non-volatile memory medium.

According to one non-limiting exemplary business scenario, a store or theater or restaurant or another business wishes to draw people to their physical premises (perhaps by running a limited time promotion). Thus, according to this example, the business may physically distribute non-volatile memory to potential customers who enter the premises. It is possible, though not a requirement, that the physical cash residing on the non-volatile media be associated with specific properties, for example, an expiration date, an acceptance request, an embedded message, etc.

It is noted that digital cash distributed to one or more users or customers (either by distributing digital cash embedded on removable non-volatile medium, or through other methods) may be associated with one or more specific properties. Thus, according to one example, “a digital cash voucher” may be provided. This digital cash voucher is defined as digital cash which is redeemable by a pre-defined entity and is not redeemable by the general public. Thus, in one non-limiting example a particular business (i.e. a store or entertainment venue) wants to encourage customers to purchase their goods or products, and distributes (the concept of “distributing” digital cash may also refer to selling the digital cash for real money or in exchange for another item of value) digital cash voucher bundles which are assigned to the business. This digital cash bundle functions as an electronic voucher or gift certificate.

In some embodiments, a web site wishes to encourage web traffic to the site, and make digital cash available (for example, a digital cash payment or a bundle) for download on the web site. In one example, the web site advertises that digital cash is available at a certain location. The web site may desire to reduce their cash liability, and thus, will not provide digital cash to every download of a given page, or to every user. Thus, in some embodiments, a given web page or web site is associated with a non-zero chance of receiving a digital cash ‘prize’ (for example a digital cash payment or bundle), which may be random, pseudo random and the like and/or may be advertised to the user as random.

In one example, a given user or group of users is prevented from receiving a digital cash bundle and/or cashing a digital cash bundle more than a pre-determined number of times (for example, more than once).

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention The described embodiments comprise different features, not all of which are required in all embodiments of the invention. Some embodiments of the present invention utilize only some of the features or possible combinations of the features Variations of embodiments of the present invention that are described and embodiments of the present invention comprising different combinations of features noted in the described embodiments will occur to persons of the art.

What is claimed is:

1. A system for visualizing digital cash on a computer, the system comprising:
a) a digital cash status engine for determining at least one cash attribute of a digital cash bundle; and
b) a digital cash management interface operative to represent said digital cash bundle as a graphical icon associated with a visual indication of at least one said determined digital cash attribute.

2) The system of claim 1 wherein said cash visual interface is operative to display an additional said visual indication associated with at least one said cash status attribute upon detecting a user engagement with said graphical icon.

3) The system of claim 2 wherein at least one said visual indication is provided as text.

4) The system of claim 1 wherein said digital cash management interface includes drag-and-drop functionality, and drag-and-drop manipulation of said graphical icons is operative to effect cash bundle manipulation operations.

5) The system of claim 4 wherein subjecting a said graphical icon to a drag-and-drop operation is operative to effect a corresponding drag-and-drop operation to a digital cash file associated with said subjected graphical icon.

6) The system of claim 1 further comprising:
c) a digital cash bundle combining engine for generating a cash bundle from a plurality of existing said digital cash bundles.

7) The system of claim 6 wherein upon detecting by said digital cash management interface of an engagement of a first said graphical icon representing a first said digital cash bundle with a second said graphical icon representing a second said digital cash bundle, said digital cash combining engine is operative to generate a combined said cash bundle from said first and second said cash bundles.

8) The system of claim 6 wherein said combining is a silent combining.

9) The system of claim 8 wherein upon said detecting of said engagement, said digital cash management interface presents a cash combining interface, and said generation of said combined cash bundle by said digital cash bundle combining engine is performed in accordance with parameters received through said cash combining interface.

10) The system of claim 1 wherein at least one said digital cash attribute is a parameter indicative of an earliest valid redeeming time of said digital cash bundle.

11) The system of claim 1 wherein at least one said digital cash attribute is a multi-redeeming parameter of said digital cash bundle.

12) The system of claim 1 wherein at least one said digital cash attribute is an acceptance condition parameter attached to said digital cash bundle.

13) The system of claim 1 wherein at least one said digital cash attribute is a password protection status of said digital cash parameter.

14) The system of claim 1 wherein at least one said digital cash attribute is a currency parameter of said digital cash bundle.

15) The system of claim 1 wherein at least one said digital cash attribute is selected from the group consisting of
a) a parameter indicative of a creation time of said digital cash bundle,
b) a parameter indicative of an expiration time of said digital cash bundle,
c) a destination parameter,
d) a parameter indicative of the ability of the present user to redeem said digital cash bundle,
e) a cancellation status parameter of said digital cash bundle,
f) a notification of redeeming status of said digital cash bundle,
g) a modifiability status of said digital cash bundle,
h) an online redeeming status of said digital cash bundle, and
i) an informative message status of said digital cash bundle.

16) The system of claim 1 wherein said digital cash management interface is further operative to effect at least one modification of at least one said digital cash attribute of said digital cash bundle.

17) The system of claim 1 further comprising:
c) a digital cash redeeming engine operative to handling redeeming of a digital cash bundle upon, and upon detecting by said digital cash management interface of a user engagement to a said graphical icon, said redeeming engine effects a redeeming operation for an associated digital cash bundle.

18) The system of claim 17 wherein said digital cash bundle is a repeat bundle, and said redeeming engine is only operative to redeem said repeat bundle if a sum of one and number of previous redeeming does not exceed a maximum number of redeeming associated with said repeat bundle.

19) The system of claim 17 wherein if a given said digital cash bundle is a deferred cash bundle, said digital cash redeeming engine is only operative to redeem said deferred cash bundle if an earliest redeeming time has arrived or passed.

20) The system of claim 17 further comprising:
c) a notification engine adapted to send a notification message upon said redeeming.

21) The system of claim 20 wherein said notification message includes at least one of an identity of a redeemer and a time of redeeming.

22) The system of claim 20 wherein said notification message is sent to a source of said redeemed cash bundle.

23) The system of claim 17 further comprising:
c) a condition acceptance engine for determining if an acceptance condition for redeeming said digital cash bundle is met,
wherein if said condition acceptance engine determines that a given said digital cash bundle is associated with an acceptance condition, said redeeming engine is operative to redeem said cash bundle associated with said acceptance condition only upon determination by said condition acceptance engine that said acceptance condition is met.

24) The system of claim 23 further comprising:
c) an acceptance condition presentation interface for presenting said acceptance condition.

25) The system of claim 17 further comprising:
c) a password engine for determining a validity status of a submitted password,
wherein if digital cash status engine determines that a given said digital cash bundle is password-protected, said redeeming engine is operative to redeem said protected cash bundle only upon determination by said password engine of a valid password.

26) The system of claim 25 further comprising:
d) a password interface associated with said password engine, said password interface being operative to communicate a received user password to said password engine,
wherein said password interface is activatable upon detection by said cash management interface of a user engagement with a said graphical icon.

27) The system of claim 1 further comprising:
c) a cash bundle generation engine operative to generate a said digital cash bundle,
wherein upon said generation of said digital cash bundle, said cash management interface is operative to display a said graphical icon representing said generated digital cash bundle.

28) The system of claim 27 further comprising:
d) a cash bundle generation interface,
wherein said cash bundle generation engine operates in accordance with directives received through said cash bundle generation interface, said cash bundle generation interface being activatable in accordance with a detected drag-and-drop operation.

29) The system of claim 27 wherein said cash bundle generation engine is operative to generate a digital cash bundle in accordance with predetermined values provided in said digital cash template.

30) The system of claim 29 wherein said generation of said digital cash bundle is performed upon detection of a dragging and a dropping of a template graphical icon associated with said provided digital cash template.

31) The system of claim 1 wherein said management interface is operative to display a graphically modified cash graphical icon which is modified in accordance with said at least one cash status attribute.

32) The system of claim 1 wherein said graphically modified cash graphical icon includes a primary icon combined with at least one secondary icon, and said visualization interface is operative to select said at least one secondary icon is selected in accordance with at least one said digital cash attribute.

33) The system of claim 1 wherein said associated visual indication is determined in accordance with at least one environmental factor of said digital cash bundle.

34) The system of claim 33 wherein said environmental factor is a current time.

35) The system of claim 33 wherein said environmental factor is selected from the group consisting of an identity of the logged in user and a location of said digital cash bundle.

36) The system of claim 33 wherein said environmental factor is a financial institution environmental factor.

37) The system of claim 1 wherein said digital cash management interface is operative to produce a menu upon detecting a user engagement with a said graphical icon, said menu containing at least one item operative to effect a cash bundle manipulation operation to a digital cash bundle associated with said engaged icon.

38) The system of claim 1 further comprising:
c) a digital cash bundle splitting engine for generating from said digital cash bundle a plurality of distinct derivative digital cash bundles.

39) The system of claim 38 wherein said cash splitting engine is activatable upon engaging said graphical icon within said cash visual interface.

40) The system of claim 1 wherein said digital cash bundle and said graphical icon are associated with a digital cash file.

41) The system of claim 1 further comprising:
c) a search engine for searching locating digital cash bundles in accordance with a plurality of values provided for respective digital cash attributes.

42) The system of claim 1 wherein said cash visualization interface is operative to interact with at least one separate desktop application to embed said graphical icon within said separate desktop application.

43) The system of claim 42 where said embedding is carried out by a user drag-and-drop operation.

44) The system of claim 1 wherein upon detecting a user designation of a desktop application as a drag-and-drop target for said graphical icon, and in accordance with a detection that said designated desktop application accepts drag-and-drop input text, said cash management interface is operative to transmit a textual representation of said associated digital cash bundle to said designated desktop application.

45) A method of visualizing digital cash on a computer, the method comprising:
a) determining at least one cash attribute of a digital cash bundle; and
b) representing said digital cash bundle as a graphical icon associated with a visual indication of at least one said determined digital cash attribute.

46) A computer readable medium comprising program instructions, wherein when executed the program instructions are operable to:
a) determine at least one cash attribute of a digital cash bundle; and
b) represent said digital cash bundle as a graphical icon associated with a visual indication of at least one said determined digital cash attribute.

47) A method of simulating a drag-and-drop operation of a Microsoft Windows notification icon from the taskbar into a region outside of the taskbar the method comprising:
a) detecting a user engagement with the notification icon in a manner indicative of initiating a drag-and-drop operation;
b) upon said detecting, creating a temporary proxy window whose initial location is proximate to said notification icon;
c) transferring the focus to said created proxy window and establishing said created proxy window as the drag source; and
d) allowing the user to complete the drag-and-drop operation with said proxy window.

48) The method of claim 47 wherein an icon derived from said notification icon is embedded in said proxy window in order to further the impression that it is the said notification icon that is being dragged.

49) A digital cash generation system for creating customized digital cash, the system comprising:
a) a digital cash generator for generating digital cash; and
b) a data extractor for deriving an identifier of a payee target from a software application distinct from said digital cash generator,
wherein said digital cash generator is operative to generate said digital cash in accordance with said derived identity of said payee.

50) A digital cash generation system for creating customized digital cash, the system comprising:
a) a digital cash generator for generating digital cash customized in accordance with a digital cash account identifier; and
b) a customized data manager for associating said digital cash account identifiers with identifiers under a software application distinct from said digital cash generator,
wherein upon receiving a request to generate digital cash for a payee having an identifier under said software application, said digital cash generator is operative to customize generated digital cash using a digital cash account identifier previously associated with said identifier under said software application.

51) A method of facilitating the installation of software on a user machine, the method comprising:
a) associating a digital cash bundle file with code or with a reference to code operative to install an application on the user machine in accordance with a detecting of a user engagement of said digital cash bundle file; and
b) storing said digital cash bundle in volatile or non-volatile memory.

52) The method of claim 51 wherein said code is operative to prevent repeated installation of said application.

53) The method of claim 52 wherein said code is operative to modify said digital cash bundle to prevent said repeated installation.

54) The method of claim 52 wherein said code is operative to configure a file type association data structure of the operating system such that future engagements by the user of digital cash bundles associated with said installation code or said reference are operative to bypass said installation code.

55) A system for redeeming digital cash on a computer, the system comprising:
a) a digital cash status engine for determining at least one cash access attribute of digital cash payment; and
b) a digital cash access granting engine for redeeming only upon detecting a user acceptance of an embedded acceptance condition associated with said digital cash payment.

56) The system of claim 55 further comprising:
c) a notification engine operative to send a notification upon user acceptance of said acceptance condition.

57) The system of claim 56 wherein said notification engine is operative to send or make available a piece of legally admissible evidence of said user acceptance.

58) The system of claim 57 wherein said legally admissible evidence includes a digitally signed communication.

59) A method of doing business, the method comprising:
a) providing a digital cash file having an embedded specified earliest redeeming time; and
b) upon handling a redeeming request, redeeming said digital cash file only if said redeeming time constraint is satisfied.

60) The method of claim 59 wherein a digital cash account is debited at a time selected from the group consisting of a time of successful redeeming, said specified redeeming time, and a time of said issuing.

61) The method of claim 60 wherein said digital cash file is designated with a status selected from the group consisting of cancelable and non-cancellable.

62) A method of doing business, the method comprising:
a) specifying a redeeming parameter describing a number of times a digital cash payment may be redeemed; and
b) associating said redeeming parameter with said digital cash payment.

63) The method of claim 62 wherein a user-specific number of times a digital cash payment may be redeemed for any given user is also specified, and said user-specific number of times is associated with said digital cash payment.

64) A method of redeeming digital cash:
a) handling a redeeming request for a repeat digital cash payment that is redeemable a number of times equal to a first number; and
b) authorizing redeeming of said repeat digital cash payment only if a number of previous successful redeemings is less than one less than said first number.

65) The method of claim 64 wherein said redeeming request is associated with an identity of a potential redeemer, said digital cash payment is redeemable for said potential redeemer a number of times equal to a second number, and said digital cash payment is authorized for said redeeming only if a number of previous successful redeemings for said potential redeemer is less than one less than said second number.

66) A method of doing business, the method comprising:
a) offering an item or service for sale over the Internet; and
b) receiving over the Internet one or more digital cash bundle files as payment for said item or service.

67) The method of claim 66 wherein said step of offering includes embedding within a web page a visual element with associated code, said visual element representing said item or service offered for sale and said associated code is operative to accept said digital cash bundle file as payment for said item or service upon user engagement with said web element.

68) The method of claim 67 wherein said embedded associated code is operative to accept said digital cash bundle file upon detecting a user drag-and-drop operation of said digital cash bundle file onto a region associated with said visual web element.

69) The method of claim 67 wherein said associated code is operative to accept a plurality of said digital cash bundle files, and to indicate when an accrued amount of digital cash from said plurality is equal to or exceeds a payment due for said item or service.

70) The method of claim 67 wherein if excess digital cash is received for said item or service, said associated code is operative to provide one or more digital cash files whose value is determined by a received excess payment.

71) A method dispensing digital cash bundles, the method comprising:
a) embedding within a web page a visual indication of a presence of digital cash; and
b) embedding within said web page at least one web element operative to supply a digital cash bundle file upon detecting a user engagement of a location associated with said visual indication of said presence of said digital cash.

72) The method of claim 71 wherein said web element is selected from the group consisting a digital cash bundle file, computer-readable code for providing a digital cash bundle file, and a reference to said computer-readable code.

73) A method of encouraging web traffic, the method comprising:
a) making a web page available a plurality of times; and
b) for at least one of said plurality of times, making said web page available with an embedded digital cash bundle.

74) The method of claim 73 wherein said web page is made available with said digital cash bundle only a fraction of the time, and a determination about whether or not to embed said digital cash bundle is made in accordance at least in part with an identity of a user.

75) A method of doing business, the method comprising:
a) providing restricted digital cash redeemable only by a pre-defined entity; and
b) making said restricted digital cash available to one or more individuals, each said individual being distinct from a redeeming party.

76) The method of claim 75 wherein said restricted digital cash voucher is provided as a digital cash file accessible to an operating system desktop.

77) The method of claim 75 further comprising:
c) effecting a transaction where an entity authorized to redeem said distributed restricted digital cash receives said distributed restricted digital cash in exchange for goods or services.

78) A method of doing business, the method comprising:
a) providing digital cash having an embedded informative message, said digital cash redeemable concomitant with a viewing of said embedded informative message; and
b) storing said digital cash bundle file in volatile or non-volatile memory.

79) The method of claim 78 wherein said embedded informative message includes an advertising message.

80) The method of claim 78 wherein said digital cash is redeemable only after viewing of at least a portion of said embedded informative message.

81) The method of claim 78 wherein at least a portion of said embedded informative message is presented after cash redeeming.

82) The method of claim 78 wherein said embedded informative message includes at least one of a graphical message and a multi-media message.

83) A method of doing business, the method comprising:
a) providing a password-protected digital cash payment; and
b) authorizing access to said digital cash payment only after a providing of a valid password.

84) The method of claim 83 wherein said digital cash payment is provided as a digital cash file.

85) The method of claim 83 wherein said digital cash payment is represented as a graphical icon, and said password is requested upon a user engagement to said graphical icon.

86) A method of doing business, the method comprising:
a) generating digital cash having an embedded redeeming acceptance condition; and
b) storing said digital cash bundle file in volatile or non-volatile memory

87) The method of claim 86 wherein said redeeming acceptance condition of said generated digital cash includes formal legal text, and said generating of said digital cash includes generating said formal legal text on the basis of one or more predetermined templates.

88) The method of claim 86 wherein said digital cash includes embedded instructions to send a notification upon user acceptance of said acceptance condition.

89) The method of claim 88 wherein said digital cash includes embedded instructions to send or make available a piece of legally admissible evidence of said user acceptance.

90) The method of claim 89 wherein said legally admissible evidence includes a digitally signed communication.

91) The method of claim 86 wherein said digital cash payment is distributed as a digital cash bundle file.

92) A method of doing business, the method comprising:
a) providing a digital cash payment associated with instructions which are operative upon redeeming to execute of software code distinct from said redeeming code; and
b) storing said digital cash payment in volatile or non-volatile memory.

93) The method of claim 92 wherein said instructions are instructions embedded within said digital cash payment.

94) The method of claim 92 wherein said instructions are external to said digital cash payment.

95) The method of claim 92 wherein said instructions are operative to execute installation code operative to install an application on a user machine.

96) The method of claim 92 wherein said digital cash payment is distributed as a digital cash bundle file.

97) A method of facilitating a transaction wherein a buyer purchases an item from a vendor using digital cash payment, the method comprising:
a) receiving an indication that the item has been sent from the vendor for delivery to the buyer;
b) receiving a key for redeeming the digital cash payment; and
c) in accordance with a successful validation of said key, authorizing the providing of the item to the buyer.

98) The system of claim 97, further comprising:
c) in accordance with said successful validation of the key, authorizing the sending of said key to at least one of the vendor.

99) The system of claim 97, further comprising:
c) in accordance with said successful validation of said key, effecting a crediting of an account of said vendor with an amount derived from a value of said digital cash payment.

100) The method of claim 97 wherein said digital cash payment is a digital cash bundle file.

101) A system for handling a plurality of application items of a software application, the system comprising:
a) registration code for registering with the software application; and
b) an application item handler for handling application items of the software application, said application handler adapted to handle said application items in accordance with determinations of whether or not given application items are associated with digital cash.

102) The system of claim 101 provided at least in part as a plug-in for the software application.
